(19) United States
(12) Patent Application Publication
(10) Pub. No.: US 2015/0286295 A1
(43) Pub. Date: Oct. 8, 2015

(54) INPUT DEVICE, PARTICULARLY FOR COMPUTERS OR THE LIKE, AND CORRESPONDING GRAPHICAL USER INTERFACE SYSTEM

(71) Applicant: Davide PEPE, Benevento (IT)

(72) Inventor: Davide Pepe, Benevento (IT)

(21) Appl. No.: 14/441,100

(22) PCT Filed: Nov. 7, 2012
(86) PCT No.: PCT/IT2012/000337

§ 371 Date: May 6, 2015

(51) Int. Cl. G06F 3/0354; G06F 3/0362

(52) U.S. Cl. CPC G06F 3/03543; G06F 3/0362

(57) ABSTRACT

An input device comprises a slidable member having a moveable surface which is looped back on itself. A touch sensor below its slideable surface can register clicking operations. The input device makes it possible to manipulate some types of user graphic controls using physical actions such as the pressure of a button or the scrolling of a slider.

### FIELD

The present disclosure relates to input devices and graphic interfaces for computers and the like, with particular reference to pointing devices.

### BACKGROUND

Input devices are known, with a pointing function, which convert a physical action performed by a user to an input, which is interpretable by a computer and determines a movement of a pointer within a virtual area, for example on a screen. Such pointing devices belong to two general categories. A first category includes pointing devices such as mice or the like, which comprise one or more moveable parts that are actuateable by the user, for example the body of a mouse, and one or more sensors that interact between such moveable parts and a fixed element, such as the resting surface of a mouse; a second category includes pointing devices such as touch pads, which do not comprise moveable parts, but only sensors which interact directly with the user, for example with the movement of the tip of a finger on the touch sensitive surface of a touch pad or of a touch screen.

Conventional pointing devices that belong to both categories are generally associated with selection devices, such as buttons or other types of sensor, so that the movement of the pointer can also be associated with a selection action of display widgets, for example a button, or an engagement action with a display widget, for example the slider of a scroll bar. Two types of action by the user are known, corresponding to a selection of display widgets: the action of “clicking”, which happens when a button is pressed, and the action of “tapping” which happens when a surface, for example of a touch pad, is hit. The clicking and tapping actions are associated with various interface means, generally a spring-loaded button for clicking and a sensor, for example of the capacitive type, for tapping.

Such conventional selection and pointing devices suffer numerous drawbacks among which are the necessity to perform numerous and repeated movements between one part of the screen and the area of the screen in which the user commands are located, the necessity of selecting an object before launching a command directed at that object, the impossibility of launching multiple commands simultaneously, the impossibility of modifying the settings of a command in real time while editing an object or using a tool, the impossibility of simultaneously performing a scroll action and a click action with the same finger, the impossibility of managing more than one pointer simultaneously, the impossibility of entering and/or exiting from a window or a modal control without the use of burdensome actions by the user such as the pressing of a physical button, the necessity to resort to continual movements of the hand to and from the keyboard of the computer when typing text, the impossibility of selecting a palette and the commands contained in it without moving the pointer.

Another drawback is that the selection and pointing devices belonging to the touch pad category cannot be clicked uniformly over the touch surface.

Another drawback is that selection devices of the wheel type are hard to click and have limited or uncontrollable scrolling.

### SUMMARY

The aim of the present disclosure relates to providing an input device, particularly for computers or the like, which solves the above mentioned technical problems, eliminates the drawbacks and overcomes the limitations of the known art by allowing a natural, rapid and effortless use by the user.

Within this aim, the present disclosure provides an input device that is uniformly clickable along all of its useful surface.

The present disclosure further provides:
a) an input device that does not require extensive physical space for operation;
b) a scrolling device that ensures reliable and controllable scrolling operations;
c) an input device that is capable of offering the widest guarantees of reliability and safety in use;
d) a device that is easy to make and economically competitive when compared to the known art and in consideration of the new functionalities offered;
e) a system for text input which is rapid and applicable to portable devices;
f) a graphical user interface that makes it possible to launch a command without moving the pointer;
g) a graphical user interface that makes it possible to launch multiple commands simultaneously;
h) a graphical user interface that makes it possible to search for a command by way of simple movements of the fingers;
i) a graphical user interface that makes it possible to modify the status of a control while dragging the pointer;
j) a graphical user interface that reduces to the minimum the space occupied on screen by interface commands thanks to techniques that can easily and instantly be used;
k) a graphical interface that is capable of handling more than one pointer on screen.

This aim and these and other objects which will become better apparent hereinafter are all achieved by an input device, particularly for computers or the like. The input device comprises a slideable member which engages with a sliding support, thus generating, by means of a slide sensor which is capable of reading the movements of the slideable member, electronic signals that are indicative of the movement. The device differs from the background art in that it offers a considerably larger and more ergonomic slideable surface with respect to that of a common mouse wheel, which enables, with respect to the latter, longer rolls, the possibility to combine the surface with a touch sensor, the possibility, also, of rendering the surface clickable, and the possibility, therefore, to associate a click or a “roll” (entrainment of the slideable member) with a point of the sensor. This last possibility makes it possible to operate on a display widget displayed on the screen with methods similar to those with which one operates on a real object.

The slideable member can be advantageously formed by a belt or by a membrane and the sliding support can be advantageously formed by a pair of rollers or by a lubricated surface. The slideable member slides, with respect to the pressure surface, at a distance such that it is possible to actuate both the clicking mechanism and the rolling mechanism by means of the same finger. If implemented in a mouse, the input device can be dimensioned so as to cover all of the part of the mouse that it is possible to reach with the tip of a finger. The clickable surface can be that of a touch pad. In this case the user also has available, in addition to the degrees of freedom already mentioned, i.e. clicking and rolling, a means for controlling an additional cursor on the screen with the finger. This opportunity makes it possible to associate a click action or a roll action with the graphical object, for example a button, that is currently pointed to by the additional cursor. The input device can thus act as a control panel in the following way: the user identifies a command on the screen associated with the input device, and selects it by moving the finger on the touch sensitive surface of the slideable member until the additional cursor is pointing to the identified command. At this point, and depending on the type of command, the user can perform a click at the current position of the finger on the touch sensitive surface or begin a roll action by dragging the slideable member with the same finger starting from that position. The three actions, point, click, and roll, can be performed simultaneously. The roll action can also be used for the scrolling of windows and other scrollable graphical devices.

The pressure surface of the moveable member can be the surface of a touch screen. In such case the methods described above refer to display widgets drawn on the screen of the touch screen. This characteristic is of particular utility in portable devices where, given the dearth of space onscreen, the choice of menu commands is often limited to only a few essential commands. In particular the user can cause the appearance of a context menu by clicking directly on the object to edit or by initiating a roll action from a point of that object. In one implementation, each execution of a roll action can correspond to the appearance, on the screen, of a new palette of commands.

The input device presented here has an advantage over conventional input devices in that it can also act as a text input device. This function can be carried out by the input device by using a virtual keyboard comprising lists of characters. By clicking or rolling on a list the user respectively obtains the input of a character in the list or of the next characters in that list. Since the displaying of characters occurs on a screen, the characters displayed can change in order to reflect, for example, the choice of a different language and can be of any type. Current keyboards for computers, on the contrary, are tied to a particular destination language and do not allow, or allow only to a very limited extent, the input of pictograms. If implemented in a pointing device, the input device makes it possible for the user to never cease gripping the input device when typing text. If implemented in a portable device provided with a touch screen, the input device provides the user with an alternative system to the current SMS writing systems, one that is characterized by a greater input speed, a smaller number of buttons, and the possibility of using both hands.

The methods referred to here and many others which form the subject matter of the description that follows can be used in combination with an input device such as the one described herein in order to provide a mobile terminal system which makes it possible to control a host computer remotely by way of a wireless connection. The mobile terminal is provided with a touch screen on which the user performs the normal pointing functions. The screen of the touch screen is updated, by way of information transferred to and from the host computer, with a portion of the desktop of the host computer. By using adapted panning methods it is possible to navigate the desktop of the host computer and, by way of the usual methods as well as those described above, it is possible to control applications in execution on the computer host, including email programs and web browsers. The mobile terminal also acts as a telephone terminal. The connection to the fixed or mobile telephone network can occur via the intermediation of services and/or programs in execution on the host computer. The mobile terminal system uses the graphic interface control capabilities and rapid character input functions of the input device described herein in order to provide a mobile office station by means of which the user can continue to perform the normal functions on the computer and on the telephone even if he or she is temporarily absent from the workplace.

This aim and these and other objects which will become better apparent hereinafter are also achieved by a scroll wheel, particularly for pointing devices or the like, comprising indents and a follower which is adapted to engage with said indents, characterized in that at least one part of said follower is provided with an inertial mass; said inertial mass being adapted to retard the movement of said follower with respect to said indents in response to an action adapted to accelerate the rotation movement of the scroll wheel. The wheel further comprises: at least one magnet; said magnet being adapted to exert a force of attraction and/or repulsion on at least one part of said follower; said force of attraction and/or repulsion having an intensity which is dependent on the position of said follower with respect to said indents; said force of attraction and/or repulsion being such as to favor or contrast the action of engagement of said follower with said indents.

Conventional wheels for mice have a detent mechanism which can be disabled in order to allow the scrolling of long documents. The transition from the classic scrolling mode (detented) to the mode for scrolling through long documents (not detented), however, is not automatic and requires a specific user action, which typically include triggering a switch. Moreover, with conventional wheels it is not possible to measure the launch force of the wheel so as to obtain the arrest of the wheel after a preset number of ticks. This functionality can be of particular utility in contexts in which it is desired to quickly be taken proximate to a specific location of a list or of a window, without having to accompany each tick with the finger. The “multifunctional scrolling wheel” according to the disclosure achieves this result by way of a ticking system which is capable of reducing the resistance to motion of the wheel when the latter is in free rotation mode and of restoring said resistance to normal levels when the wheel is rotated in classic mode (line by line).

This aim and these and other objects which will become better apparent hereinafter are also achieved by a “system for making a surface uniformly clickable”, characterized in that it comprises a housing; at least one click generator that is adapted, when triggered, to generate a click; a moveable element, which is associated with said housing; one or more actuators which are adapted to adjust the amount of force necessary to trigger said at least one click generator in response to an action of pressing and/or traction exerted by a finger of the user on said moveable element.

Clickable touch pads, although representing an advance in the state of the technology for this type of device, are practically unavailable on the market. The reason is due to the fact that their clickable surface has points of unevenness in the amount of force necessary to trigger the switches underneath. This is due to the fact that the switches are not configured to cut each other out, in such manner preventing the same pressure from being able to trigger more than one switch, or to the fact that the switches, or equivalent devices, do not have the ability to require a variable triggering force.

In the first embodiment of the system for making a surface uniformly clickable, the click uniformity is obtained by preventing more than one switch from being triggered simultaneously in response to pressing on a single point of the moveable element. In the second embodiment, the click uniformity is achieved by distributing the forces acting at a point of the pressure surface so that the force and the amount of movement induced on the moveable element by an external pressure are transferred to a point of the moveable element which is in contact with a single switch without substantial differences between different points of the pressure surface. In the third embodiment, the click uniformity is achieved by using, as a switch, juxtaposed pairs of magnets which are capable of generating a click by means of the electronically induced collision of juxtaposed mechanical parts which are coupled to the housing, on one side, and to the moveable element, on the other. The resistance opposed by each electromagnet can be adjusted so that the amount of resistance offered overall by all the electromagnets, in response to pressing at a point of the moveable element, is uniform over all the surface of the moveable element.

This aim and these and other objects which will become better apparent hereinafter are also achieved by:
a) a magnetic spacer, particularly for the provision of a “frictionless mouse”;
b) a device for locking the slideable member of an input device according to the disclosure;
c) an ergonomic mouse;
d) a mouse comprising at least one “multifunctional scrolling wheel” according to the disclosure;
e) a mouse comprising one or more input devices according to the disclosure;
f) a portable electronic device comprising one or more input devices according to the disclosure;
g) an electronic device comprising one or more units of the “system for making a surface uniformly clickable” according to the disclosure;
h) a mouse the function of which is to act as a mobile terminal;
i) methods of panning a desktop;
j) systems and methods for the manipulation of various aspects of a graphical user interface;
k) systems and methods for the rapid input of characters;
l) systems and methods for magnification and/or panning “with just one finger”.

The present summary makes reference to a limited set of characteristics and aspects of the disclosure and its purpose is to present some concepts useful to the comprehension of the present disclosure, in simplified form. For a list and detailed description of the various different aspects, forms and applications of the disclosure please see the following description.

### BRIEF DESCRIPTION OF THE DRAWINGS

Further characteristics and advantages of the disclosure will become better apparent from the description of a plurality of preferred, but not exclusive, embodiments of various different aspects of the present disclosure, illustrated by way of non-limiting example with the assistance of the accompanying drawings wherein:

FIG. 1 is a side view of a first embodiment of the input device according to the disclosure;

FIG. 2 is a side view of a second embodiment of the input device according to the disclosure;

FIG. 3 is a perspective view of the belt of the input device according to the disclosure in conformance with the second embodiment of the input device;

FIG. 4 is a side view of a third embodiment of the input device according to the disclosure, in engagement with the finger of the user;

FIG. 5 is a side view of a part of the input device in FIG. 4, showing in particular the closed shell, the inner housing and the internal components;

FIG. 6 is a perspective view of a part of the input device in FIG. 4, showing in particular how the sensor engages with the surface of the closed shell;

FIGS. 7a and 7b are views from above of two examples of movement of micropatterns, in conformance with the input device in FIG. 4;

FIG. 8 is a perspective view of the input device in FIG. 4;

FIG. 9 is a perspective view of a manner of holding the input device in FIG. 4 without the support shell.

FIG. 10 shows an implementation example of the input device in FIG. 4 in a notebook computer, and an example of the self-orienting method;

FIGS. 11a and 11b show the input device in FIG. 4 according to two methods of use;

FIG. 12 is a front elevation view of the multifunctional scrolling wheel according to one aspect of the present disclosure;

FIG. 13 is a side view of the multifunctional scrolling wheel in FIG. 12;

FIGS. 14a-14c are side views of a first embodiment of the system for making a surface uniformly clickable according to one aspect of the present disclosure, showing in particular three examples of engagement of the moveable element with the switches;

FIGS. 15a and 15b are perspective views of the system for making a surface uniformly clickable in FIGS. 14a-14c, showing in particular two examples of engagement of the moveable element with the switches;

FIG. 16 is a side view of an embodiment of the system for making a surface uniformly clickable in FIGS. 14a-14c;

FIG. 17 is a perspective view with sectional view of the system for making a surface uniformly clickable in FIG. 16;

FIGS. 18a-18c are side views of the system for making a surface uniformly clickable according to a second embodiment, according to three examples of engagement of the moveable element with the switches;

FIG. 19 is a perspective view with sectional view of the system for making a surface uniformly clickable in FIG. 18;

FIG. 20 is a side view of the system for making a surface uniformly clickable according to a first variation of the third embodiment;

FIGS. 21a-21c are side views of the system for making a surface uniformly clickable according to a second variation of the third embodiment, according to three configurations of use;

FIG. 22 shows an implementation example of the system for making a surface uniformly clickable in FIGS. 21a-21c in a tablet computer;

FIG. 23 is an exploded perspective view of the system for making a surface uniformly clickable according to a third variation of the third embodiment;

FIGS. 24a-24d show four examples of the sequence of advancement of the system for making a surface uniformly clickable in FIG. 23;

FIG. 25 shows an implementation example of the system for making a surface uniformly clickable in FIG. 23 in a media player;

FIG. 26 shows an example of modular coupling of the system for making a surface uniformly clickable, in combination with a touch-sensitive screen;

FIGS. 27a and 27b are side views, according to a first embodiment, of the locking device of the slideable member of an input device, according to two configurations of use.

FIG. 28 is a side view of a manner of holding the ergonomic input device according to the disclosure;

FIG. 29 is a front elevation view of the manner of holding the ergonomic input device in FIG. 28;

FIG. 30 is a rear view of the ergonomic input device in FIG. 28;

FIG. 31 is an exploded perspective view of a modular composition of three input devices according to the disclosure, in conformance with the second embodiment;

FIG. 32 is a side view of a part of the input device according to the disclosure, showing the self-cleaning system for the belt;

FIG. 33 is a view from above of the magnetic spacer according to one aspect of the present disclosure;

FIG. 34 is a perspective view of a part of the magnetic spacer in FIG. 33, showing in particular a moveable bearing;

FIGS. 35a and 35b are side views of two configurations of use of the moveable bearings of the magnetic spacer in FIG. 33;

FIG. 36 is a partially exploded perspective view of a variation of the input device according to the disclosure inserted in a cellular phone;

FIGS. 37a and 37b are side views of the input device in FIG. 36 in two different configurations of use;

FIG. 38 is a view from above of a portion of the input device in FIG. 36;

FIG. 39 is a partially exploded perspective view of a variation of the input device according to the disclosure inserted in a smartphone;

FIG. 40 shows an example of connection of multiple pointing devices having mobile terminal capabilities.

FIG. 41 is a perspective view of an example of a pointing device, which is provided, at its base, with a microphone and loudspeaker;

FIG. 42 shows an example of the method of panning a desktop according to one aspect of the present disclosure;

FIG. 43 shows an example of the method of panning a desktop, applied to a spreadsheet.

FIGS. 44a and 44b show two examples of navigating virtual desktops;

FIG. 45 shows an example of manipulating a palette of commands by way of an input device according to the disclosure;

FIG. 46 shows an example of modifying the area under finger control, following the movement of the system pointer;

FIG. 47 is a block diagram of a computer system that integrates the input device according to the disclosure;

FIG. 48 shows an example of manipulating a combo box by way of an input device according to the disclosure;

FIG. 49 shows an example of modifying the area under finger control, following the movement of the system pointer within a large palette;

FIG. 50 shows an example of modifying the area under finger control, in a dialog window subdivided into control groups;

FIG. 51 shows an example of applying an area under finger control to two overlapping palettes;

FIGS. 52a-52c show three examples of determining the Normal Mode Area;

FIG. 53 shows an example of a three-dimensional structure of palettes;

FIG. 54 shows an example of the reuse of palettes in a three-dimensional structure of palettes;

FIG. 55 shows an example of manipulating a group of layers;

FIGS. 56a and 56b show two examples of displaying fliers in a scrollable window;

FIG. 57 shows an example of continuous scrolling;

FIG. 58 shows an example of scrollable windows side by side;

FIGS. 59a-59c show three examples of selection of a palette in a group of tiles;

FIGS. 60a and 60b show, in two configurations of use, an example of selectively displaying palettes;

FIG. 61 shows an example of selectively displaying the controls of a palette;

FIG. 62 shows an example of a graphical effect applied to a displayed control;

FIG. 63 shows a first example of reuse of the background of a palette;

FIG. 64 shows a second example of reuse of the background of a palette;

FIG. 65 shows an example of the method of rapid selection of palettes;

FIGS. 66a and 66b collectively show an example of selecting the column of commands of a palette with two columns of commands per finger;

FIGS. 67a-67c collectively show an example of selecting the column of commands of a palette according to an alternative method to that in FIGS. 66a and 66b;

FIG. 68 shows an example of the method of selecting extra lines;

FIG. 69 shows an example of the WYSIWYG customization mode;

FIG. 70 shows an example of resizing a palette;

FIG. 71 shows an example of the manual customization mode;

FIGS. 72-78 show in sequence the actions to be performed in order to browse an example structure in the manual customization mode;

FIGS. 79-85 show in sequence the actions to be performed in order to create an example structure in the manual customization mode;

FIG. 86 show the use of modifiers in three configurations of use;

FIG. 87 shows an example of applying the same properties to a discontinuous group of objects;

FIG. 88 shows a comparison between old and new methods of selecting text;

FIGS. 89a and 89b collectively show an example of the drag & drop method for copying the content of one control to another;

FIG. 90 shows a first example of live editing, relating to modifying a portion of a line;

FIGS. 91a and 91b collectively show a second example of live editing, relating to two methods of using the cut and paste functions;

FIG. 92 shows a third example of live editing, relating to a method of using the paste function;

FIG. 93 shows a fourth example of live editing, relating to drawing a line having different properties of stroke, size, and color;

FIGS. 94a-94b, 95, 96a-96b, 97a-97b, 98a-98b, 99 show several alternative examples of methods for navigating through a tree structure;

FIGS. 100a and 100b show two examples of the method for aligning submenu/subfolder elements;

FIG. 101 shows an example of selecting a tool in a palette;

FIGS. 102a-102c collectively show an example of a method of rapid character input;

FIGS. 103a and 103b collectively show an example of an alternative method of rapid character input to that in FIGS. 102a-102c;

FIGS. 104-106 show three examples of writing and correction of artifacts;

FIGS. 107a and 107b show two examples of parameterization of the output of an input device according to the disclosure;

FIG. 108 shows an example of selecting palettes by way of an input device according to the disclosure provided with a touch-sensitive screen;

FIGS. 109a-109d show four steps of a method of magnifying and panning “with just one finger”;

FIG. 110 shows an example of an alternative method of magnifying and panning “with just one finger” to that in FIGS. 109a-109d;

### DETAILED DESCRIPTION OF THE DRAWINGS

### Input Device

According to one aspect of the present disclosure the disclosure relates to an input device, particularly for use in a computer system. The input device, generally designated by the reference numeral 1, makes it possible to reduce the number of movements of the cursor, execute multiple commands simultaneously, multiply the number of controls available by way of multiplexing techniques, execute precision operations by way of new methods of manipulating user controls, and a variety of other advantages, in particular in the field of applications for computers. The device can be used in systems for controlling all types of device, from home appliances to machines for industrial and medical use, with particular reference to the field of robotics, and in all contexts that require reliability and precision.

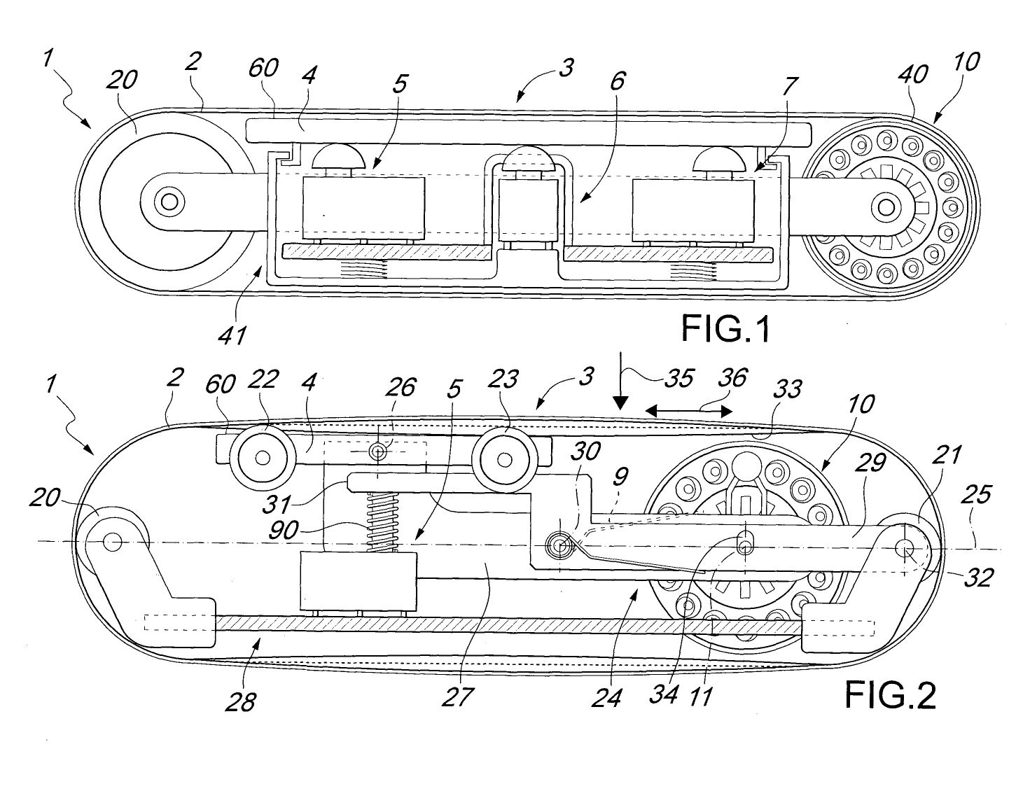

FIG. 1 is a side view of an example input device according to the first preferred embodiment. The device comprises: a slideable member comprising a belt 2; a sliding support comprising two rollers; a first roller 20 and a second roller 40; the belt 2 being adapted to slide around the rollers 20, 40. The belt 2 provides at least one substantially squashed portion 3 of the input device 1. The belt 2, at such substantially squashed portion 3, is in slideable contact with a moveable member 4. The belt 2 moreover engages with a code wheel 10, which is typically associated with a sensor, which is adapted to detect the amount and direction of movement of the belt 2. The first roller 20 and the second roller 40 are kept in position by a supporting structure 41 which is also adapted to support one or more switches 5, 6 and 7. Such switches 5, 6 and 7 engage with the moveable member 4, so that a pressure of the belt 2 corresponds to a pressure of the moveable member 4 and thus the triggering of at least one of the switches 5, 6, 7. The moveable member 4 is advantageously associated with a sensor 60 which is adapted to read the position of contact of a finger on the belt 2 at the substantially squashed portion 3. Any type of sensor is envisaged, including capacitive, resistive, optical, and electromagnetic induction sensors. The sensor can be limited to reading the position of the finger only on the longitudinal axis of the device or on both axes, in which case the function of the sensor 60 can be performed by a touch pad or a touch screen. If the sensor is a touch screen then the belt 2 can be advantageously chosen in transparent material. The code wheel 10 can be substituted by any other sensor that is adapted for the purpose, including magnetic, optical, and electromechanical sensors. The moveable member 4 defines a pressure surface on which slides, at a suitable distance, the belt 2. The switches 5, 6, 7 can generate a first output signal corresponding, for example, to a click. So that the click obtained is uniform over all of the pressure surface, in the preferred implementation, the input device 1 is associated with the “system for making a surface uniformly clickable” which is described later in this description.

In the present description a switch can be of any type and size, including switches for mice, microswitches, dome switches and reed switches. More generally it is possible to use any sensor that is capable of generating an electrical signal as a switch. Normally, when it is triggered, a switch emits perceptible auditory and/or tactile feedback. A switch, or equivalent device, can comprise a click generator. A click generator comprises means, such as for example the spring of an ordinary switch, which are adapted to generate auditory and/or tactile feedback which can be interpreted as the clicking of a button or the ticking of a mouse wheel. A click generator, for example, can comprise mechanical parts which are adapted to collide with each other as a consequence of an electrical impulse, as occurs in relays. An auditory and/or tactile click feedback can moreover be obtained by way of the generation of one or more vibration impulses, for example by way of using a vibrating battery, or by way of the contrasting action exerted by one or more electromagnets on a moveable element placed in motion by the finger of the user. A click generator can comprise means which are adapted to generate an electronic signal.

The input device 1 described above operates in the following manner: the user places the tip of the finger on the touch sensitive surface of the belt 2, thus identifying a point on the screen. Subsequently, and depending on the actions to be executed, the user exerts, through the belt, a pressure on the moveable member 4 in order to perform a click on the point that was previously identified on the screen, or executes an action, defined as a “roll”, by sliding the belt 2 in at least one direction. This latter action can also be directed at the point identified on the screen by way of the sensor 60.

In the preferred implementation the code wheel 10 is the “multifunctional scrolling wheel” described later in this description.

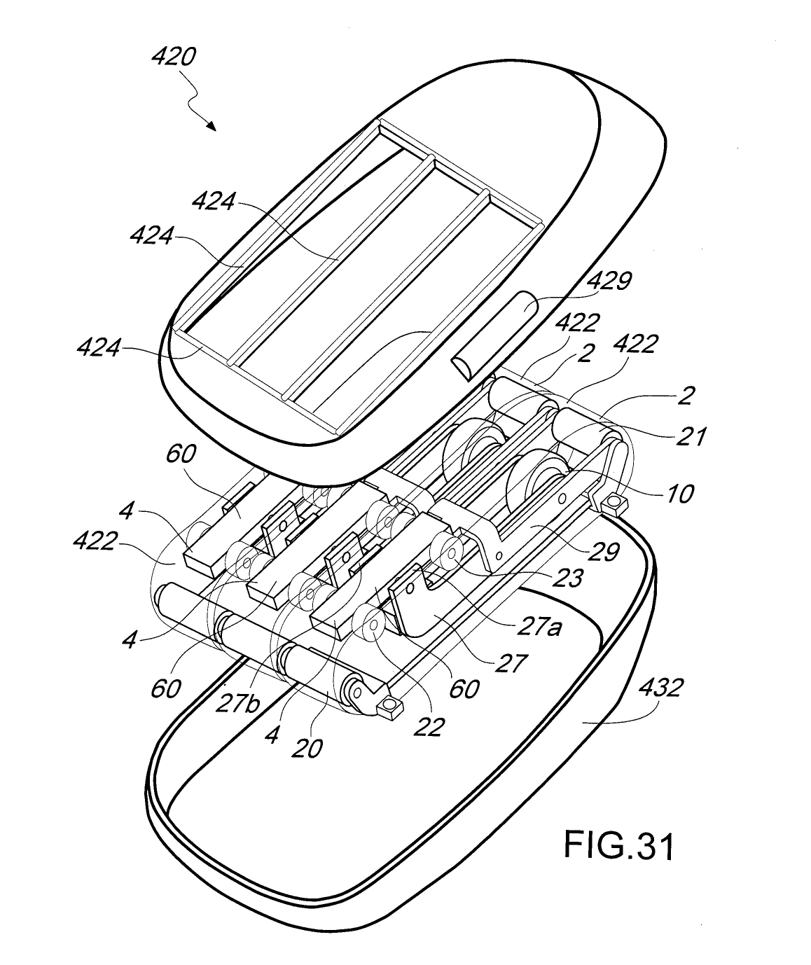

It is possible to subdivide the area of the sensor 60 of the input device 1 into logical areas, each of which is dedicated to a different finger of the hand. It is likewise possible to arrange two or more input devices 1 side by side so that each finger acts on a different input device 1. This configuration is shown in FIG. 31, which shows the modular coupling of three input devices 422 according to the second preferred embodiment. Below we refer to the input device 1 with a sensor that is shared by more than one finger as a “scroll board”, and we refer to an input device 1 for a single finger as a “scroll button”. Multiple scroll buttons likewise form a scroll board.

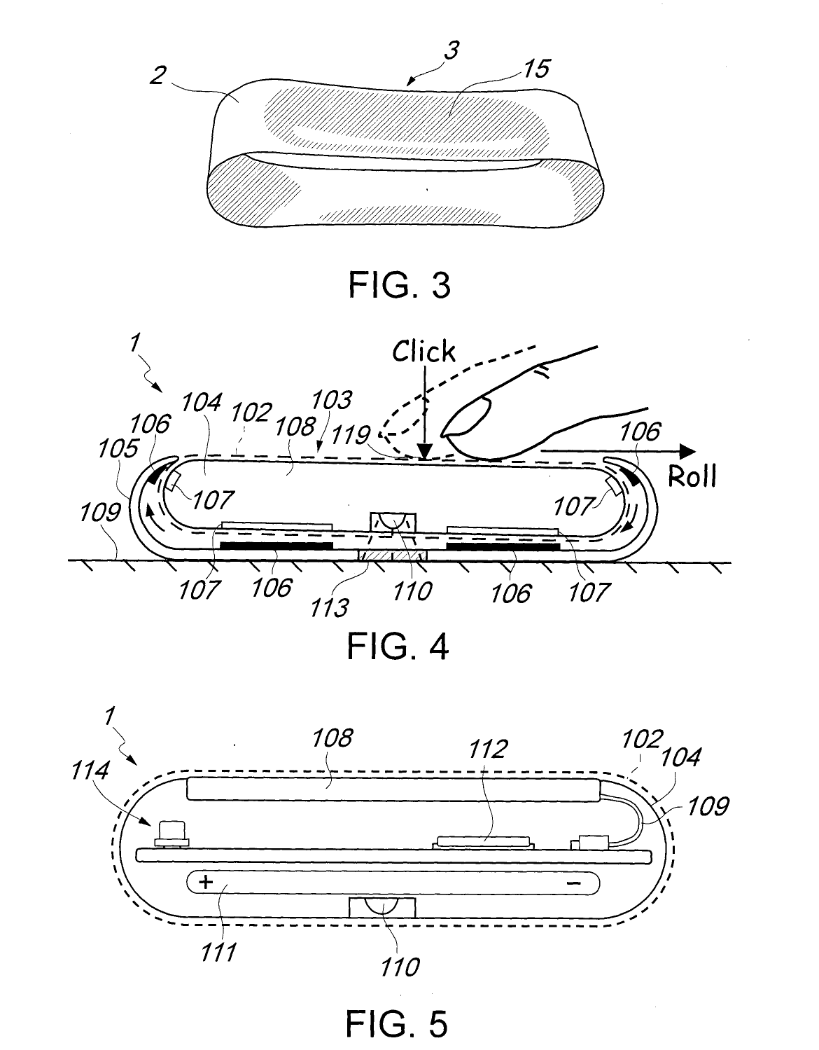

In FIG. 2 we see a side view of an example input device 1 according to the second preferred embodiment. This embodiment is characterized in that the scrolling of the belt 2 on the moveable member 4 occurs by the interposition of rotating means, in this manner eliminating the friction due to contact between the parts in motion. This result is achieved by way of using a self-shaping belt. A self-shaping belt is a belt that is adapted to maintain its shape substantially without the use of external forces. In FIG. 3 an example of a self-shaping belt 2 can be seen. The belt 2 is preferably made of an elastic material provided with a marked resistance to traction and has a curved cross-section 15 along the longitudinal axis. The curved cross-section of the belt 2 together with the marked resistance to traction of the material ensures that the belt 2 assumes, in the rest condition, a squashed ring shape. This effect is produced by the surface tensions that are generated at the points of curvature when a sheet of material provided with a suitable degree of flexibility and having a non-flat cross-section is curved beyond a certain angle. By keeping the belt 2 in place with rollers and exerting a force in direction of the tangent to its surface, the belt 2 rotates while maintaining its squashed ring shape. The part of the belt 2 comprised between the curves forms, along the longitudinal axis, a substantially rectilinear surface 3 with a curved cross-section 15 and having the characteristic of behaving, in response to incident pressures, like a substantially rigid surface. The belt 2 can be made of the material that is best adapted for the purpose, such as, for example, a material of the type of steel or plastic, and it can be a compound material, or a material having internal structures coated in a material with different characteristics or have reticulations. The belt 2 can be held in shape by way of guides and elements which are external to it.

With reference to FIG. 2, in the preferred implementation the input device 1 is provided with lever means which are adapted to enable the code wheel 10 to rotate freely in response to an impulse imparted to the belt 2 with the finger in the direction of the arrow 36. In the preferred implementation the input device 1 uses the “multifunctional scrolling wheel” described later in this description. Also with reference to FIG. 31, the input device 1 comprises: a belt 2, a supporting bracket 28, one or more spacing rollers 20, 21 arranged advantageously at the ends of the supporting bracket 28, a first lever arm 29 having a first end pivoted to the supporting bracket 28 and rotating around an axis 32, and a second end 31 which is adapted to engage with a switch 5 placed on the supporting bracket 28, the supporting bracket 28 comprising advantageously a PCB (Printed Circuit Board). The input device 1 further comprises: a second lever arm 27 pivoted on the first lever arm 29 and rotating around an axis 30, the lever arm 27 having a first end which supports a code wheel 10 and a second end which supports the moveable member 4. Code wheel 10 and moveable member 4 are pivoted to the second lever arm 27 respectively on the axes 11 and 26. The second lever arm 27 advantageously comprises two brackets 27a, 27b, as can be seen in FIG. 31. The axis 11 of the code wheel 10 is coupled to openings 34 which are present on the first lever arm 29. The openings 34 have a shape which is such as to allow vertical movements of the axis 11. The moveable member 4 advantageously supports one or more rotating members, a first roller 22 and a second roller 23. The belt 2 bears down on the moveable member 4 by way of the rotating members 22, 23 and is held in place by way of the spacing rollers 20, 21. The input device 1 also advantageously comprises balancing means, such as for example a coil spring 90, which are adapted to prevent the spontaneous triggering of the switch 5, and realignment means, such as a torsion spring 9, which are adapted to return the lever arms 29, 27 to the rest condition shown in FIG. 2 at the end of the user action.

When the user compresses a part of the belt 2, the pressure is transferred to the rotating members 22, 23 and to the moveable member 4. Simultaneously the moveable member 4 impacts on the second end 31 of the first lever arm 29 which, in turn, triggers the switch 5 underneath. When the user moves the belt 2 with the finger in direction of the arrow 36, the finger exerts a light pressure on the belt 2, sufficient to put in motion the second lever arm 27, which is coupled to the moveable member 4, and sufficient to make the second lever arm 27 rotate around the axis 30. In the rotation the first end of the second lever arm 27 pushes the code wheel 10 up, thus bringing it to impact against the inner surface of the belt 2, approximately at the point indicated by the reference numeral 33. The contact between the wheel 10 and the belt 2 during the entrainment of the latter ensures that the scrolling of the belt 2 also corresponds to the rotation of the code wheel 10.

Free scrolling of the code wheel 10 is obtained by giving the belt 2 a tap in the direction of the arrow 36. Following the lowering, owing to the tap, of the moveable member 4, a rapid exchange of kinetic energy takes place between the code wheel 10 and the belt 2, owing to the contact between the two parts, followed by a similarly rapid separation of the two parts. At the end of the tap, the weight of the code wheel 10 and the action of the torsion spring 9 instantly return the two lever arms 29, 27 to the rest position in FIG. 2. At the same time the wheel 10 is freed from contact with the belt 2 and continues its stroke around its axis 11. The user can stop the wheel by exerting another pressure on the belt 2, or the user can wait for the wheel 10 to stop on its own. Depending on the force with which the user presses on the belt 2, it is possible to put the belt 2 in rotation with or without triggering the switch 5. As well as by way of lever means, a similar result to the one described can also be obtained by way of using the means best adapted to coupling the code wheel to the belt in the ways indicated, i.e. magnetic means, hydraulic means, mechanical means and electromechanical means.

A touch sensor 60 can be associated with the moveable member 4 in order to keep track of the movements of the finger proximate to the belt 2. Alternatively it is possible to position a sensor in the vicinity of the input device 1, particularly proximate to the edges of the portion of belt 2 that is left uncovered by the housing.

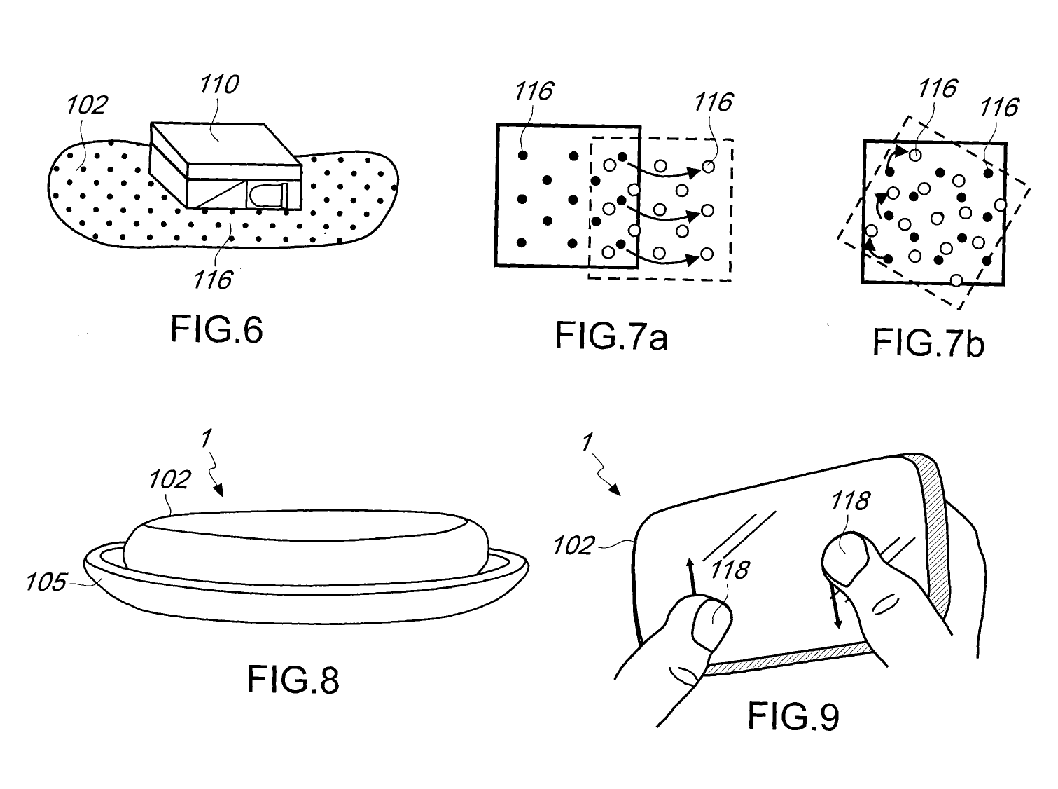

In FIGS. 4, 5, 8 and 9 we see, in a side view and in a perspective view, an example of the input device according to a third preferred embodiment. This embodiment is characterized in that the slideable member comprises a surface which is closed on every side 102. For convenience, hereinafter we shall refer to the surface closed on every side 102 with the term “bubble”. This embodiment is moreover characterized in that the slideable member can be made to slide in all directions on a plane tangential to the point of entrainment of the bubble 102. The device comprises: a bubble 102 having an outer surface and an inner surface; an inner housing 104 which engages with the inner surface of the bubble 102; and a slide sensor 110 which is adapted to detect the sliding of the bubble 102 around the inner housing 104. The bubble 102 encloses the inner housing 104 and is made of a material that is, at least partially, elastically deformable. The material, the shape and the dimensions of the bubble 102 are such that the bubble 102 can slide around an object of advantageously rounded shape while remaining substantially adherent to the surface of the object. The slide sensor 110 can be positioned both internally to the bubble 102, as shown in FIG. 5, and externally to it. If the slide sensor 110 is positioned within the bubble 102, then the input device 1 will advantageously also comprise a wirelessly rechargeable battery 111 and, according to the scenarios of use, a wireless communication system 112. The slide sensor 110 can be of any type among those capable of performing the required function, including optical, magnetic and electromechanical sensors. If optical sensors are used, then the slide sensor 110 can extrapolate the information on the movement of the bubble 102 by comparing readings of a portion of the surface of the bubble 102 which are executed at different times. The surface of the bubble 102 can advantageously have reference points for the readings. For example, with reference to FIG. 6, the bubble 102 can be associated with micropatterns 116. By moving, the bubble 102 alters the position of the micropatterns 116. From the change in position of the micropatterns 116 within the field of view of the slide sensor 110, it is possible to extrapolate a motion vector of the bubble 102. The motion vector optionally takes account of both the translation and rotation movements of the bubble 102. FIGS. 7a and 7b show, respectively, an example of translation and an example of rotation of micropatterns 116. An example of manipulation of the input device 1 which produces a rotation of the bubble 102 can be seen in FIG. 9, where the input device 1 is manipulated with two hands and the thumbs 118 push the bubble 102 in two different directions.

The input device 1 can be associated with a support shell 105. The support shell 105 makes it possible for the input device 1 to be held in the hand while the thumb moves the bubble 102, or to accommodate the input device 1 in a host device, for example in the part of a notebook computer that is commonly used for the touch pad. In the preferred implementation the support shell 105 comprises a system of magnets 106, 107 which is adapted to suspend the inner housing 104 in such a way that the bubble 102, under conditions of normal use, does not touch the support shell 105. With reference to FIG. 4, an example of magnetic suspension of the bubble 102 is obtained by providing, on juxtaposed portions of the inner housing 104 and of the support shell 105, pairs of magnets 106, 107 which are adapted to repel each other, driving, in this manner, the inner housing 104 toward the center of the support shell 105. The pairs of magnets 106, 107 are positioned at points of the input device 1 such that the thrust exerted on the inner housing 104 is such as to make the latter float in the space comprised by the support shell 105. The magnets 106, 107 can be permanent magnets or electromagnets, and be, at least partially, passive magnetic elements, such as, for example, some types of metals. In one implementation the inner housing 104 and the bubble 102 can be extracted from the support shell 105 in order to allow the bubble 102 to be manipulated with two or more opposing fingers of a hand.

A feedback equivalent to a click can be produced by the input device 1 in response to the pressure of the finger at a point of the bubble 102. In FIG. 4 we see the outcome of pressing the bubble 102 at a point 119 of the substantially squashed region 103 of the input device 1. The magnetic suspension system opposes the movement of the bubble 102, while a sensor, detecting a pressure on the bubble 102, reacts by producing feedback indicative of that pressure. In one implementation, a feedback indicative of a pressure on the bubble 102 is produced by the input device 1 in response to a variation in brightness detected by an optical sensor 110, the variation in brightness being caused by the approach of the bubble 102 to a part of the support shell 105. The optical sensor 110 can be the same slide sensor 110 used to detect the movements of the bubble 102. With reference to FIG. 4, when the user compresses the bubble 102 against the support shell 105, the optical sensor 110, which is generally associated with a light source, registers, in at least one portion of its field of view, a variation in brightness within the support shell 105. When the variation in brightness exceeds a preset limit value, the input device 1 generates a click output. The sensor 110 can be configured to register variations in brightness in different portions of its field of view. For example, with reference to the figure, pressure on one side of the bubble 102 produces a greater variation in brightness in the part of the field of view of the sensor 110 directed toward that side. In this case the input device 1 will generate a click output corresponding to the side of the input device 1 which is pressed. Similarly, by pressing the bubble 102 at different points on its surface, particularly along the cardinal axis and at the center, the input device 1 will simulate the triggering of a corresponding number of logical buttons. When a logical button is triggered the input device 1 also generates a sensory output which is indicative of the bubble 102 having been pressed. The sensory output can be produced by the same magnets 106, 107 which are used for the suspension of the bubble 102, by electromechanical devices, haptic feedback generators, vibrating batteries, audio playback devices or by any other device adapted to the purpose. A sensory output similar to a click can, moreover, be produced by the input device 1 at preset motion intervals of the bubble 102 in one or more directions. In FIG. 5 we see a vibrating battery 111 which, in addition to supplying the power supply for the circuitry of the input device 1, is used to generate sensory feedback in the form of one or more vibration impulses.

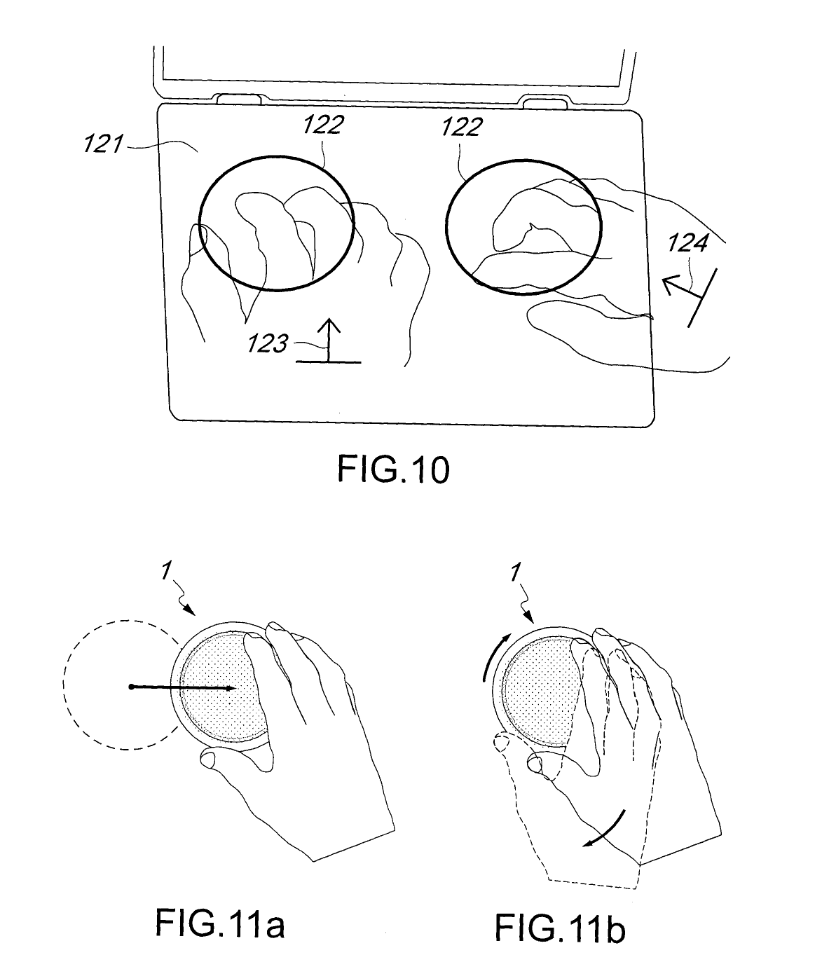

Given the capacity of the bubble 102 to slide in all directions, the input device according to the third embodiment can be used as an alternative pointing system to that of an ordinary touch pad. In such case the entrainment action of the bubble 102 by the user can be used to move a cursor on the screen. This characteristic can be exploited to produce a “frictionless” touch pad. In FIG. 10 we see an example system which comprises a notebook computer 121 that incorporates two input devices 122 according to the embodiment which we are describing. In order to move the cursor on the screen the user places a finger at a point of the bubble 102 and drags the bubble 102 with a movement similar to that when using a touch pad. The bubble 102 follows the movement of the finger and the movements of the bubble 102 are used by the system of the notebook computer 121 to move the cursor on the screen.

By associating the inner housing 104, or the support shell 105, with a sensor 108 that is capable of reading the position of contact of the finger on the substantially squashed portion 103 of the bubble 102, it is possible to have an additional pointing system. The two pointing systems can be used for moving an object, or for panning a view, according to different spatial planes. By associating the support shell 105, or the inner housing 104, with a position sensor 110 which is adapted to read the position of the input device 1 with respect to an external resting surface 109, it is possible to control a third pointer as well. As shown in FIG. 11a, the movement of the third pointer can be controlled by moving the input device 1 like an ordinary mouse. In addition to the normal pointing functions, the second movement sensor 110 is advantageously also capable of reading any rotational movements of the input device 1, which are made by rotating the input device 1 with one hand, as shown in FIG. 11b. It is possible to use, as a movement sensor 110, the same slide sensor 110 which is used for reading the movements of the bubble 102. In the example in FIG. 4 we see an optical slide sensor 110 positioned inside the inner housing 104 of the input device 1 and oriented toward the resting surface 109. By using a bubble 102 made of a substantially transparent material and ensuring that at least one part of the field of view of the optical sensor 110 intercepts a portion of the resting surface 109, the slide sensor 110 can calculate the movements for the translation and/or rotation of the input device 1 with respect to the resting surface 109 on the basis of the readings performed by the sensor 110 on the portions of the resting surface 109. In the example in the figure, the images relating to the portion of the resting surface 109 which is currently framed by the sensor 110 are intercepted by the sensor 110 through an opening 113 present in the side of the support shell 105 that is directed toward the resting surface 109, as well as through the surface of the bubble 102 itself. The separate reading of the sliding of the bubble 102, on the one hand, and of the movement of the input device 1 with respect to the resting surface 109, on the other, can occur by separately calculating the movements, in the field of view of the sensor 110, both of the currently framed portion of the resting surface 109, and of the micropatterns 116 that are associated with the surface of the bubble 102. The movement of the third pointer can be used to move or rotate an object or a view according to a predetermined plane.

The data originating from any electronic parts 114 that are present inside the inner housing of the input device 1 can be transferred to an external system by way of a wireless communication system 112, such as, for example, the Bluetooth system. These electronic parts 114 can be powered wirelessly, preferably by means of a process of electromagnetic induction. In the preferred implementation, the input device 1 comprises a wirelessly rechargeable battery 111 which is powered by a wireless recharging system comprised in the support shell 105.

The bubble 102 can be made to slide around the inner housing 104 in various ways. In the preferred implementation the bubble slides over a layer of lubricant material that occupies at least part of the interspace between the bubble 102 and the inner housing 104. The interspace between the bubble 102 and the inner housing 104 can be kept at a negative pressure in order to enable the bubble 102, which is made of flexible material, to assume the shape of the inner housing 104. In order to prevent any of the lubricant material from penetrating into the inner housing 104, the latter can be built so as to be impermeable to infiltrations of the lubricant material. The inner housing 104 can easily be rendered impermeable, during the manufacturing process, by immersing its inner components in a substance which is capable, by drying, of forming a solid body. This method can also be used to model the inner housing 1 to the shapes that are best adapted to the sliding of the bubble 102.

### Multifunctional Scrolling Wheel

According to another aspect of the present disclosure, the disclosure relates to a scroll wheel, particularly for pointing devices or the like, characterized in that it comprises a ticking system which is capable of adapting automatically to different types of use.

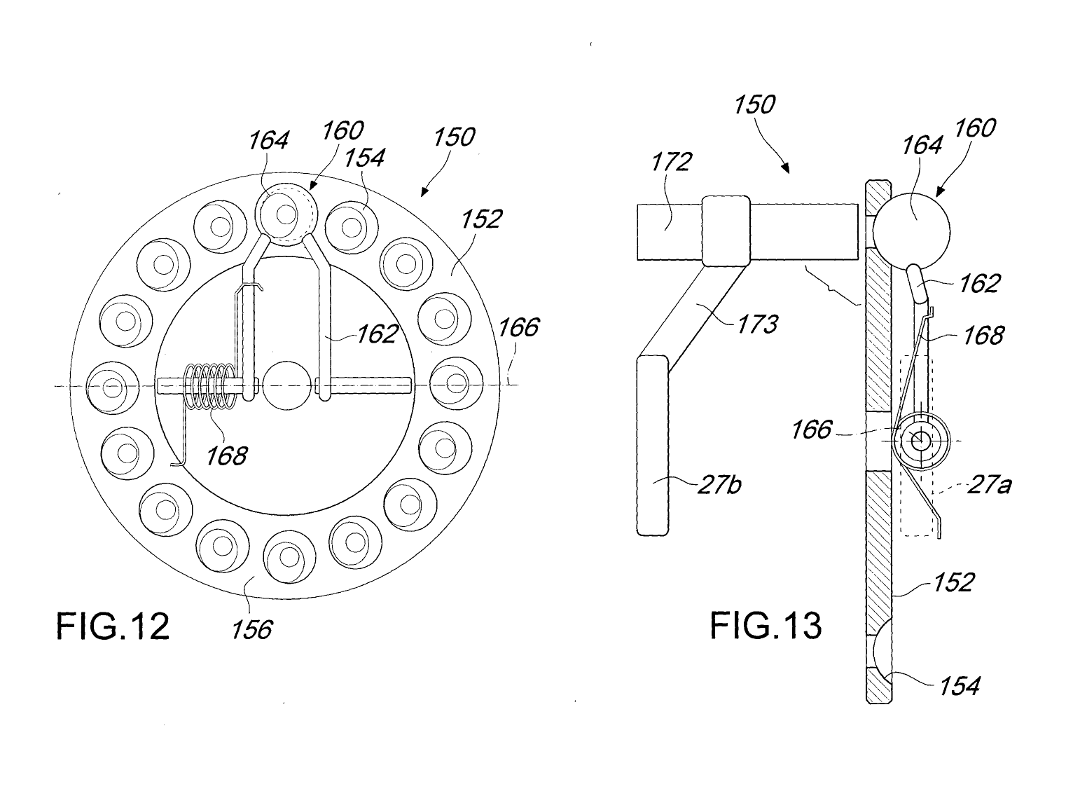

In FIGS. 12 and 13 we see an example multifunctional scrolling wheel according to a preferred embodiment. The wheel, generally designated by the reference numeral 150, comprises: a disc 152, indents 154 which are arranged along a circular path preferably on one side of the disc 152; a follower which comprises a hammer 160, the hammer 160 having a moveable arm 162 and an inertial mass 164, preferably metallic; the moveable arm 162 being adapted to rotate around an axis 166 that is substantially perpendicular to the rotation axis of the disc 152, and being compressed against the disc 152 by way of elastic means 168; the inertial mass 164 being adapted to engage the indents 154 and being adapted, when the disc 152 turns, to retard the movement of the hammer 160 on entering and on exiting from the indents 154 so as to prolong the stroke of the wheel.

In one implementation the wheel further comprises: at least one magnet 172 which engages with the indents 154, preferably on the opposite side of the disc 152 with respect to the side on which the indents 154 are located; the magnet 172 being adapted to attract or repel at least one part of the hammer 160 so as to favor or contrast the action of the elastic means 168.

In the example in the figure the magnet 172 is configured to attract the inertial mass 164 toward the indents 154. In a given instant the forces acting on the hammer 160 are given by the sum of the force exerted by the elastic means 168 and the force of attraction of the magnet 172. When the wheel is stationary the force of attraction of the magnet 172 is maximal. When the wheel turns and the inertial mass 164 comes to be outside the indents 154, said force is considerably reduced. When the wheel turns rapidly, the force acting on the inertial mass 164 tends to balance the force exerted by the elastic means 168 on the hammer 160. As a consequence of this the inertial mass 164 tends to remain outside the indents 154 where the magnetic force acting on it is minimal. This condition ensures that the wheel turns more rapidly. When the wheel is rotated slowly, on the other hand, the force acting on the inertial mass 164 is minimal and the hammer 160 behaves in the manner of a hammer with virtually no mass. In this situation the elastic and magnetic forces behave substantially like an elastic means of resistance which is equal to the sum of the elastic and magnetic forces. The end result is a wheel that produces clear and precise ticks when it is rotated slowly and which progressively retards the end of the stroke when it receives a progressively stronger or weaker rotary impulse.

In one implementation the magnet 172 can be incorporated directly in the disc 152. In another implementation the disc 152 incorporates a plurality of magnets, as many as there are indents 154. The indents 154 can be located in a cylindrical portion of the wheel. The disc 152 can be advantageously associated with a metallic shell.

### System for Making a Surface Uniformly Clickable

According to another aspect of the present disclosure, the disclosure relates to a system for making a surface uniformly clickable. The system is characterized in that it comprises actuators which are adapted to produce, in response to pressure on a moveable element, the triggering of a single switch or equivalent device.

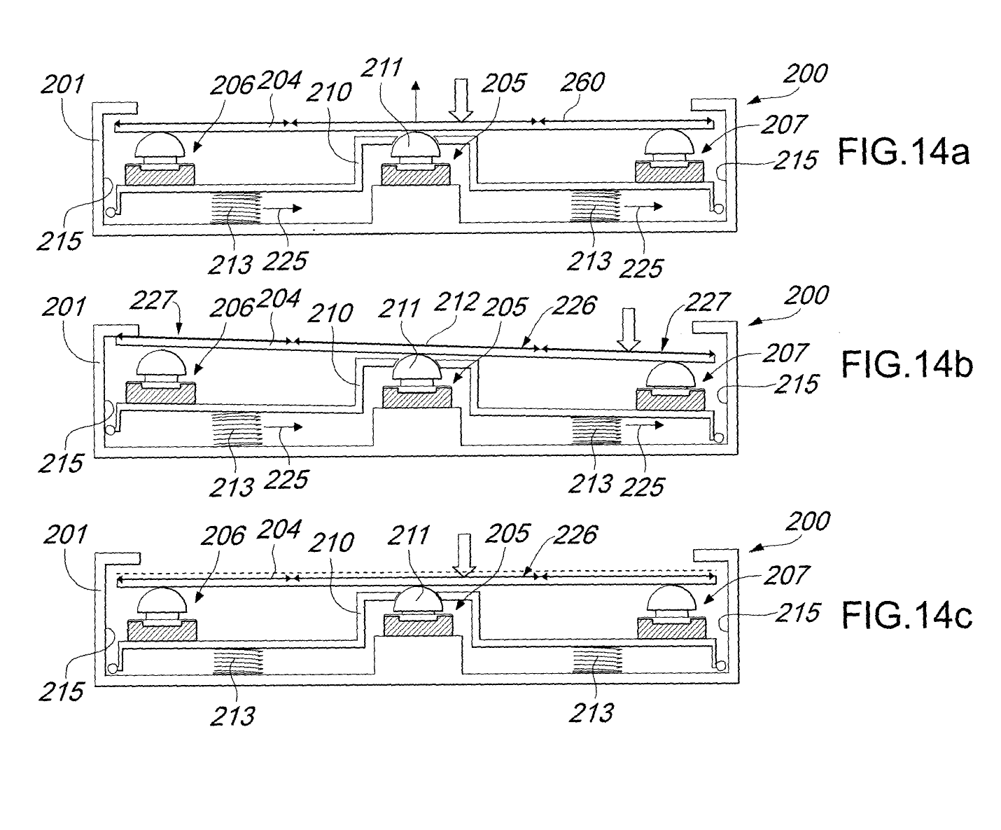

In FIGS. 14a, 14b and 14c we see an example device which implements the system for making a surface uniformly clickable according to a first preferred embodiment. The system, generally designated by the reference numeral 200, comprises: a housing 201; a moveable element 204; a first fixed switch 205; a tilting bracket 210; and one or more moveable switches 206, 207 which are arranged advantageously at the ends of the tilting bracket 210. The tilting bracket 210 is coupled to the moveable part 211 of the fixed switch 205 and can perform oscillations about said moveable part 211. The tilting bracket 210 is configured to oppose, at least beyond a certain angle of oscillation, a resistance to the oscillatory movement, locking itself totally at the occurrence. The moveable element 204 engages with the fixed switch 205 and the moveable switches 206, 207 and is such as to follow, at least partially, the movement of the tilting bracket 210. If the user proceeds to exert a pressure on the moveable element 204 at progressively closer points to the point of oscillation 212, and starting from the ends of the moveable element 204, the triggering is obtained of the closest moveable switch 206, 207 to the point of pressure, up to a limit beyond which the triggering of the fixed switch 205 is obtained. The triggerings of the switches 205, 206, 207 are mutually exclusive. With reference to FIG. 14b, pressure at a point of the triggering zone 227 corresponding to a moveable switch 207 induces the tilting bracket 210 to rotate about the point of oscillation 212 until it encounters the resistance induced, for example, by the impact of a part of the tilting bracket 210 with a substantially fixed part 215 of the device 200, or by the deformation of a spring 213. If the resistance to the oscillating motion of the tilting bracket 210, indicated in the figure with an arrow 225, exceeds the resistance of the moveable button 207, then the latter will be triggered. If the resistance to the oscillating motion of the tilting bracket 210 is less than the resistance of the moveable button 207, then the fixed button 205 will be triggered. The resistance to the oscillating motion of the tilting bracket 210 can be made to depend on the position of the point of pressure on the moveable element 204. In the figure, the resistance to the oscillating motion of the tilting bracket 210 is produced by a coil spring 213 which also serves to return the tilting bracket 210 to the initial position of equilibrium (FIG. 14a).

With reference to FIG. 14c, a pressure exerted on the moveable element 204 within the triggering zone 226 of the fixed button 205 causes the lowering, substantially by way of translation, of the moveable element 204 and the triggering of the fixed switch 205 underneath. The lowering of the moveable element 204 induces the tilting bracket 210 to perform a similar movement downward which prevents the moveable switches 206, 207 from being triggered in consequence of the lowering.

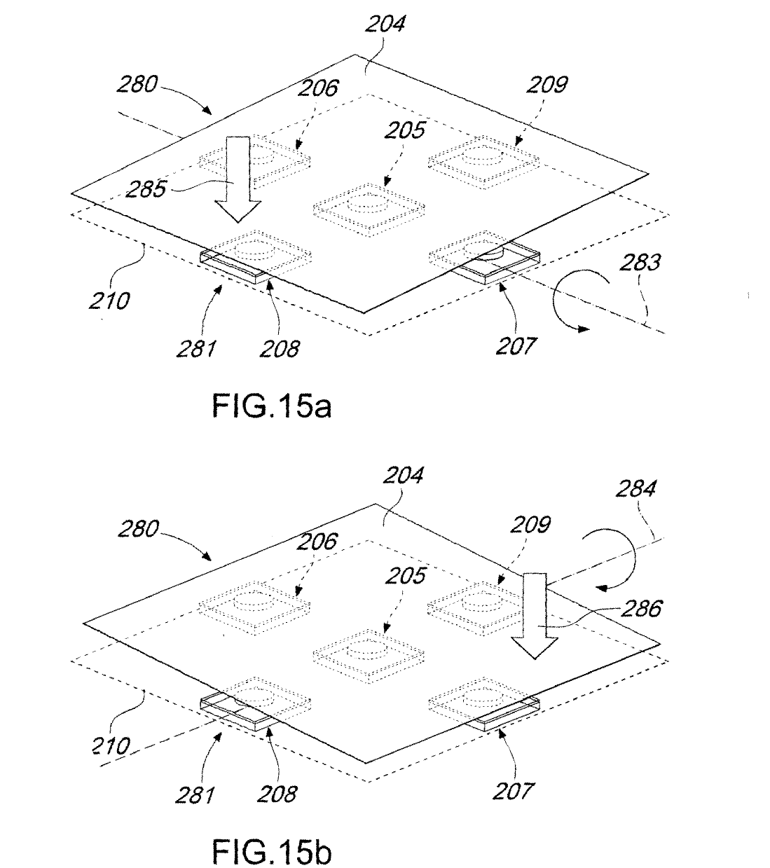

In one implementation the tilting bracket 210 is free to oscillate about at least two axes. In FIGS. 15a and 15b we see, in schematic form, a tilting bracket 210 which supports two rows 280, 281, advantageously at right angles, of moveable switches 206, 207, 208, 209 which have a common fixed switch 205. The first row 280 comprises the switches 206, 205 and 207, the second row 281 the switches 208, 205 and 209. The figure shows two examples of triggering of moveable switches 208, 207 as a consequence of a pressure on the moveable element 204 in the respective triggering zones. In FIG. 15a a pressure on the point indicated by the arrow 285 induces the moveable element 204 to rotate about a first axis 283 which is formed by the alignment of the switches of the row 280 and to trigger the closest moveable switch 208 to that point of pressure 285. Similarly, in FIG. 15b, a pressure on the point indicated by the arrow 286 induces the moveable element 204 to rotate about a second axis 284 which is formed by the alignment of the switches of the row 281 and to trigger the closest moveable switch 207 to that point of pressure 286. In the example in FIG. 15a, the resistance to the oscillating motion of the tilting bracket 210 can be such as to oppose the rotation of the tilting bracket 210 about the first axis 283. In the example in FIG. 15b, the resistance to the oscillating motion of the tilting bracket 210 can be such as to oppose the rotation of the tilting bracket 210 about the second axis 284.

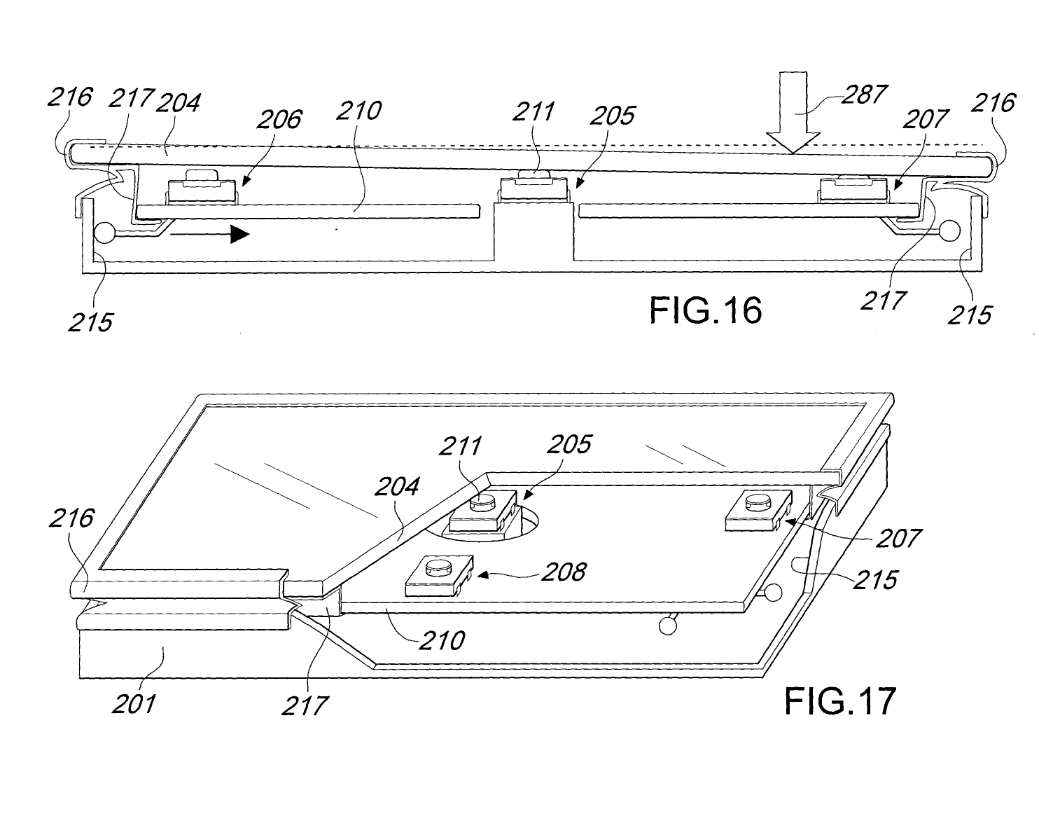

The resistance to the oscillating motion of the tilting bracket 210 can occur, in addition to by elastic means, such as coil springs, leaf springs, and almost any other type of spring, also by magnetic, electromagnetic and mechanical means in general. In particular at least part of this resistance can originate from a gasket such as, for example, the gasket 216 shown in FIGS. 16 and 17, respectively in a side view and in a perspective view. FIG. 16 shows an example of triggering of a moveable switch 207 following the pressure at a point of the moveable element 204 indicated with the arrow 287. The gasket 216 in the example is of the bellows type and couples the moveable element 204 to the moveable parts of the switches 206, 205 and 207, and to a housing 201. The gasket 216, by folding in on itself on at least one side, makes it possible to lessen the distance between the moveable element 204 and the housing 201. With reference to the example in the figure, the force exerted at the point of pressure indicated by the arrow 287 is transmitted, by way of the moveable part of the closest moveable switch 207 to that point, to the tilting bracket 210, and from the latter to the housing 201. The resistance opposed by the housing 201 to the oscillating motion of the tilting bracket 210 makes it possible for the moveable switch 207 to be triggered. A gasket 216 of the type described offers the advantage, with respect to the spring in the previous example, of freeing the fixed switch 205 from the weight of the moveable element 204, by discharging that weight on the housing 201. In order to also free the fixed button 205 from the weight of the tilting bracket 210, the latter can be supported by way of stays 217, which are advantageously elastic. In the figures we see an example stay 217 which is constituted by an appendage which extends from the gasket 216 or from the moveable element 204 and perimetrically envelops at least one part of the tilting bracket 210. The gasket 216 in the example can be substituted by elastic and magnetic means in general and can contain liquids. The tilting bracket can advantageously comprise a PCB.

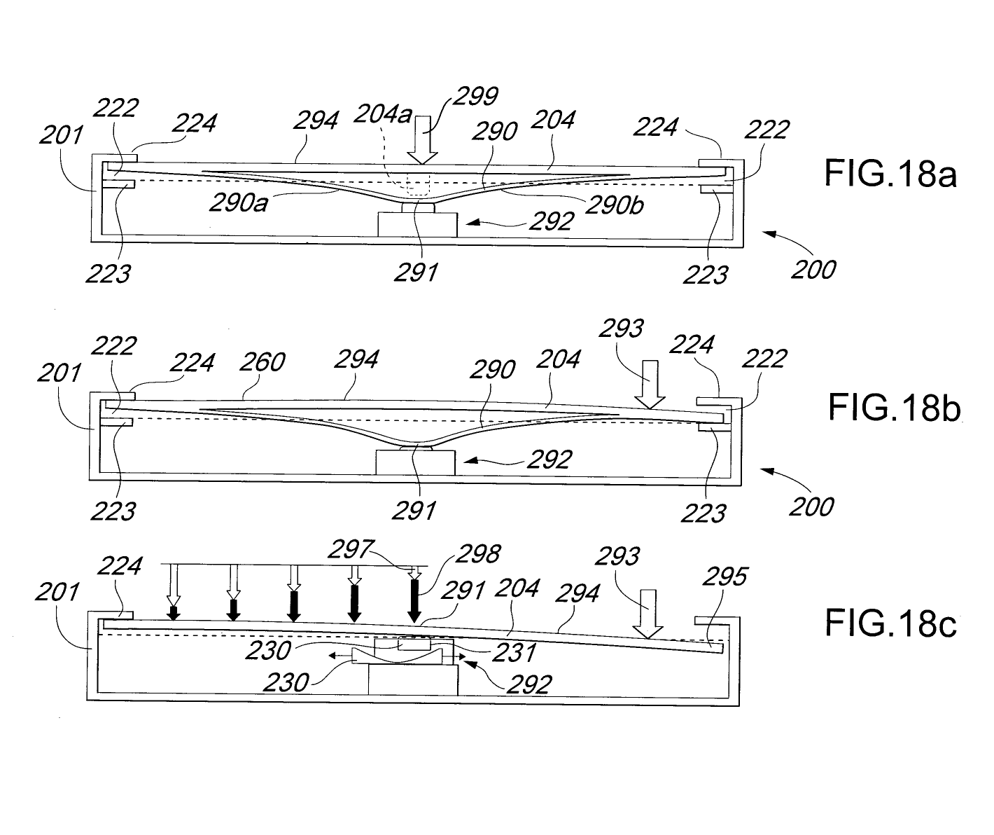

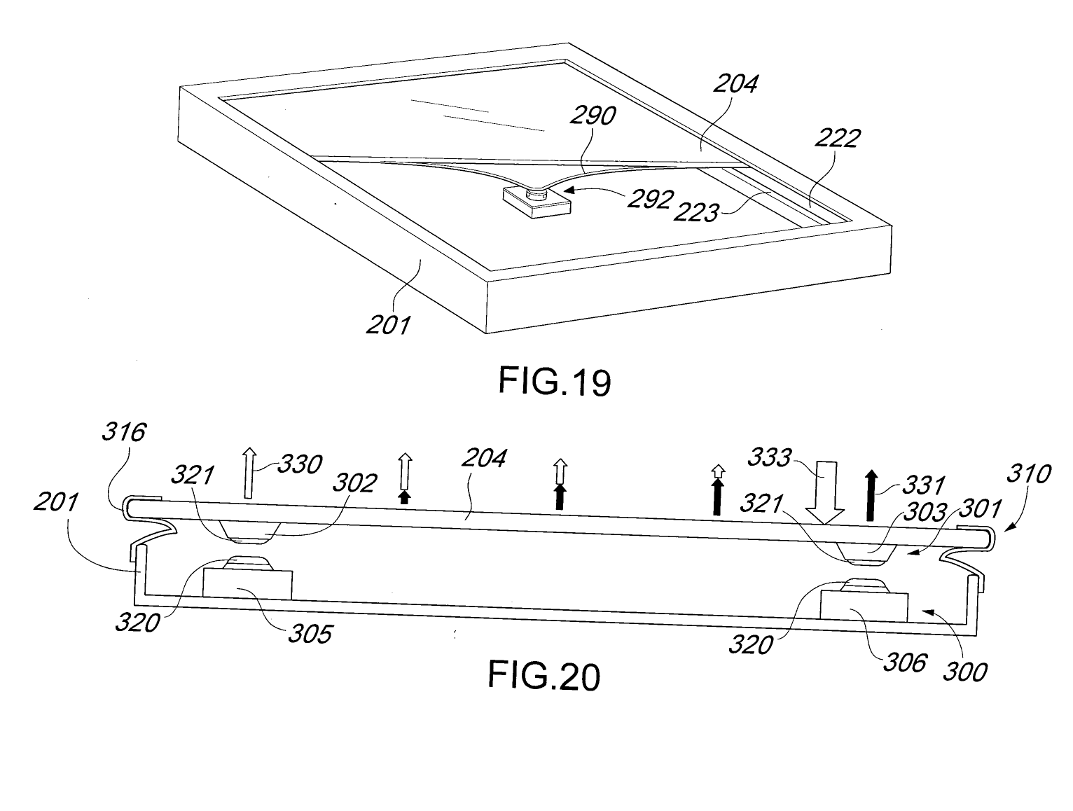

FIGS. 18a, 18b and 19 show an example of the system for making a surface uniformly clickable according to a second preferred embodiment. The system comprises a housing 201 which has a perimetric groove 222 which acts as a guide for the moveable element 204. The moveable element 204 has, in the lower part, a second, bulge-shaped surface 290, advantageously in the shape of a basin, and a switch 292 placed at the base of the housing 201, preferably in a central position. The moveable element 204 is accommodated in the perimetric groove 222 and rests, with the bottom 291 of the bulge 290, on the moveable part of the button 292. The lower protrusion 223 of the perimetric groove 222 constitutes a resting surface for the moveable element 204 when the latter is pressed, while the upper protrusion 224 of the perimetric groove 222 prevents the moveable element 204 from lifting on one side when it is pressed on the opposite side. The moveable element 204 is adapted to elastically deform by an amount sufficient to trigger the switch 292.

In order to render uniform the amount of force necessary to trigger the switch 292 in response to a pressure on any point of the moveable element 204, the system takes advantage of the properties of the principle of the lever applied to a flexible body. In order to better understand the problem see FIG. 18c, which shows an exemplary non-optimal system. In the figure we see the effect produced, on a moveable element 204 without a bulge 290, by a pressure 293 on a non-central zone of the moveable element 204. The moveable element 204, by levering the moveable part of the switch 292, compresses, with one end, the upper protrusion 224 of the perimetric groove 222. The force accumulated on the fulcrum 291 determines the arching of the moveable element 204 and, simultaneously, the triggering of the switch 292. According to the lever principle, for the same force employed at a point of the moveable element 204, the force exerted on the fulcrum 291 increases in a way that is directly proportional to the distance of the point from the fulcrum 291. Since, again according to the lever principle, the moveable element 204 offers a resistance to bending which is inversely proportional to said distance, it is possible to provide the moveable element 204 with an elasticity coefficient which is such that the perceived force of pressure on the switch 292 is uniform no matter what point of the surface 294 is pressed. The figure shows a graphical representation of the minimum force necessary to trigger the switch 292 at different points of the moveable element 204. The forces acting at a point are shown by way of arrows the length of which is proportional to the entity of the forces applied at that point. The sum of two components of the force which acts at a point is described by way of two overlapping arrows 297, 298. The white arrows 297 correspond to the work done by the force acting on the point in order to deform the moveable element 204 until the switch 292 is triggered, expressed in the form of a force perceived by the user. The black arrows 298 represent the minimum force necessary to exert on the point of pressure in order to trigger the switch 292 if the moveable element 204 were rigid. As can be seen, there is a coefficient of elasticity which is such that the sum of the two forces 297, 298 is uniform over the whole surface of the moveable element 204. The benefits obtained in terms of uniformity of pressure have a cost, however, in terms of excessive lowering of the ends 295 of the moveable element 204. It is possible to remedy this drawback by conveniently reducing the stroke for triggering the switch 292. In FIGS. 18a and 18b we see the moveable element 204 in its preferred implementation. In FIG. 18b the pressure 293 in a non-central zone of the moveable element 204 causes the dilation of the bulge 290 at its bottom with consequent reduction of the stroke of the switch 292 which is coupled to the bottom 291 of the bulge 290. Thanks to the particular shape of the bulge 290, the pressure at points of the moveable element 204 which are progressively farther away from the switch 292 will produce, for the same vertical space traveled by that point, a progressively greater reduction of the stroke of the switch 292. The progressive reduction of the stroke of the switch 292 makes it possible for the incident force which acts on a given point to complete the triggering of the switch by making the moveable element 204 travel the same amount of vertical movement, independently of whether the moveable element 204 is pressed in a central or peripheral region. With reference to FIG. 18a, when the moveable element 204 is compressed centrally by a pressure 299 it does not undergo particular deformations, thanks to the slightly curved cross-section of the two segments 290a, 290b of the bulge cross-section 290 which form the basin, behaving as a substantially rigid body. As can be seen in FIG. 18a the moveable element 204, when compressed, is supported by the lower protrusion 223 of the perimetric groove 222 and, in one implementation, by a central spacer 204a (dotted line).

With reference to FIG. 18c, in an alternative implementation, a progressive reduction of the stroke of the switch 292 can be produced by associating an actuator of the type of the bulge 290 in the previous implementation with one or more magnets 230 which act on the switch 292 so that the change of position of the magnets 230 with respect to the switch 292, induced by the pressure on the moveable element 204, determines a change of position of the moveable part 231 of the switch 292 according to the greater or lesser entity of that pressure.

In FIGS. 20, 21a, 21b, 21c and 23 we see, in side views and perspective views, examples of the system for making a surface uniformly clickable according to a third preferred embodiment.

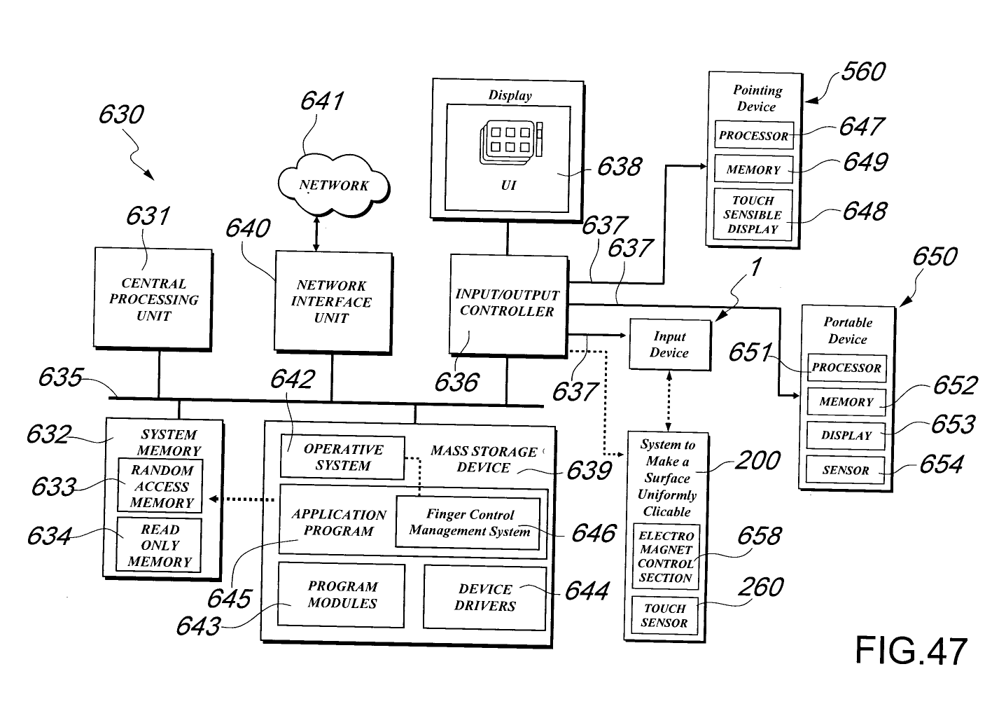

The system comprises: a housing 201, at least one electromagnet 300 which is coupled to the housing 201, a moveable element 204 comprising a pressure surface, at least one position magnet 301 which is coupled to the moveable element 204, the electromagnet 300 and the position magnet 301 being adapted to interact with each other in order to induce the moveable element 204 to move in at least one degree of freedom; link members 310 which are adapted to couple the moveable element 204 to the housing 201, the link members being adapted to allow the movement of the moveable element 204 in the at least one degree of freedom; an electromagnet control section 658 (FIG. 47). The magnetically induced movement of the moveable element 204 vertically with respect to the housing 201 is used by the system to simulate the resistance of triggering a switch. The magnetically induced movement of the moveable element 204 horizontally with respect to the housing 201 is used by the system to simulate the ticking of a scrolling wheel or of a slider if that movement corresponds, respectively, to a rotation of the moveable element 201 on itself or to a translational motion with respect to the housing 201.

In a first variation, and with reference to the example in FIG. 20, an electromagnet 300 and a position magnet 301 are arranged at the four corners of the moveable element 204. The moveable element 204 is held in elastic suspension on the upper part of the housing 201 by way of coupling means such as, for example, an elastic gasket 316. The end parts 320, 321 of each electromagnet 300 and of each position magnet 301 form electrical contacts. In the rest condition (moveable element 204 not pressed) the end parts 320, 321 of each electromagnet 300 and of each position magnet 301 are kept at a certain distance, corresponding, for example, to the stroke of an ordinary switch.

The principle of operation is the following: when a pressure is exerted at a point of the moveable element 204 the end part 321 of the position magnet 301 that is coupled to the moveable element 204 approaches the corresponding end part 320 of the electromagnet 300, the approach being picked up by the system 200 preferably in the form of currents induced in the circuit of the electromagnet 300. In response to this event, the system 200 reacts by inducing the electromagnet 300 to generate a magnetic field such as to cause repulsion of the position magnet 301 and, thus, of the moveable element 204. This repulsion increases with the increase of the pressure force until a limit value is reached, beyond which the repulsion force is abruptly reset to zero. The abrupt resetting to zero of the repulsion force causes, as a consequence of the persistence of the external pressure, the end parts 320, 321 of the magnets 300, 301 to collide sharply. The collision of the end parts 320, 321 of the magnets 300, 301 produces a sensory feedback which is perceptible by the user as a click. The contact of the end parts can be used to generate an electrical signal indicative of the moveable element 204 having been pressed.

With reference also to FIG. 47, the response of each pair of magnets 300, 301 to the pressure on the moveable element 204 can be varied by way of signals sent by the system 630 to the electromagnet control section 658. These signals can be generated by the system 630, or by a dedicated control section, in response to the information about the position of the point of pressure on the moveable element 204 which originates from the electromagnets 300 themselves or from adapted sensors. In the example in FIG. 20, points that are progressively farther away from an electromagnet 300 correspond to, for the same pressure, progressively smaller repulsion forces relative to that given electromagnet 300. The repulsion forces generated by different electromagnets 305, 306, which act, respectively, on the position magnets 302, 303, complement each other so that the sum of the values of the repulsion forces is, for each point of the moveable element 204, constant. In the figure this situation is shown by way of overlapping arrows 330, 331 drawn at a given point of the moveable element 204, the arrows 330, 331 having a length proportional to the magnetic repulsion force exerted, for that given point, by a given electromagnet 305, 306. The white arrows 330 refer to the electromagnets 305 on the left, and the black arrows 331 refer to the electromagnets 306 on the right. As can be seen the sum of the values of the repulsion forces exerted by the four electromagnets 300 in response to a pressure of uniform value, is, at each point of the moveable element 204, constant.

In the preferred implementation, the electromagnet control section 658, in response to an external pressure at a point of the moveable element 204, introduces, into the coils of a given electromagnet 300, a current which is substantially proportional to the current induced, in the coils, by the change of position, with respect to the electromagnet 300, of the position magnet 301 which is associated with the electromagnet 300. In this configuration the repulsion force of an electromagnet 300 depends substantially only on the movement, with respect to the electromagnet 300, of the point of the moveable element 204 which is associated with the electromagnet 300. By pressing on a given point 333, in fact, the moveable element 204 will tend to incline toward that point 333, thus generating, in the coils of the closest electromagnet 306 to that point 333, an induced current which is greater than that generated in the coils of the electromagnets 305 that are farther away. Since the distancing of the point of pressure from an electromagnet 300, for example the electromagnet 306, corresponds to approaching at least one other electromagnet 300, for example the electromagnet 305, the sum of the currents induced in each electromagnet 300 can be considered, for each point of the moveable element 204, substantially constant. This implementation has the advantage of not requiring additional sensors for the calculation of the position of the point of pressure and of not requiring further control circuits that are adapted to process the data originating from the additional sensors.

In order to simulate the resistance feedback of triggering a switch, the system 200 reacts to the pressure on the moveable element 204 by opposing that pressure with a force that is substantially equal and contrary to the pressure. This enables the moveable element 204 to remain substantially immobile or, at the outside, to perform small movements toward the housing 201, in this manner simulating the resistance feedback of triggering a switch. In order to simulate the click of a switch, the magnetic repulsion force against the moveable element 204 is abruptly reset to zero so as to induce the end parts of at least one pair of magnets 300, 301 to collide sharply. The abrupt resetting to zero of the magnetic field can occur when determined conditions are met. For example it is possible to reset the magnetic field of the electromagnets 300 when the pressure on the moveable element 204 exceeds a given threshold. Since the pressure is, as said above, proportional to the sum of the magnetic fields produced by the electromagnets 300, the system 200 can produce the abrupt resetting to zero of the magnetic fields when the sum exceeds a certain preset value. The pressure limit can be made to correspond to the typical pressure for triggering a switch. Since the sum of the magnetic fields is constant with the varying of the point of pressure, the pressure limit will in turn be constant. It follows from this that triggering the system will always require the same force, independently of the point of the moveable element 204 which is pressed.

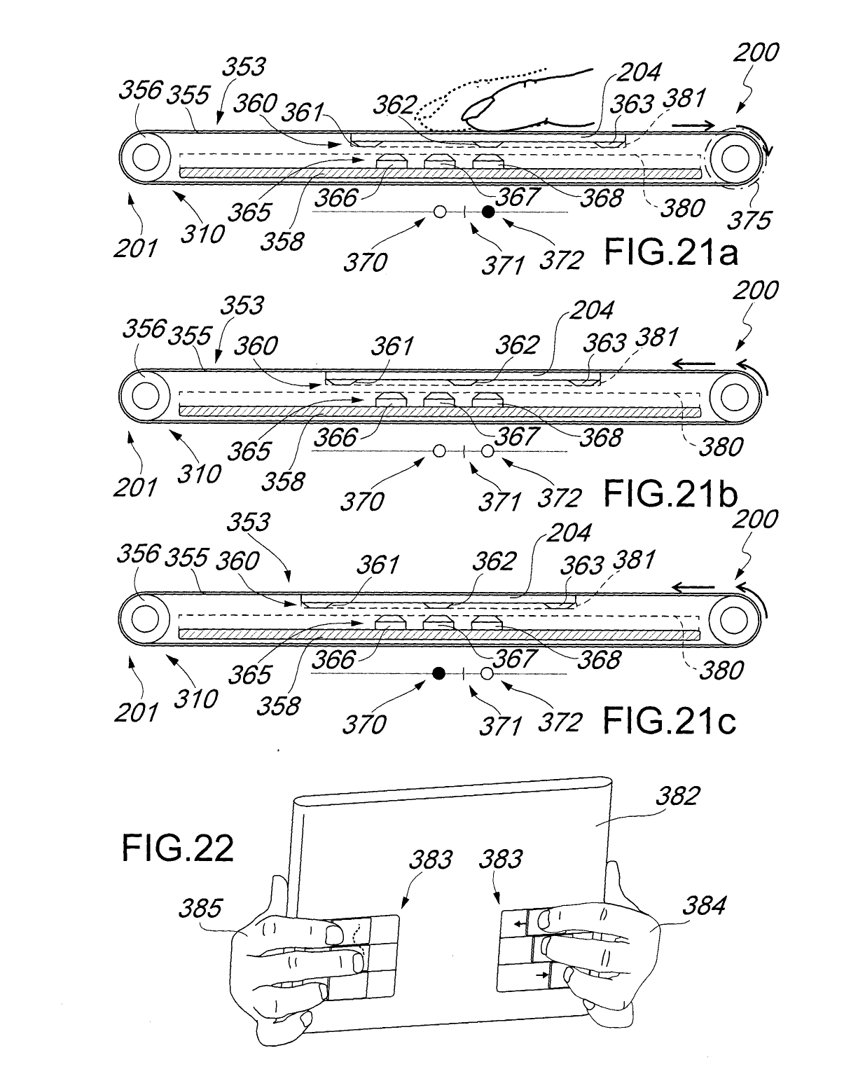

In a second variation, the system to make a surface uniformly clickable according to the third preferred embodiment appears, for example, as in FIGS. 21a, 21b and 21c. In this implementation a click is generated by the tick-delimited scrolling of a slider 204: by dragging the slider 204 with a finger the system 200 generates a series of ticks at substantially regular intervals which can correspond, for example, to the scrolling of a window on the screen. The system 200 further makes it possible to simulate the infinite scrolling of the slider 204 by way of a technique that is capable of rapidly returning the slider 204 to the rest position, as in FIG. 21c, before the finger can make it slide again. This characteristic enables the system to perform the functions of the input device 1 described earlier.

The system comprises: a belt 355 which is provided with at least one substantially flat portion 353, the belt 355 being adapted to slide around at least one supporting roller 356; a moveable element 204 which is coupled to the belt 355 and positioned at the substantially flat portion 353; the moveable element 204 being adapted to drag along with it the belt 355 when a traction in the direction of sliding of the belt 355 is exerted on the moveable element 204; a series of at least one position magnet 360 positioned preferably on the lower part of the moveable element 204; another series of at least two electromagnets 365 positioned along a supporting bracket 358, advantageously a PCB; the electromagnets 365 being capable of generating an electro-induced magnetic field which is such as to cause the sliding of the belt 355 by acting on the moveable element 204 by way of episodes of attraction and/or repulsion exerted on the position magnets 360 associated with the moveable element 204; an electromagnet control section 658 (FIG. 47). The supporting bracket 358 can be associated with a sliding platform 380 (dotted line) which is adapted to facilitate the sliding of the moveable element 204. The system 200 can be advantageously associated with a sensor that is capable of detecting the position or the presence of the finger over the surface of the moveable element 204 facing outward from the device 200. The system 200 can moreover be associated with a sensor, advantageously of the optical type, which is adapted to read the position of the moveable element 204 along the substantially flat portion 353 of the belt 355 and/or the position of the moveable element 204 with respect to the housing 201, not shown, along the vertical axis in the figures.

With reference to FIG. 21c, the moveable element 204 is initially located in a central position with respect to the belt 355 and includes, preferably, a strip of material that is very light and unaffected by magnetic fields, such as, for example, plastic or aluminum. The moveable element 204 occupies a part of the substantially flat portion 353 of the belt 355 and can slide in one direction or the other until it touches the ends thereof.

With reference also to FIG. 47, the principle of operation is the following: the user places a finger on the moveable element 204 and drags it for a portion in any direction; the system made up of the position magnets 360, the electromagnets 365 and the control section 658 detects the movement of the moveable element 204 and opposes a force that is adapted to retain it. Once a determined range of movement is exceeded, the magnets instantly cease the retaining action. After another range of movement the magnets start exerting, on the moveable element 204, an opposite action to the previous one, this time aimed at pushing the moveable element 204 forward in the direction of motion already embarked on. This action stops at the end of the range, and from this moment onward the method is repeated in a similar manner for the subsequent movements, whatever direction the belt 355 is made to take. This technique makes it possible to faithfully simulate the behavior of a mouse wheel, in particular the formation of the typical tick. As soon as the touch sensor or position sensor detects that the user has lifted the finger from the moveable element 204, the electromagnet control section 658 triggers a series of attraction and/or repulsion actions on the position magnets 360 which are such as to put the moveable element 204 in motion and return it in the shortest possible time, and from any position, to the initial rest position, as in FIG. 21c. This action, if performed with the necessary swiftness, enables the user to virtually rewind the belt 355.

An electromagnet control section can induce a plurality of magnets to produce a magnetic field according to time sequences which are such as to produce, on a reactive body, actions such as rotation or translational motion. This technique is currently used in stepper motors and makes it possible to precisely position one body with respect to another by way of electronic signals.

On detecting the onset of electrical currents induced in an electromagnet by the transition, at close quarters, of another magnet, an electromagnet control section can glean information about the position, the speed and the direction of travel of that magnet. In one implementation this function can be performed by a separate sensor, advantageously of the optical type.

With reference to FIGS. 21a, 21b and 21c, a method for the simulation of tick-delimited scrolling can be provided in the following manner: When the moveable element 204 is stationary, as in FIG. 21c, and in a position that coincides with a tick 370, the action of the electromagnets 365 on it is nil. When the moveable element 204 is moved in one of the two directions starting from this position, as in FIG. 21b, the movement of the position magnet 362 is intercepted by the control section 658 which reacts by inducing the electromagnet 367 to generate a magnetic field which is such as to cause the attraction of the position magnet 362 and thus of the moveable element 204. The user perceives this resistance and interprets it as the start of a tick. Toward the half way 371 of the distance that separates one tick 370 from another 372, this resistance is abruptly eased off. As the position magnet 362 approaches, from the position indicated in FIG. 21b, a new tick point 372, in FIG. 21a, the electromagnet 368 which is positioned, on the supporting bracket 358, farther along in the direction of motion with respect to the position magnet 362 begins to exert a force of attraction on the position magnet 362, which is ever-increasing and is maximal at the new tick point 372. Once the moveable element 204 has been entrained to a tick point the force of attraction can cease and the method can be repeated.

In order to facilitate the settling of the moveable element 204 in the new tick position and ensure that continuous corrections of position by the electromagnets 365 are not triggered, the sliding platform 380 and the part 381 of the moveable element 204 which is juxtaposed with it can be provided, at each tick point 370, 372, with indents.

In FIGS. 21a, 21b and 21c we see an example sequence of advancement of the moveable element 204 by way of three electromagnets 366, 367, 368. In FIG. 21a, the moveable element 204 has been entrained by the user from the rest position in FIG. 21c to the tick point 372 and subsequently released. From information gleaned from previous movements and from other sensors if present, the system 200 deduces that a position magnet 362 is arranged at the rightmost electromagnet 368 and emits a signal with which the control section 658 is instructed to induce the central 367 and rightmost 368 electromagnets to generate a force of magnetic attraction on that position magnet 362. As a consequence of this the position magnet 362 is brought to an intermediate point 371 between the two electromagnets 367 and 368, as in FIG. 21b. Subsequently, with a similar action, the rightmost electromagnet 368 is deactivated and the moveable element 204 returns to the rest position, as in FIG. 21c, thanks to the attraction exerted on the position magnet 362 by the central electromagnet 367. If the return stroke starts from a higher number of ticks performed, then the sequence of advancement will affect a greater number of position magnets 361, 362. Once the moveable element 204 has returned to the rest position it is no longer necessary to supply power to the circuit for the electromagnets 365 until the next scrolling of the belt 355. In order to reduce the dissipation of energy to the input device 1, elastic means can be associated which are adapted to return the moveable element 204 to the rest position. In one implementation, such elastic means can be, at least partially, constituted by the belt 355 itself.

A vertically-directed pressure at a point of the moveable element 204 also causes the triggering of a switch which is constituted, at least partially, by the same position magnets 360 and electromagnets 365 according to the methods described for the first variation of the third embodiment of the system to make a surface uniformly clickable.

In another implementation the movement of the moveable element 204 is induced and/or controlled according to the methods described above, by way of an electric motor 375, preferably of the stepper type, which is advantageously coupled to at least one of the rollers 356.

In yet another implementation the moveable element 204 slides on the sliding platform 380 without using a belt 355 or rollers 356.

As already mentioned, the second variation of the third embodiment of the system to make a surface uniformly clickable can be used as an alternative to the previously described implementations of the input device 1. In particular this embodiment can be used in devices of reduced size, typically in thin and ultrathin portable devices such as, for example, cellular phones and tablet computers. In FIG. 22 we see an implementation example of the system 200 in a tablet computer 382. The user holds the tablet computer 382 with the hands while, with the fingers of each hand, the user manipulates a series of three sliders 383 which are provided in conformance with the second variation. The fingers of the left hand 384 offer an example of simultaneous manipulation of sliders 383, by way of which it is possible, for example, to manipulate the graphical interface system discussed later on in this description. The fingers of the right hand 385 offer an example of controlling a pointer on screen by means of touch sensors associated with at least one slider 383 of the series of sliders. When the sliders 383 are in the rest position their touch sensitive surface can be used by the user to move at least one pointer on the screen in the same way in which an ordinary touch pad is used. The touch sensitive surface is moreover uniformly clickable.

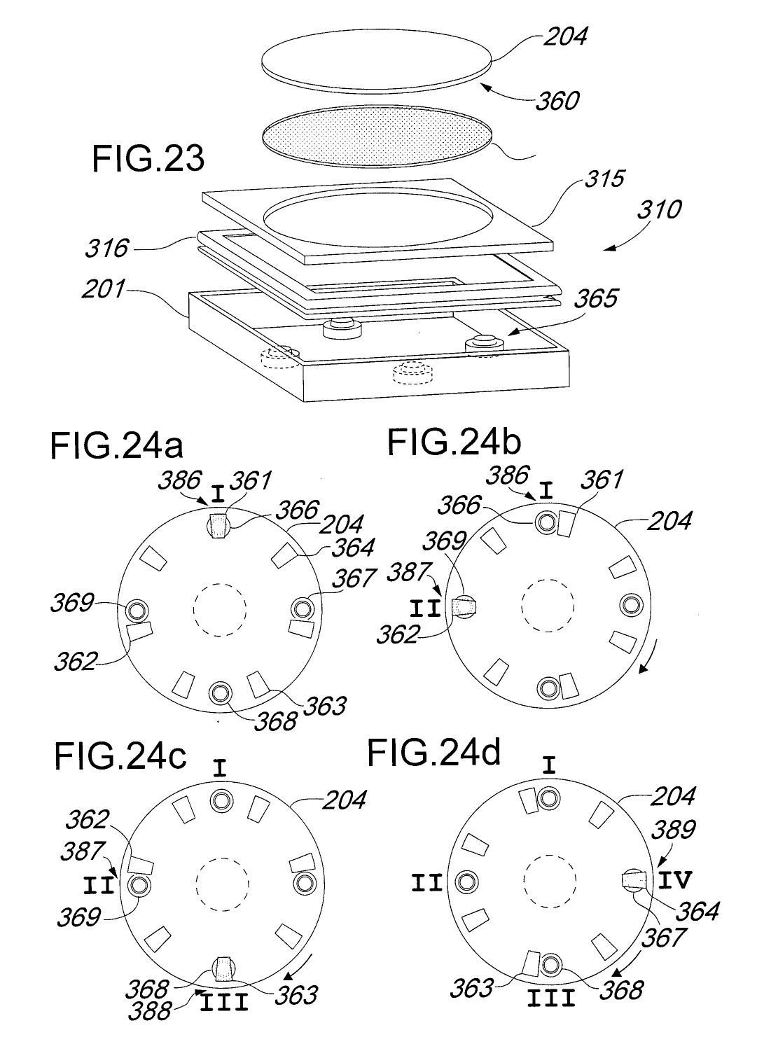

In a third variation, the system to make a surface uniformly clickable according to the third preferred embodiment appears, for example, as in FIG. 23. In this implementation the moveable element 204 can be rotated on itself in a similar manner to the use of a handgrip. The rotation of the moveable element 204 produces, at substantially regular intervals, a series of ticks in a similar manner to that of the previous implementation. The rotation of the moveable element 204 can, moreover, be driven by the system 630 (FIG. 47) by way of a sequence of advancement similar to that of the previous implementation.

The system comprises: a housing 201, a moveable element 204, link members 315 which are adapted to allow the rotation of the moveable element 204 with respect to the housing 201 about an axis extending from the pressure surface, a series of at least one position magnet 360 positioned preferably on the lower part of the moveable element 204, another series of at least two electromagnets 365, which are electronically controllable by way of an adapted control section 658 (FIG. 47), and positioned along a supporting bracket, not shown, or at the base of the housing 201; the electromagnets 365 being capable of generating an electro-induced magnetic field that is such as to cause the rotation of the moveable element 204 by acting on the moveable element 204 by way of episodes of attraction and/or repulsion exerted on the position magnets 360 which are associated with the moveable element 204. The link members 315 can comprise a support, like the one shown in the figure, which is provided with a seat that is adapted to accommodate the moveable element 204 and to follow its rotary movement.

The principle of operation is similar to that of the previous implementation, with the sole difference that the movement of the position magnets 360 occurs in a circular path instead of in a linear path.

In FIGS. 24a, 24b, 24c and 24d we see, in schematic form, an example of the method for simulating tick-delimited scrolling. With reference also to FIG. 47, when the moveable element 204 is stationary, as in FIG. 24a, and in a position that coincides with the tick 386 marked by the Roman numeral I, the action of the electromagnets on the moveable element 204 is nil. When the moveable element 204 is made to move in one of the two directions starting from this position, the movement of the position magnet 361 is intercepted by the control section 658 which reacts by inducing the electromagnet 366 to generate a magnetic field which is such as to cause the attraction of the position magnet 361 and thus of the moveable element 204. The user perceives this resistance and interprets it as the start of a tick. At about half way along the distance that separates one tick 386 from another 387 (FIG. 24b, rotation to the right), this resistance is abruptly eased off. As the position magnet 362 approaches a new tick point 387, as in FIG. 24b, Roman numeral II, the electromagnet 369 which is positioned farther along in the direction of motion with respect to the position magnet 362 begins to exert a force of attraction on the position magnet 362, which is ever-increasing and is maximal at the new tick point 387. Once entrained by the moveable element 204 to a tick point the force of attraction can cease and the method can be repeated.

In FIGS. 24a, 24b, 24c and 24d we see an example sequence of advancement of the moveable element 204 by way of four electromagnets 366, 367, 368, 369. In FIG. 24a the moveable element 204 is in a rest position corresponding to the tick 386 marked by the Roman numeral I. In FIG. 24b the control section 658 has induced the electromagnet 369 to generate a force of attraction on the position magnet 362. As a consequence of this, the moveable element 204 rotates by one position to the right, corresponding to the tick 387 marked by the Roman numeral II. In FIGS. 24c and 24d the moveable element 204 is made to advance by another two ticks 388, 389 by actuating in succession first the electromagnet 368 and then the electromagnet 367. With a similar method it is possible to invert the direction of sliding of the moveable element 204.

In one implementation the rotating moveable element 204 in the previous implementation is made uniformly clickable by combining the first variation, in FIG. 20, and the third variation, in FIG. 23, into a single device. This can be done, starting from the third variation, by modifying the link members so that the moveable element 204 can perform, together with its support 315, vertical movements which are adapted to allow the moveable element 204 to be pressed as well as rotated. This result can be achieved by coupling the support 315 of the moveable element 204 to the housing 201 by way of an elastic gasket 316 or any elastic or magnetic means adapted to elastically suspend the support 315 on the housing 201. The electromagnets 365 and the position magnets 360 in FIG. 23 can be used both to rotate the moveable element 204 according to the methods of the third variation, in FIG. 23, and to generate a click according to the methods of the first variation, in FIG. 20. Pairs of collision terminals 320, 321 can be variously associated with the housing 201 and with the support 315 of the moveable element 204. Pressure on one point of the moveable element 204 causes the approaching of the collision terminals 320, 321 as previously described with respect to the first variation.

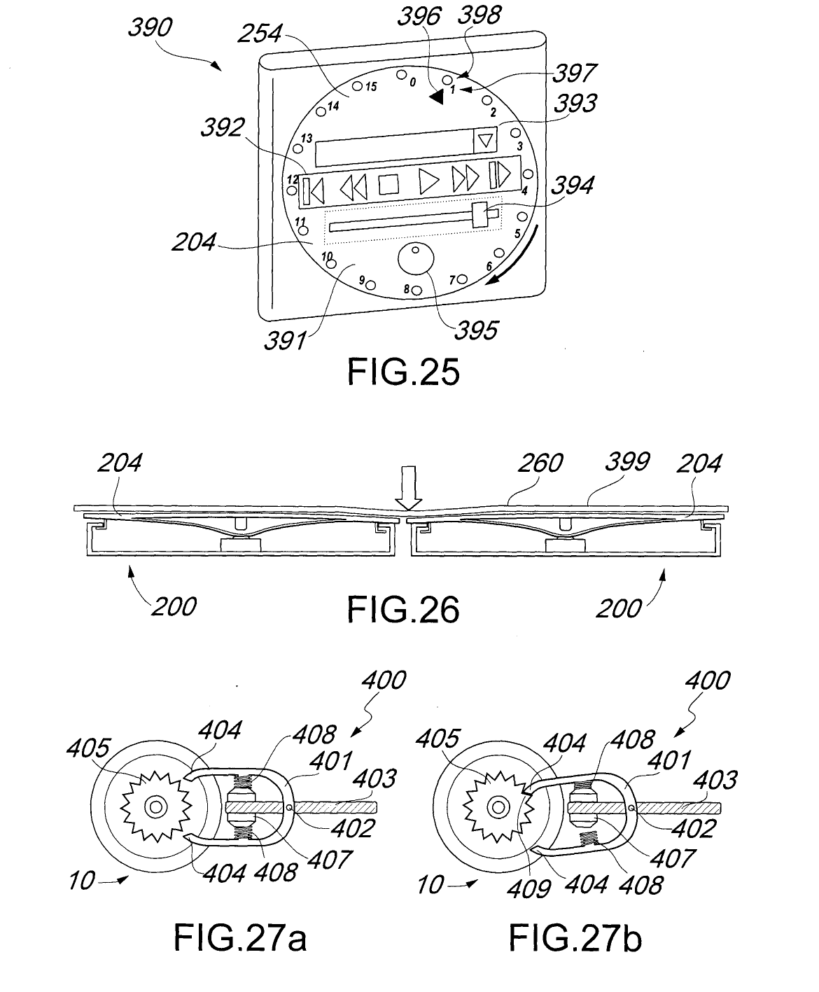

In FIG. 25 we see an example of application of the system 200 according to the embodiment that we are describing to a portable device, specifically a media player 390. The moveable element 204 is associated with a touch-sensitive screen 391 by way of which the user can actuate a graphic control 392 by clicking directly thereon with the finger. Graphic controls 392 that require the scrolling of a list can be controlled by way of the rotation of the moveable element 204 according to a number of ticks corresponding to the amount of elements of the list to scroll. For example, in order to select a music track listed in the combo box 393, a new position on the timeline 394, or a new value for the volume control 395, the user selects the appropriate control by clicking or tapping on it and subsequently rotates the moveable element 204 by an amount corresponding to the selection of a new value for that control. In one implementation the system 200, in response to the selection of a control, makes the moveable element 204 rotate until it points, by way of an adapted sign 396, to the number 397 or graphical representation 398 corresponding to the currently selected value for that control. For example selecting the combo box 393 in the example could correspond to pointing, by means of the sign 396, to the number 397 indicating the position, in the list of the combo box 393, of the currently selected track.

In another implementation the three variations are combined so that the moveable element 204 can be simultaneously clicked, rotated and translated.

The first, second and third embodiment of the system to make a surface uniformly clickable and the first, second and third variation of the third embodiment of the system to make a surface uniformly clickable can be associated with a sensor 260 which is adapted to read the position of contact of the finger of the user with the moveable element 204 or with elements associated with it. The output of the sensor 260 can be associated with the output of a switch or, more generally, of a click generator in order to make a selection on the screen. By associating a touch pad or a touch screen with the moveable element 204 the system 200 makes it possible to provide touch pads or touch screens that are uniformly clickable.

Very large surfaces can be made uniformly clickable by associating them with multiple devices that implement the system described. In the example in FIG. 26 we see the modular coupling of two devices 200 that implement the system to make a surface uniformly clickable according to the second preferred embodiment. The moveable elements 204 of the devices 200 are associated with a display 399, preferably of the OLED type, and a sensor 260. With this system it is possible to render clickable touch-sensitive screens of any size and of any shape (for example curved screens).

### Input Device Locking System

According to another aspect of the present disclosure, the disclosure relates to a system for locking the slideable member of an input device. The system, generally designated by the reference numeral 400, is adapted to lock the scrolling of the slideable member 2 after a determined number of ticks by means of the same finger that puts the slideable member 2 in rotation. The locking of the slideable member 2 can intervene via the increased pressure of the finger on the slideable member 2, via the slideable member 2 reaching a rotation speed limit, or via both events.

According to a first embodiment and with reference to FIGS. 27a and 27b, the locking system 400 comprises an actuator 401 that tilts about an axis 402 placed at a support bracket 403, advantageously a PCB; the actuator 401 being provided with ends 404 that are adapted to engage with a toothed wheel 405 which is integral with the wheel 10 within an input device 1; at least one electromagnet 407 controlled by an adapted control section 658 (FIG. 47) and being adapted to induce the actuator 401 to rotate about its axis 402 by means of electromagnetic attraction exerted on it; and elastic means 408 which are adapted to return the actuator 401 to the rest position. In the rest position, as in FIG. 27a, the elastic means 408, in the absence of the electromagnetic field induced by the electromagnet 407, deploy the actuator 401 so that its ends 404 do not interfere with the rotation of the wheel 10. Following the arising of the conditions that render locking of the wheel 10 necessary, for example because the user imparted a sudden acceleration to the belt 2, the system 400 proceeds to determine the direction of sliding of the wheel 10 and to energize the electromagnet 407 so that the latter, by attracting the appropriate end 404 of the actuator 401, as in FIG. 27b, causes the collision of the end 404 with a tooth 409 of the toothed wheel 405, locking it. The shape of the teeth on the toothed wheel 405 and on the ends 404 of the actuator 401 are such as to allow the disengagement of the actuator 401 from the wheel 10, and the consequent return of the actuator 401 to the rest position by way of the elastic means 408, as in FIG. 27a, by briefly inverting the rotary motion of the wheel 10 and in the absence of the magnetic field induced by the electromagnet 407. The magnetic field can therefore conveniently be in the form of an impulse.

With reference to FIGS. 21a, 21b and 21c, according to a second embodiment of the locking system of the slideable member applied to the second variation of the third embodiment of the system to make a surface uniformly clickable, an abrupt acceleration of the moveable element 204 and/or greater pressure on the moveable element 204 by the finger that is moving it determine the arrest of the moveable element 204 in a position corresponding to a tick by way of electromagnetic forces. This abrupt acceleration of and greater pressure on the moveable element 204 can be picked up by the system 200 both by way of electromagnets 265 and by way of other sensors if present, and can induce the electromagnet control section 658 (FIG. 47) to generate, according to the methods previously described, a magnetic field that is such as to oppose a further advancement of the moveable element 204.

The utility of this method will be clear from reading the part of this description which deals with the new technique of character input based on the use of the input device 1.

### Ergonomic Input Device

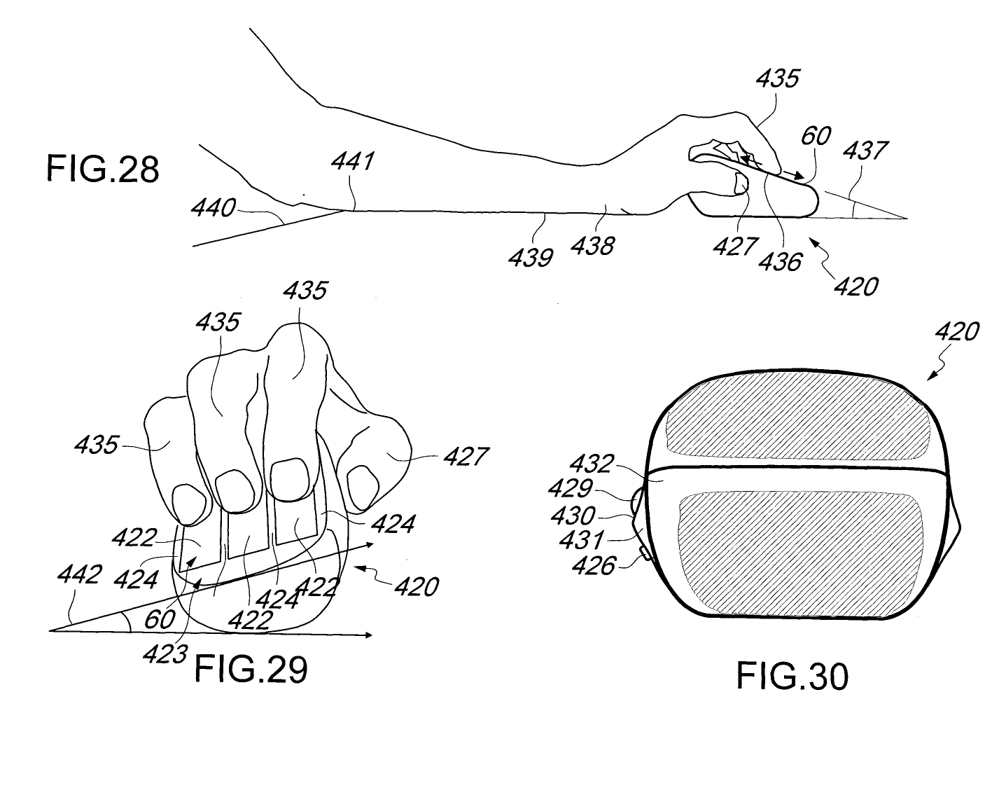

In the preferred implementation the input device 1 has an ergonomic shape that in its turn constitutes inventive novelty. In FIGS. 28 to 31 we see an example ergonomic input device, generally designated by the reference numeral 420, applied to a pointing device, in this case a mouse.

With particular reference to FIGS. 29 and 31, the input device 1 allows for the modular coupling of two or more scroll buttons 422, together forming a scroll board 423. At the sides of the scroll board 423 and of each scroll button 422 there are strips of conductive material (advantageously conductive paint) which implement the contact (not position) type of sensor called “contact band” 424. This conductive strip sensor 424 acts in substance as a switch (one for each strip), but, unlike an ordinary switch, it can be extended in length so that it is always within reach of the finger. Since a conductive strip 424 is a touch sensor, it is sufficient to lightly touch to trigger it. Moreover it can be equally easily deactivated by breaking off contact with it. These characteristics make it a valid aid to selecting secondary elements or to modifying the behavior of the sensor 60 associated with the moveable member 4 or to multiplying the virtual area of the sensor 60, for example by moving the finger on the sensor 60 while maintaining contact with a band 424. In the preferred implementation, and in order to meet the requirements of the new graphical interface system which is described later, the ergonomic input device 420 is provided with two auxiliary controls. The first is a “side switch” button 426 which is positioned at the height of the thumb 427 in its rest position, the second is a thumb-roller 429, i.e. a mouse wheel having the shape of a thin roller and adapted to be rotated vertically preferably by the thumb 427. The thumb-roller 429 is advantageously located slightly higher than the side switch 426 and preferably on the same vertical axis. In order to facilitate the use of the thumb-roller 429 it is positioned on a protrusion 430 which is provided along the side 431 of the housing 432. The protrusion 430 has a certain slope and enables the thumb 427 to discharge part of its weight on it. The rotation of the thumb-roller 429 by the thumb 427 occurs by dragging it with the inner part of the knuckle and keeping the thumb straight and immobile, except for the first joint (abductor muscles) of the thumb 427, a joint which, by its nature, has great muscular force. On the contrary, ordinary thumbwheels are, for the most part, simply mouse wheels placed in a horizontal position and this involves that all the muscles of the thumb must contribute to their manipulation. A scroll board 423 must be capable of being actuated by the fingers along the entire sensor surface 60. For best performance it is recommended that the fingers 435 (preferably the index, middle and ring fingers) rest, in the rest position, at around its half way point 436. In this manner the direction of movement can give indications of the user's intentions, and the system 630 can respond more rapidly to his or her requests. In such regard it is necessary that the scroll board 423 be inclined longitudinally at an angle 437, as shown in FIG. 28, and that the fingers 435 be slightly bent. This position involves flattening the wrist 438 on the resting surface 439 of the ergonomic input device 420, which contributes to giving more freedom of movement to the hand in all directions with respect to the traditional posture. Flattening the wrist 438 also decreases the influence of the edge 440 of the table on the lower part 441 of the forearm, a factor that, usually, causes many problems with the integrity of the arm. The posture, moreover, favors activities like artistic and technical drawing since the hand, free from the limitation caused by the edge 440 of the table, can move with the same freedom in all directions.

Even better ergonomics are achieved by subjecting the scroll board 423 to an additional inclination 442 in a lateral direction, as illustrated in FIG. 29. In this manner the natural shape structure is preserved of the fingers 435 of the hand which, in the rest position, is rotated slightly toward the thumb 427. The double inclination 437, 442 ensures maximum ergonomics for a system that sets out to also be an alternative to the tablet pen system. The aforementioned posture is the same one that the hand assumes in the rest position, even when one is standing erect and allows the arms to fall to the sides, and it is, for that reason, a guarantee of efficacy.

### Self-Cleaning System

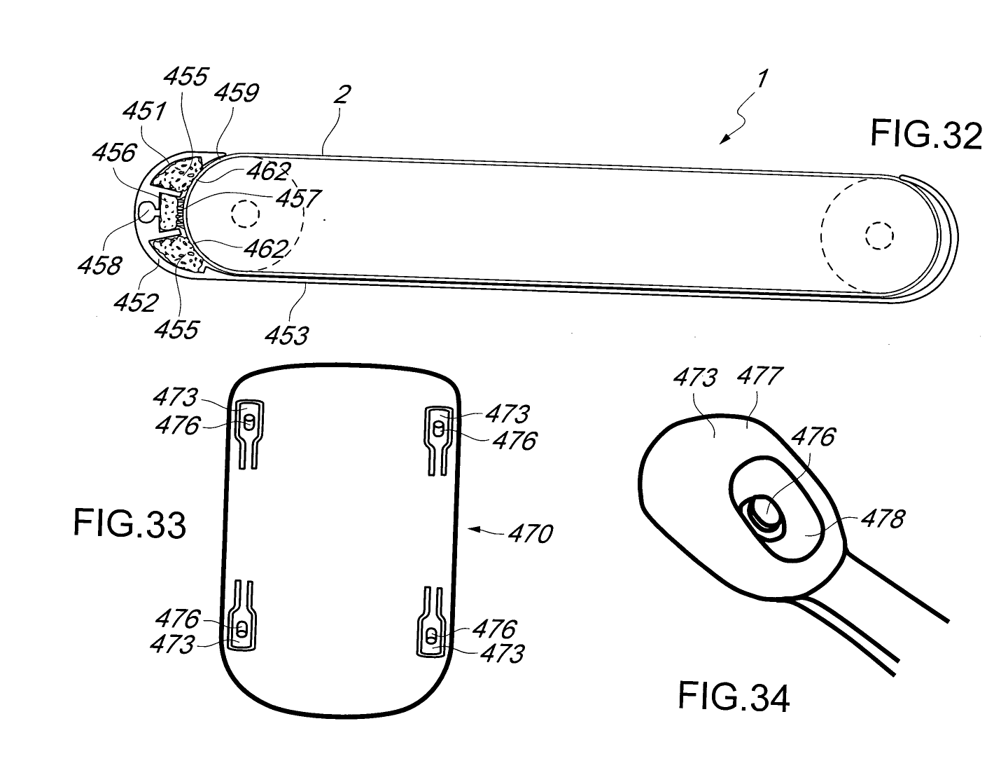

With reference to FIG. 32, the input device 1 according to the disclosure can comprise a self-cleaning system. Its optimal location is in the uncovered part of the device, particularly along a portion 452 of the support shell 453 in mobile devices (for example a smartphone) or inside the housing for other devices. The system is comprised of three parts. A first part is constituted by a pair of sponges 455, a second part by a brush 456 with spongy base or a base otherwise adapted to transmit liquids or the like along its bristles 457, and a third part by a system of channels 458 for the conservation and transmission of the liquids. Close to one of the curves 459 of the belt 2, in adapted seats 451, the two sponges 455 are installed with the brush 456 in the intermediate position. The seats 451 of the aforementioned elements are provided with openings 462 at the belt 2 and the two sponges 455 and the brush 456 are arranged in such a way as to be able to establish contact with the belt 2. On the back of the brush 456 open channels 458 which connect the brush 456 with a reservoir of detergent liquid. In at least one of the channels 458 it is possible to insert a tube connecting the detergent liquid to the brush 456 or any other device that is adapted to achieve the aforementioned aim. The brush 456 must be able to transfer the liquid that it receives from the chamber 458 behind it to the belt 2. This can occur by simple contact of the bristles 457 of the brush 456 with the liquid. The liquid is transported from one end to the other of each bristle 457 by the principle of capillary action. Thus a bubble of detergent liquid is formed which comes to rest between one end of the bristle 457 and the belt 2, and which is continuously regenerated by virtue of this principle. When the belt 2 is made to rotate (in one direction or the other) a part of it slides in contact with a first sponge 455 which collects a part of the dirt accumulated on the belt 2. Subsequently the same part of the belt 2 encounters the bristles 457 of the brush 456 which are soaked in liquid and remain perfused with it via a known principle. By continuing to drag the belt 2 the residual dirt and the liquid present on the belt 2 are partially absorbed by the second sponge 455, which also spread the liquid evenly over the belt 2. The method is symmetric in the two directions of rotation and is such that, during the normal operation of the apparatus, the belt 2 automatically and effortlessly cleans itself after just a few runs and keeps itself clean for as long as the liquid lasts. The liquid can be easily injected into the adapted tank by way of an ordinary valve.

### Magnetic Spacer

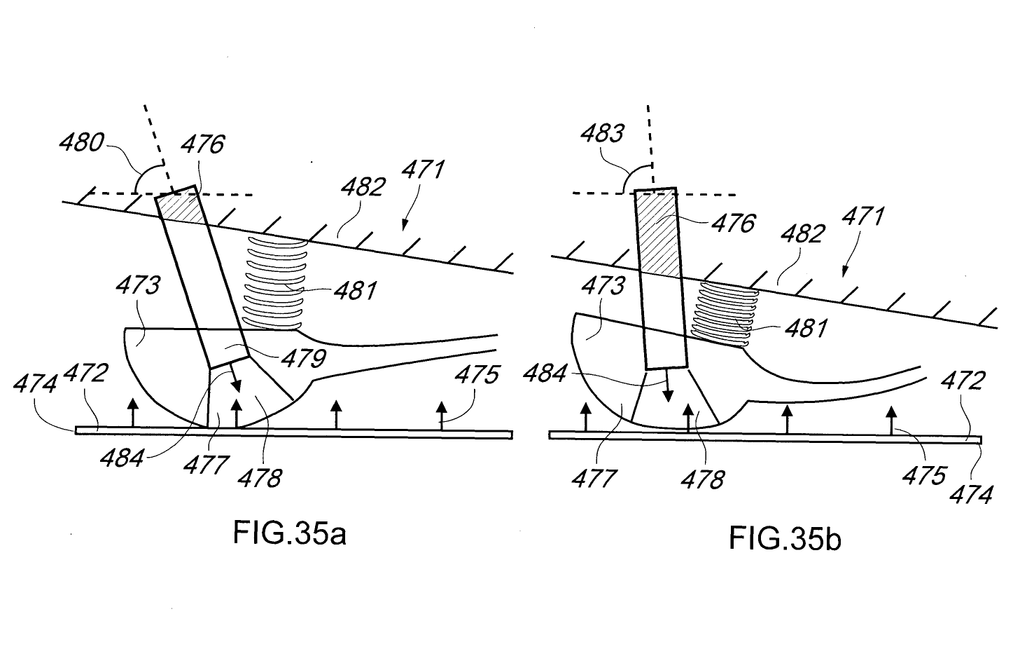

With reference to FIGS. 33, 34, 35a and 35b, according to another aspect of the present disclosure the disclosure relates to a magnetic spacer which is adapted to suspend a device by means of the repulsion generated by magnetic fields. The magnetic spacer can be advantageously associated with a mobile pointing device in order to provide a mouse of the “frictionless” type. Mobile pointing devices generally slide on a plane by pure contact and as a consequence they are subjected to a certain amount of friction which impedes their movements, especially precision movements. Heavier devices are subjected to proportionally greater friction. In order to overcome the effects of the friction it is possible to fit a device 471 with a magnetic mat 472, a base 470 and moveable bearings 473. In the system, the device 471 provided with a magnetic spacer remains anchored to the magnetic mat 472 by the force of friction when it is stationary and not manipulated by the user; it disengages gradually, and to the extent desired by the user, from the friction and remains thus for as long as it is subjected to the action of the hand of the user, and it is brought to a stable and still position at the point where it is released. The system comprises: a magnetic mat 472 which is capable of generating a magnetic field 475 oriented toward the outside of the magnetic mat 472 and is sufficiently uniform to keep in suspension, under determined conditions, a device 471 which is advantageously provided with position sensor; the device 471 being provided, in its lower part, with a base 470 that is provided with moveable bearings 473, each moveable bearing 473 being provided with a magnet 476. In FIG. 33 we see an example magnetic spacer which is provided with four moveable bearings 473. The moveable bearings 473 are, at least partially, free to move. In the example in the figure, and with reference also to FIGS. 35a and 35b, the moveable bearings 473 are cut, partially, from the base and are adapted to rotate with respect to the base 470 so as to alter the angle of incidence, with respect to the magnetic mat 472, of the magnetic field produced by the magnet 476. In FIG. 34 and in FIGS. 35a and 35b an example moveable bearing 473 is shown, respectively in a perspective view and in a side view. In FIG. 35a the moveable bearing 473 is in the rest position, as it is when the device 471 is left unaccompanied on the magnetic mat 472. The moveable bearing 473 is provided with a certain friction coefficient, as well as advantageously a certain weight. Within the moveable bearing 473 there is advantageously a cavity 478 from which exits one end of the magnet 476. The end of the magnet 476 remains at a certain height with respect to the resting surface 472 and is adapted to generate a magnetic field which is oriented in the opposite direction to that of the magnetic field 475 exiting from the magnetic mat 472. Elastic means 481 couple the moveable bearing 473 to a fixed part 482 of the base 470 or of the device 471. In the rest position, as we can see, the magnet 476 is at a height from the magnetic mat 472 which is such as to not cause the suspension of the device 471 or a considerable reduction of the friction. In order to facilitate this condition the magnet 476, and the magnetic field 484 generated by it, is oriented initially so as to form an oblique angle 480 with the magnetic mat 472. In FIG. 35b we see the moveable bearing 473 lifted slightly by the magnetic mat 472. In this position the device 471 floats on the magnetic mat 472 and the friction is eliminated. What determines this condition is the hand of the user which presses on the device 471. Following this compression the moveable bearings 473 receive a push downward which makes them approach the magnetic source 475. The magnet 476 inside them reacts to the increase of magnetic repulsion 475 by pushing the moveable bearing 473 upward. At the same time the magnet 476 rotates through an angle 483, further increasing the opposition owing to the increased magnetic force 475 (at maximum in the perpendicular position). As the user pushes the hand down on the device 471 the moveable bearings 473 detach from the magnetic mat 472 to a greater extent than the entire device 471 is lowered. The elastic means 481 absorb the upward push of the moveable bearing 473 and soften their impact against the fixed part 482. When the maximum lifting limit is reached of the moveable bearing 473, the magnet 476 will be vertical 483 and its repulsion 484 against the magnetic mat 472 will be maximum. By reducing the pressure of the hand the opposite effect is obtained until the desired stability in the rest position is reached.

### Input Device Application

### Cellular Phone

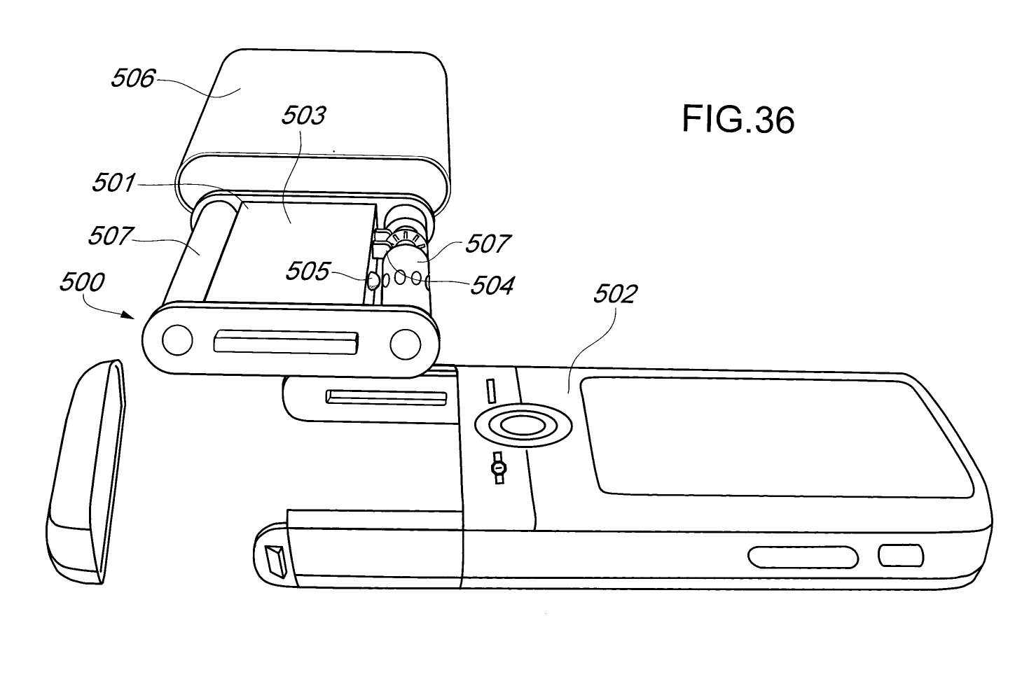

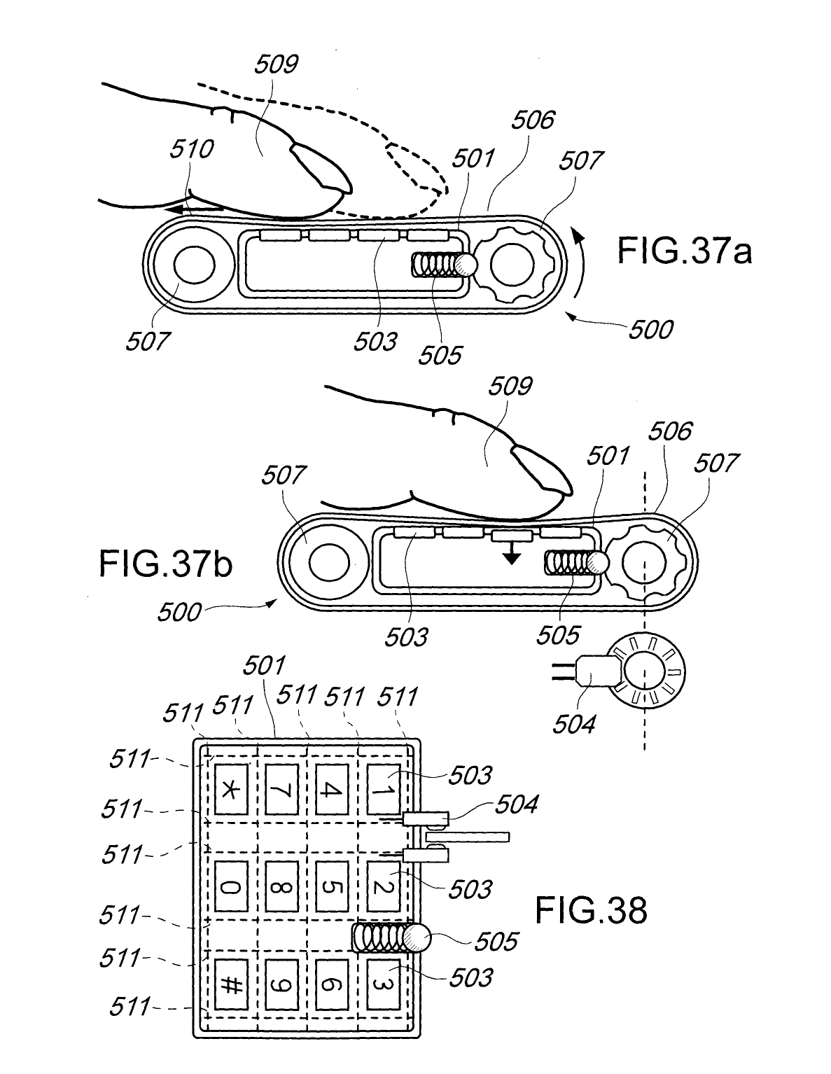

FIG. 36 shows, in a partially exploded view, an example scroll board 500 which is adapted to be implemented in a cellular phone 502 provided with a numeric keypad. The scroll board 500 comprises: a keypad 501 which comprises a set of buttons 503, means 504 for coding the movement of the slideable member 506 and means 505 for forming the tick. A belt 506, advantageously transparent so as to make the characters present on each button 503 show through, slides over the keypad 501. The belt 506 is wound around rollers 507 which are situated at the ends of the keypad 501. In one implementation, multiple belts 506 arranged side by side, each one covering a column of buttons 503, can contribute to forming the scroll board 500. The connection between the keypad 501 and the components accommodated therein and the circuitry of the mobile phone 502 can occur by way of cables which exit laterally to the keypad 501, so as to bypass the roller 507. FIGS. 37a and 37b show a side view of the scroll board 500. The belt 506 slides over the upper part of the keypad 501 at a distance which is such that the finger can trigger a button 503 by pressing on the belt 506 at the button 503. The belt 506, moreover, can be made to slide by means of the traction exerted thereupon by a finger 509.

The scrolling of the belt 506 is converted to electrical signals and sent to the cellular phone system. At regular intervals it is possible to make the scroll board 500 produce a physically perceptible tick by employing the best adapted means, such as elastic means 505 and vibrating batteries. With reference to the example in FIG. 38, running laterally to the buttons 503, or above them, are scanning lines 511 (dotted line) of sensors which are adapted to detect the position of the fingers on the keypad 501. The scanning lines 511 are subdivided into logical regions, each one corresponding to a button 503 of the matrix of buttons 503. In this manner the system is capable of establishing on which button 503, or logical area correlated thereto, the user is holding the finger 509. In one implementation, each button 503 is associated with a touch or pressure sensor. Contact of the finger on the button 503 can provide a first visual feedback by way of displaying, on the display of the cellular phone 502, the characters that it is possible to input by way of the button 503.

The principle of operation is the following: when the sensor 511 detects the presence of a finger 509 on the keypad 501 the system associates the information obtained from the sensor 511 with the information in an internal map of values, so as to identify the button 503 on which, or proximate to which, the finger 509 is lying. If the user presses on the button 503 (once) then we have, as is normal, the input of the first letter associated with it. If the user rotates the belt 506 starting from the same point, then each tick produced will produce the selection of the next character in a list of characters associated with that button 503. The actual input of the character into the text can occur upon lifting the finger 509 from the belt 506. The method is described in more detail in the part of this description that deals with the graphical interface associated with the input device 1.

### Input Device Application

### Remote Control

With the advent of Web TV, conventional remote controls have all shown their limits. They are, in fact, required to be capable of locating fields in web pages and entering text into them, for example in order to perform a search or in order to type the address of the web page. In order to offer the user an interaction technique that is on a level with the speed of current internet connections, it is possible to implement a scroll board within an ordinary remote control. This combines a high operating speed with the capacity to offer low production costs and occupy a reduced space. The overall area occupied by the scroll board can be roughly that dedicated to the navigation keys on the remote control (arrow keys and confirmation button). The sensor of the scroll board can be used to move a cursor on the screen or to navigate between the elements of a web page. The sensor can be advantageously associated with contact bands.

### Input Device Application

### Smartphone/PDA

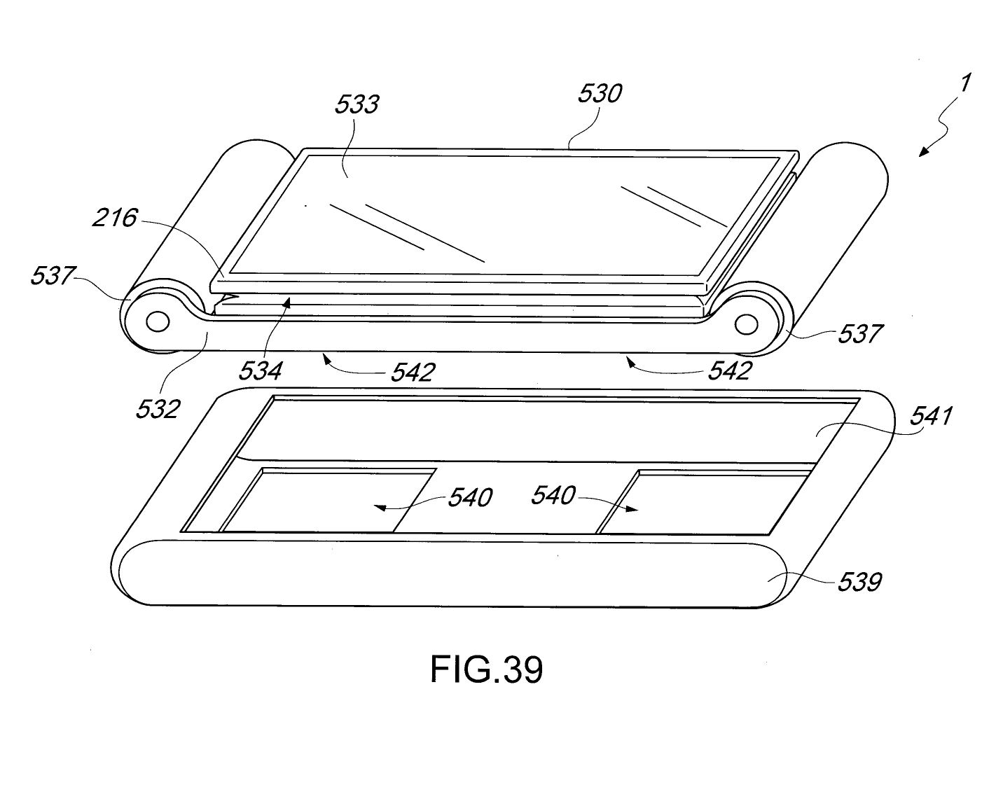

An input device applied to an electronic device provided with a touch-sensitive screen, for example a smartphone or a PDA, can give the device the benefits deriving from two new degrees of freedom (clicking and rolling) which are added to the conventional one (tapping). The derived benefits translate to better control of complex applications, the use of a greater number of gestures of the single touch type, support for the new rapid writing system based on the scroll board, the adoption of a system of browsing and magnification “with just one finger”, and the extensive use of contextual palettes and more besides. In FIG. 39 there is an example of application of the input device 1 to a smartphone 530. The smartphone 530 in the example comprises a scroll board 532 of the second type with a touch-sensitive screen 533 within it, a “system to make a surface uniformly clickable” 534 of the first type comprising the gasket 216, and a shell 539. A transparent belt 2, not shown, runs on the rollers 537 of the scroll board 532. In order to not influence the vertical dimensions of the device, the system 534 uses the PCB of the smartphone 530 as a tilting element to support the lateral buttons 206, 207, 208 and 209, as shown in FIG. 17. The shell 539 serves as a grip for the fingers of the hand while another finger, preferably the thumb, acts on the touch-sensitive screen 533. The shell 536 can be fitted onto the scroll board 532 so as to make the upper flat part of the belt 2 show through, from an adapted opening 541. This is free to slide inside the shell 539 around the adapted rollers 537.

With reference also to FIG. 22, in the preferred implementation two supplementary scroll boards 383 are installed in the lower part of the smartphone 530. The user manipulates the two supplementary scroll boards 383 with the fingers of the hands that hold the smartphone 530 in a similar manner to that previously shown for a tablet computer 382. Use of the supplementary scroll boards 383 makes it possible to use the rapid character input system described previously. Another advantage over the background art is being able to use both hands during the typing of the text. A scroll board 383, in fact, occupies a reduced space when compared to the keypad of a mobile phone or to the virtual keyboard of a smartphone and it is therefore possible to implement one of them for each hand.

The same result as the previous implementation can be achieved by using a single scroll board 532. In the example in FIG. 39, on the lower part of the shell 539 there are openings 540 through which the user can put the belt 2 of the scroll board 532 in rotation by acting on the rear of the smartphone 530. The openings 540 are associated with a corresponding number of touch sensors 542 which are positioned on the lower part of the scroll board 532. The user uses the scroll board 532 as in the previous implementation. The system associates the output of the scroll board 532 with one hand or the other depending on the information that comes from the rear touch sensors 542 or from the front sensor comprised in the touch-sensitive screen 533. The user observes the outcome of text entry by looking at the touch-sensitive screen 533.

### Input Device Application

### Alternative System to a Computer Keyboard

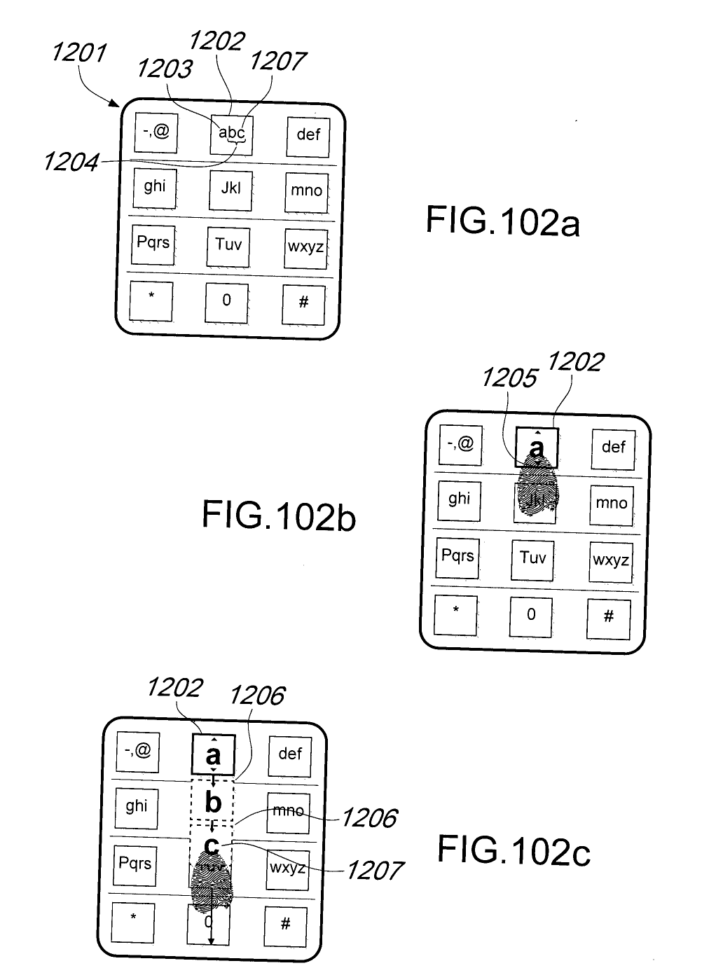

With reference to the field of application of character input devices, keyboards for computers exhibit three principal disadvantages: they are cumbersome, they cannot be used to move the cursor, and they do not cover the mass of characters of all existing languages. It is possible to use at least one input device 1 in order to provide a keyboard for computers which can manage an unlimited number of characters, supports ideograms, and enables the user to maintain the grip on the device both during pointing and during text entry. With reference to FIGS. 29, 30 and 31, in the preferred implementation the keyboard comprises an input device 1 for each hand, of which at least one is associated with a pointing device 420, such as, for example, a mouse. By clicking in an area of the screen which is adapted to receive text, a mode is triggered for which the sensor 60 of the input device 1 is associated, on the screen, with a virtual keyboard 1201 of similar type to the one in FIG. 102a. By keeping the pointing device 420 substantially stationary and typing the text with the technique described above, we obtain the input of the text at the insertion point on the screen. By moving the pointing device 420 beyond a given displacement threshold, the virtual keyboard 1201 disappears and the system 630 returns to the normal pointing mode. In order to enter text in different regions of the screen, for example in different fields of a form, it is sufficient to position the cursor on the first field, click to make the insertion cursor appear, type the text with at least one input device 1, move the pointing device 420, position the cursor on a second field and repeat the procedure for the subsequent fields. An input device 1 equipped as a keyboard for computers can comprise a touch-sensitive screen. In such case the user reads the characters to be entered directly on the touch-sensitive screen.

With reference to FIGS. 47 and 102a, in the preferred implementation one or more input devices 1 are associated with one or more dedicated displays 638 which are arranged preferably on the base of the monitor 638 of a computer 630. On the display 638 the user can read the current page of characters, for example the palette 1201. The current page of characters 1201 of an input device 1 displays the characters 1203, 1204 which it is possible to input with that device 1. An input device 1 can be associated with multiple pages of characters 1201. In the preferred implementation the loading of a new page of characters 1201 is obtained by rotating the thumb-roller 429 (FIG. 30) by one tick. In each page of characters 1201 it is possible to read the characters 1203, 1204 or the pictograms associated with each virtual button 1202. The number of characters 1203, 1204 that a page of characters 1201 can contain depends on the number of virtual buttons 1202 associated with each finger and on the number of supplementary characters 1204 associated with each virtual button 1202. The supplementary characters 1204 are entered by rotating the slideable member 2 starting from a location of the sensor corresponding to a virtual button 1202. By rotating the slideable member 2 in one direction, instead of another, it is possible to scroll a different set of supplementary characters 1204. In the preferred implementation the dedicated display 638 is adapted to simultaneously display two pages 1201 of characters 1203, 1204, one for each hand. The dedicated display 638 can be provided with OLED technology so as to enable the visibility of characters even if the computer is powered down. OLED displays, in fact, retain a certain degree of visibility even when they are not powered. In the preferred implementation a region of the dedicated display 638 is reserved for displaying the entered text. Text input can occur even when the computer is powered down. The transfer of the text contained in this part of the dedicated display 638 can be transferred to the computer 630 when the latter is next rebooted.

### Pointing Device which Acts as a Mobile Terminal

According to another aspect of the present disclosure, the disclosure relates to a pointing device which acts as a mobile terminal. The device comprises a touch-sensitive screen and a medium and/or long range wireless connection.

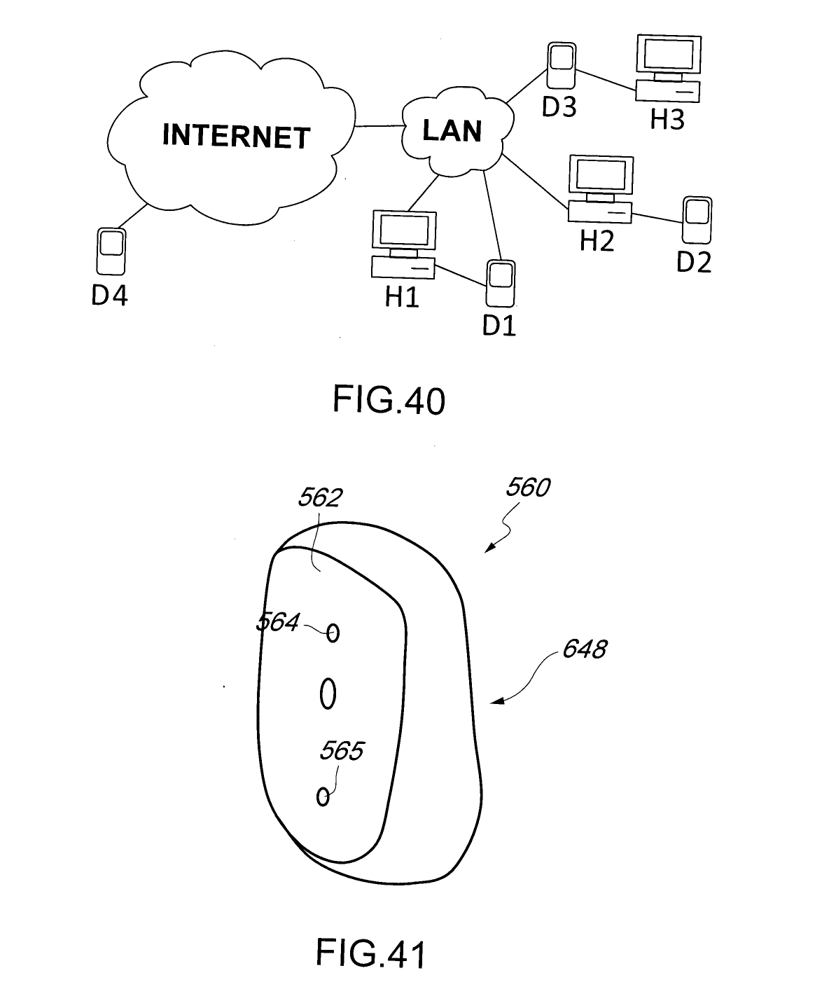

With reference to FIGS. 40 and 47, a pointing device which acts as a mobile terminal, generally designated by the reference numeral 560, can be used to receive, display, and modify information originating both from a host computer 630 and from another pointing device 560. The system can be used advantageously for receiving email, surfing the internet, entering text, reading and modifying data stored on the host computer 630, receiving audio and video streams, making and responding to voice calls, using services being executed on the host computer 630, connecting to a computer network directly or by means of a host computer 630, and connecting to similar devices directly or through a host computer 630.

This aspect of the disclosure relates in particular to mice and to pointing devices which can be extracted from the body of a host computer, for example the extractable touch pad of a notebook computer. The use of this type of device is normally associated with the presence of a screen which can be physically perceived by the user. For this reason they are traditionally provided with short-range wireless connections such as, for example, the Bluetooth system. A pointing device which acts as a mobile terminal 560 is capable of establishing medium-range (for example the WLAN system) and long-range (for example connection to a mobile telephony system) wireless connections 637.

In FIG. 40 we see some examples of connection. The pointing device D1 communicates with the pointing device D4 by means of the internet connection provided by the host computer H1. The pointing device D1 communicates with the pointing device D2 by means of host computers H1 and H2. The pointing device D1 communicates also with the pointing device D3 directly over a LAN or a WLAN (Wireless LAN). The pointing device D2 communicates with the host computer H1 by way of the host computer H2. The host computer H3 of the pointing device D3 communicates with the host computer H1 by way of the pointing device D3 itself, and the host computer itself is not connected to the network. The pointing device D4 connects directly to the internet and communicates with all the other devices either directly over the internet or also by going through the LAN. Two or more pointing devices 560 can also communicate with each other using wireless communication alone, without using specific protocols (such as for example, VoIP for voice). The connection 637 between pointing devices 560 and host computers 630 can occur both with medium-range (WLAN) and long-range wireless network systems and with short-range systems (Bluetooth) or by cable. A pointing device which acts as a mobile terminal 560 can be comprised in an extractable part of the host computer 630.

On the basis of its computational capacities a pointing device which acts as a mobile terminal 560 can be subdivided into two categories: “terminal” and “server-based”. The principle according to which a “terminal” device operates is the following: the actual computation is executed by the host computer 630, while the pointing device 560 is limited to displaying screens and providing the host computer 630 with the user's input. With reference to FIG. 47, the pointing device 560 comprises a touch-sensitive screen 648, a processor 647, for example a CPU or a microcontroller, and a memory 649. The pointing device 560 must be able to handle a touch-sensitive screen 648 on which the screens “prepared” on the host computer 630 are displayed. The user program 645, including every graphical component thereof, is executed by the processor 631 of the host computer 630. The processor 631 maintains a copy in memory 633 of the screen currently displayed on the pointing device 560. When the user moves the cursor using the touch-sensitive screen 648, the pointing device 560 sends every movement information of the cursor to the processor 631. The pointing device 560 sends the processor 631 any other input (clicking, rolling, contact with a contact band etc.) for each finger. On the basis of this information the processor 631 will compute the next screen. For example, if the user has moved to a text box by means of the touch-sensitive screen 648 and has performed a click, then the processor 631, in parallel with the pointing device 560, keeps track of the movements of the cursor and is capable of recognizing the text box (or any other type of control) and of sending it a click message. The text box management system, as the system for handling any other object allocated by the processor 631 for being handled by the pointing device 560, reacts by suitably modifying the internal memory 633 of the host computer 630. Subsequently the processor 631 sends the pointing device 560 a new screen with the updates deriving from the user's action (the box is now selected following the click). In this manner all the operations requiring specific computations are delegated to the processor 631 of the host computer 630. The pointing device 560 can be limited to displaying the current screen and, preferably, updating the position of the cursor. The pointing device 560 can handle voice calls, and also audio and video data, with a technique of the streaming type. This type of transfer requires much less memory than that required for keeping an entire copy of a file on the pointing device 560.

A pointing device 560 of the “server-based” type arrives at the same results as one of the “terminal” type, but in different ways. The processor 647 of the pointing device 560 is adapted to execute programs resident in the memory 649 of the pointing device 560. The programs communicate with the host computer 630, for example according to a model of the client-server type. The pointing device 560 is capable of storing files in memory 649 and of making them usable by the user with or without the intervention of the host computer 630. For example the user can download an audio file from the internet by means of the connection 637 with the host computer 630, store it on the pointing device 560 and listen to it using a specific program (player) for audio. This implementation, differently from the previous one, makes it possible to use the pointing device 560 even if it is disconnected from the host computer 630. Voice calls can be made using a voice protocol (for example VoIP) which enables the pointing device 560 to handle the calls directly. These can occur between two or more pointing devices 560 which have equal capabilities and are connected to each other by a wireless network (without the intervention of a host computer 630) or, if the device has direct access to the internet or access to the internet mediated by another computer 630, between two or more pointing devices 560 which are connected to the internet.

In the preferred version the pointing device which acts as a mobile terminal comprises a telephone. This implementation makes it possible for the user to use only one medium for the various different steps of a typical office job, using the same device and without ever having to abandon the grip thereof. For example, if the pointing device is a mouse, then the user can begin a call by dialing the number on the touch-sensitive screen 648 and bringing the pointing device 560 to the ear in order to talk with the called party, then lowering it again in order to update information on the host computer 630 using the pointing device 560 as a keyboard, resuming the conversation and ending it by way of a determined action. In the preferred implementation the user begins a new call by lifting the pointing device 560 from a resting surface. In one implementation the call initiation function is triggered by the signal originating from an accelerometer or other device within the pointing device 560 which is adapted to detect particular movements of the pointing device 560, for example upward. The call initiation function results in the displaying on the touch-sensitive screen 648 of a virtual telephone keypad (soft keypad) with which the user can dial the receiving number and handle the call until it is ended. In one implementation, replacing the pointing device 560 on the resting surface will end the call. In the preferred implementation the same function is obtained by pressing the side-switch once. Lifting the pointing device 560 from the table when the pointing device 560 reports an incoming call establishes the telephone connection with the calling party after confirmation from the user by way of adapted virtual buttons (soft keys) drawn on the screen 648. In FIG. 41 we see a pointing device 560 which is provided at its base 562 with loudspeakers 564 and a microphone 565.

In one implementation the telephone connection with the pointing device 560 is handled by the host computer 630 by way of a connection to a fixed-line telephone network which is connected to an internal or external card on the host computer 630. In another implementation the pointing device 560 is part of a cordless telephone. The base of the pointing device 560 establishes the incoming and outgoing telephone connections through the telephone cable which comes from a wall socket. The pointing device 560 is connected both to the host computer 630 for data traffic and also to the base of the cordless telephone for voice traffic. In yet another implementation the pointing device 560 is part of a cellular phone and is capable of connecting directly with the mobile telephone network. In another implementation the pointing device 560 can act as a telephone terminal for internet calls handled by the host computer 630, for example using a software program of the type of Skype™. More generally the pointing device 560 can handle calls by means of a protocol such as VoIP.

### Method of Panning a Desktop

According to another aspect of the present disclosure the disclosure relates to a method of panning a desktop by way of a portable device provided with a sensor. The method enables the navigation of a desktop which is larger than the resolution of the display of a portable device. A desktop is a set of display information associated with a particular resolution. Devices provided with display of lower resolution than that associated with a desktop can navigate the desktop by using a panning method such as the one described herein.

With reference to FIG. 47, the portable device 650 comprises a processor 651, for example a CPU or a microcontroller, a memory 652, a screen 653, and a sensor 654 which is adapted to detect the movements of the portable device 650. The desktop can reside in the memory 652 of the portable device 650 and be generated locally by the processor 651, or it can be produced by an external computerized system 630 and sent, at least partially, to the portable device 650 by way of a wireless or wired connection 637 in order to be displayed on the screen 653 of the portable device 650.

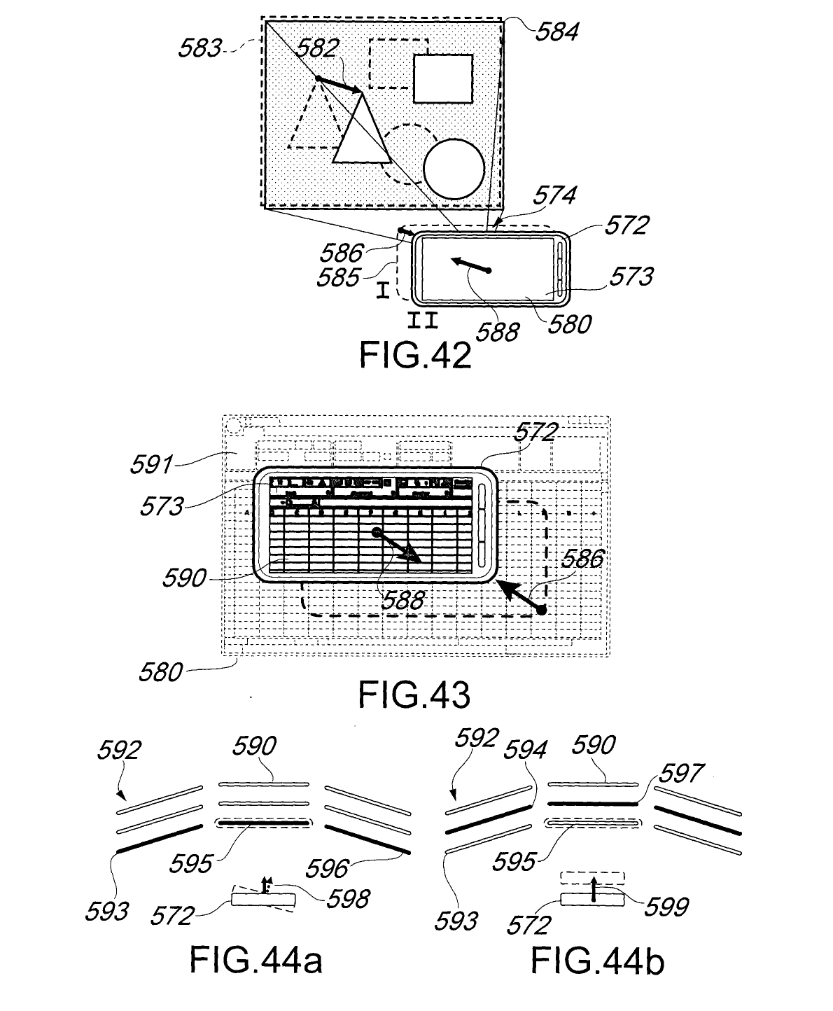

In FIG. 42 we see an example portable device 572 which is provided with a screen 573, advantageously touch-sensitive, and with an optical sensor 574. The optical sensor 574 is positioned, preferably, on the rear of the portable device 572. On the screen 573 of the portable device 572 a portion of the desktop 580 is displayed. When the user moves the portable device 572 in a direction, particularly when the user moves the portable device 572 on a plane that is substantially parallel to the plane on which the screen of the portable device 572 lies, the optical sensor 574 intercepts the movement of the portable device 572 and sends signals to the processor 651. In response to the sending of the signals of the optical sensor 574, the processor 651 computes, on the basis of those signals, a motion vector 582 of the portable device 572. If the sensor 574 is a digital camera, for example a CCD, then the motion vector 582 can be obtained by calculating the delta between two or more images 583, 584 originating from the optical sensor 574.

In the figure we see two images 583, 584 captured by an optical sensor 574 during the movement, by the user, of the portable device 572. At a time T1 the portable device 572 is in the position indicated by the dotted line 585, Roman numeral I. This position of the portable device 572 corresponds to the image 583. At a time T2 the user has moved the portable device 572 in the direction of the arrow 586 until it is in position II. Position II of the portable device 572 corresponds to the image 584. If the movement of the portable device 572 is sufficiently small then the images 583, 584 will have characteristics such that it is possible to reconstruct the movement performed by the portable device 572. Thanks to known techniques the processor 651 obtains, for each elementary movement of the portable device 572, a motion vector 582. The motion vector 582 thus obtained is used by the processor 651 of the portable device 572 to pan the desktop 580 displayed on the screen 573. In the figure, the processor 651 has panned the desktop 580 along a vector 588 the size of which is proportional to the motion vector 582 and in the opposite direction to the motion vector 582.

The result of a panning operation can be seen in FIG. 43. In the figure we see the portion 590 of desktop 580 that is currently displayed on the display 573 of a portable device 572 following the movement of the portable device 572 along the vector 586. The desktop 580 of the example corresponds to the output of a spreadsheet program and is drawn with a dotted line. The example shows how, by moving the portable device 572 toward an area of interest, the graphical interface management system draws, on the screen 573, a portion 590 of the desktop 580 arranged along the direction of the movement 586.

As can be seen from the figure, in order to launch a command it is sufficient to go, with the method just described, to the area of the program 591 that contains the control relating to the command and work on it in the usual way. This approach is radically different from the one in use in current portable systems, where, usually, the command interface is always in view and occupies a significant part of the area of the screen, which is generally of limited size. The method described can also be used for scrolling the content of a scrollable window.

A similar method can be used for navigating within a set of desktops. In FIG. 44a we see three series 592 of desktops 590, each one comprising three desktops 590. By moving the portable device 572 beyond a given displacement threshold we obtain the selection of the desktop next to the one currently displayed 595 in the direction of motion of the portable device 572. In the example in the figure, a rotation 598 to the right of the portable device 572 corresponds to the selection of the desktop 596 located to the right of the current desktop 595 of the current series of desktops 593. With reference to FIG. 44b, a forward movement 599 of the portable device 572 corresponds to the displaying of a desktop 597 belonging to the next series 594 of desktops 590 in a similar direction of motion.

### Graphical Interface Systems and Methods

According to another aspect of the present disclosure, the disclosure relates to systems and methods for manipulating the graphical interface of a computer system that is adapted to translate the benefits deriving from the adoption of the input device described above to the field of computer applications.

Take an area of the screen within which the elements, graphic controls and so on to be controlled fall, at least partially. By moving a finger along the touch sensitive surface of the input device 1 we obtain the accompanying highlighting (preselection) of the elements on the screen. The subsequent pressing or scrolling, also indicated hereinafter with the term “rotation”, of the slideable member 2, 102 of the input device 1 determines the execution of a command associated with the graphic controls.

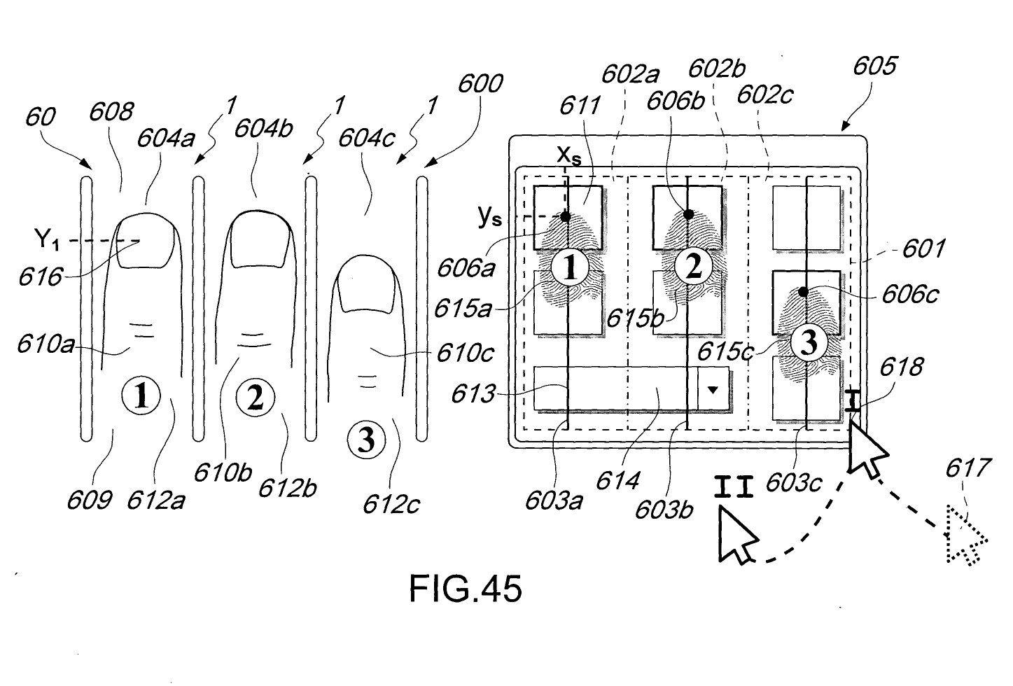

In FIG. 45 we see a scroll board 600 comprising three input devices 1. Each input device 1 is associated with a different finger of the hand. In the same figure we see an example palette 605 associated with the scroll board 600. The dotted line delimits the area under finger control 601 within which all the elements contained in it can be controlled directly by the scroll board 600. In the example in the figure, the area under finger control 601 is divided into three sections 602a, 602b and 602c, each one controlled by a finger 610a, 610b and 610c of the hand. Within each section 602a, 602b and 602c, a line 603a, 603b and 603c is drawn to indicate a path taken by the finger, along two axes, on the touch sensitive surface of the input device 1. Hereinafter we shall refer to said touch sensitive surface more briefly as “the sensor”. The position of each finger 610a, 610b and 610c on the sensor 604a, 604b, 604c of the input device 1 corresponds, on the screen, to a point 606a, 606b and 606c which lies on the corresponding line 603a, 603b and 603c. By moving a finger, for example the finger 610a, from one end 608 to the other end 609 of the sensor 604a it is possible to move a cursor 615a which proceeds along the line 603a, hereinafter referred to as “scanning line”. When the cursor 615a comes within the area of a control 611, it becomes selected. Each subsequent click or scrolling of the slideable member 612a of the input device 1 made from the point 606a indicated by the cursor 615a is understood to be directed at the control 611. A click at the point 606a of the scanning line 603a contained within the area of a button 611, for example, will result in the pressing of the button 611. The scrolling of the slideable member 612a begun from a point 613 of the scanning line 603a contained within a drop-down list 614 will result in the selection of an element of the drop-down list 614.

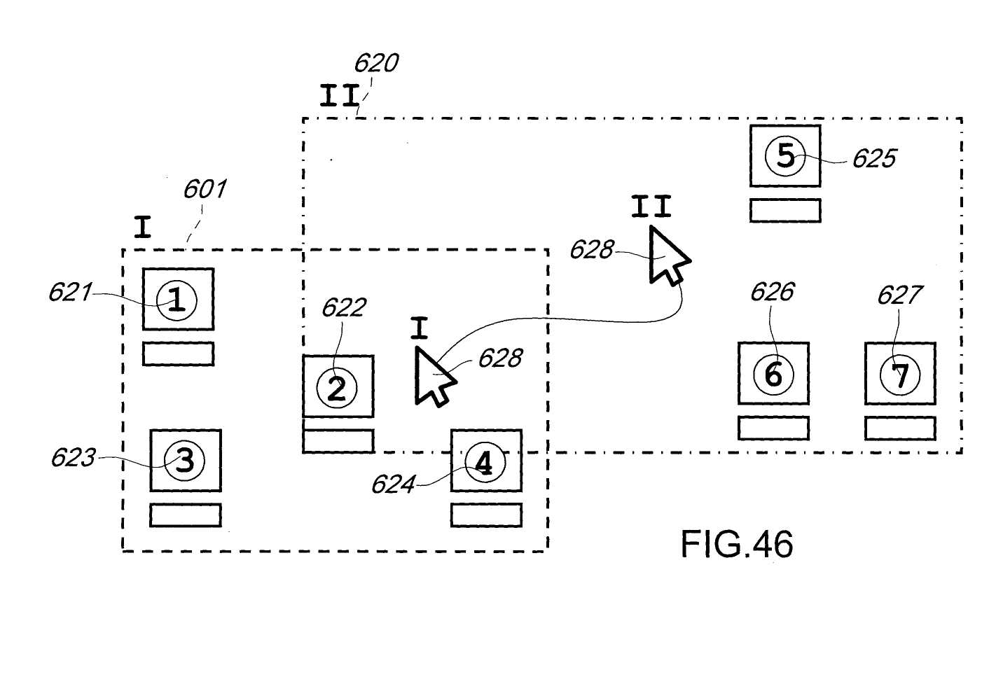

The area under finger control 601 on screen can be fixed or moveable. A fixed area under finger control can be made to correspond, for example, to a palette of commands and the user will use the method described above to manipulate the controls contained in the palette. An area under finger control which is moveable can be bound to the pointer of a pointing device and move in concert with that pointer. The dimensions of the area under finger control 601 can vary in order to reflect the quantity of controllable objects that progressively come to be within it. In such case its dimensions will be recalculated as it moves. The recalculation can take account of the maximum number of elements to encompass or of the maximum size that it can assume on the screen. In FIG. 46 we see an area under finger control 601 that is moving together with the pointer 628 of a pointing device. At a time T1, indicated by the Roman numeral I, the area under finger control 601 comprises a certain number of elements, in this case the icons 621, 622, 623 and 624. When the pointer 628 will have been moved, at time T2 indicated by Roman numeral II, the area under finger control 601 will have been moved a certain distance, to the dotted line 620, and its dimensions will have been adapted to contain new elements, i.e. the icons 625, 626 and 627, in addition to a part of those already contained, i.e. the icon 622.

In FIG. 47 we see the block diagram of a non-limiting example of a computer system that applies both to a desktop and a mobile environment. The computer system 630 comprises a central processor (CPU) 631, a system memory 632 which includes a random access memory (RAM) 633 and a read only memory (ROM) 634; a system bus 635 that connects the central processor 631 to the system memory 632 and to the other parts of the system 630, an input/output (I/O) controller 636 to which are connected, by way of the wireless or wired connection 637, an input device 1 and a display 638; a mass memory 639, for example a hard disk or a CD drive, which contains instructions that can be executed by the processor 631; a network controller 640 for wireless or wired connection to networks 641 and to the internet. The mass memory 639 includes, in the form of instructions, routines, data structures and other types of information, an operating system 642, program modules 643, device drivers 644, applications 645 and a management system 646 for manipulating the graphical interface by way of movement of the fingers on an input device 1. This information can also reside on a removable data support that can be read by the computer.

With reference also to FIG. 45, the user tells the system 630 that he or she wants to control an area of the screen by way of a triggering action. The triggering action causes the entry of the system 630 into a mode, which we shall call the Finger Control Mode, wherein the user interacts with the elements on the screen by using the fingers. In the Finger Control Mode, the management system 646 for controlling the graphical interface by way of the fingers, hereinafter “the management system”, calculates the position and dimensions of the area under finger control 601 adapting it to the part of the screen to be controlled. Subsequently it maps the resolution of the sensor 60 of the scroll board 600 to the dimensions of the area under finger control 601 so that every point of the sensor 60 corresponds to at least one coordinate of a point that lies within the area under finger control 601. If the scroll board 600 has multiple sensors or sensor portions 604a, 604b and 604c, preferably three in number, and controlled by the same number of fingers 610a, 610b and 610c, then the associated areas of control 602a, 602b and 602c can be side by side in order to form a single area under finger control 601.

Over the course of the following description we will assume that the scroll board 600 has three sensors 604a, 604b and 604c which are controlled respectively by the index, middle and ring fingers, that the sensors 604a, 604b and 604c all have the same resolution and that the scroll board 600 is associated with a pointing device. After having mapped the sensors 604a, 604b and 604c to the area of the screen to be controlled, the system 630 listens for the input from the user. When the finger of the user touches a part of the sensor 60, the input device 1 sends the information provided by the latter to the processor 631 by means of the connection 637. The driver of the device 644 collects this input and sends it to the management system 646 which translates, in the Finger Control Mode, the actions of the user into corresponding actions on the elements contained, even partially, by the area under finger control 601. If the action of the user is a touch (on the sensor) then the management system 646 will locate, drawing on the mapping performed previously, a point within the area under finger control 601 which corresponds to the finger in question and, if the point should fall within an element that can be controlled by the system 630, it will select that element and provide a visual representation of the performed selection. If the action of the user is a click or a roll (rotation of the slideable member 612a) or any other action, then the management system 646 will translate the action into input that can be read by the elements (windows, controls, editable objects etc.) that are covered, even partially, by the area under finger control 601 and, depending on the individual case, will send them to the management system for those elements. In FIG. 45 we see an example button 611 arranged in a palette 605. In order to execute the command associated with the button 611 the user performs the following actions: at time T1 the user has brought the tip of the index finger 610a to the position Y1 616 of the sensor 604a farthest to the left. The management system translates the data of the sensor 604a relating to the position 616 of the finger of the user into the Xs and Ys coordinates of a point 606a on the screen which is contained in the area under finger control 601. The management system, in at least one implementation, checks whether the point thus obtained is contained within the area of a control in the palette, for example the button 611. If this is the case, then the management system instructs the graphic control 611 to move to the highlighted state. The user sees that the button 611 has become selected and, while keeping the finger 610a at the same point 616, performs a click on the input device 1. This action is sent to the management system which then sends a click message to the selected element 611. The button 611 passes to the “pressed” state and the command associated with it is executed.

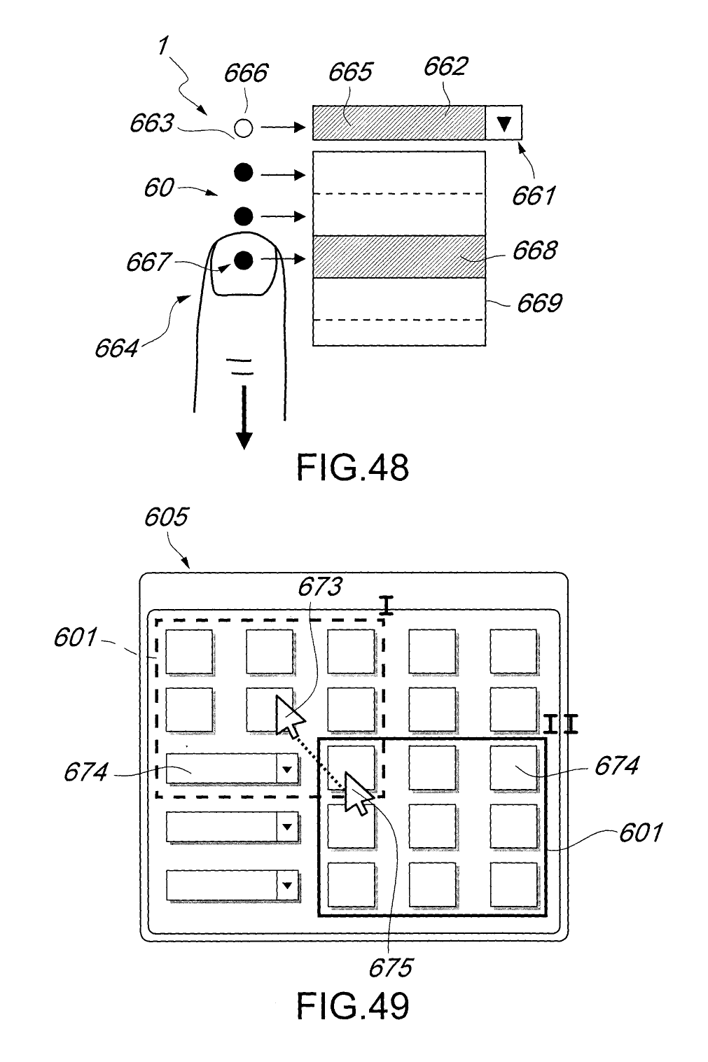

FIG. 48 shows an example combo box 661. The combo box is a drop-down list which in the normal state (control closed) shows only the element that is currently selected 662, while in the open state it shows a list 669 of possible selections. In order to change the current selection 662 of a combo box 661, an action that will be also referred to here as “rotation” of the combo box, the user proceeds in the following manner: he or she places the finger at a point 663 of the sensor 60 which corresponds, on the screen, to a point 665 within the combo box 661; as soon as the control 661 becomes selected the user will rotate the slideable member 664 of the input device 1 by a number of ticks 667 corresponding to the position, in the list 669, of the element 668 that it is desired to select. At each tick the management system will send a message to indicate to the combo box 661 to select the next element in the direction of sliding of the slideable member 664. The first tick of the rotation, in at least one implementation, will also cause the opening of the combo box. In at least one implementation an additional click on the selected element 668 of the list 669 will cause the updating of the current selection 662 of the combo box 661 and the closure thereof.

It is possible to combine a click action with a roll action in an action called “click & roll” in the following manner the user places the finger on a control of the type of a combo box 661, and presses the switch 5 of the input device 1 in order to perform a click, but without lifting it. Subsequently the user rotates the slideable member 664 while keeping the switch 5 pressed: the selections follow one another within the list 669. We arrive at the element 668 of the list 669 to be selected and the user lifts the finger. The button returns to the not-pressed state and the system 630 updates the current element 662 of the control 661 with the element selected 668 at the time of releasing the switch 5.

In a similar manner it is possible to control all controls, known and unknown, that behave in a similar or equivalent manner to a button (list cells, menu entries etc.) or to a combo box (sliders, spin boxes, check boxes, drop-down menus etc.)

The techniques mentioned above can be combined with using one or more auxiliary devices such as, for example, buttons, scrolling wheels and contact bands, functioning as modifiers, in order to obtain variations of the command or in order to manage a greater number of controls with just one finger. For a detailed description of the types and functions of the modifiers of the input device, see below in this description.

In the preferred implementation the system 630, following a triggering action by the user, enters a new operating mode. In the Finger Control Mode the system 630 uses the input originating from the input device 1 to manipulate the graphical interface; in the Normal Control Mode the system is managed by means of the conventional pointer, hereinafter referred to as the “system pointer”. This distinction can be used in order to pass from one mode to the other without making use of particularly burdensome actions, such as pressing a button, or actions that are harmful to concentration, such as moving the system pointer. Two preferred triggering actions of the Finger Control Mode should be noted according to the type of palette to be controlled: for a palette that is always visible, the triggering action is produced by the entry of the system pointer into the palette; for a “pop-up” palette, the triggering action is produced by the movement of the finger in a reserved area of the sensor 60 of the input device 1. Furthermore, two preferred deactivation actions (return to the Normal Control Mode) of the Finger Control Mode should be noted: for an always-visible palette the deactivation action is produced by bringing the pointer outside the area of the palette; for a pop-up palette the deactivation action is produced, essentially, by moving the system pointer.

A person skilled in the art will appreciate the simplicity and transparency of these actions and in particular the fact that they are “on the road” toward achieving a particular operation. A person skilled in the art will observe, furthermore, that the nature of this approach is radically different from the previous art and that it fully solves the drawbacks thereof.

In FIG. 45 we see an example always-visible palette 605. We shall assume that initially the system pointer 617 is outside the area of the palette 605. In order to assume control of the palette 605 the user, as indicated by the Roman numeral I, brings the pointer 617 to any point 618 of the palette 605, this can be very close to where it is initially. At this point the user will notice that the commands (for example 611, 614) of the palette 605 respond to the movement of the fingers 610a, 610b and 610c on the scroll board 600, and are highlighted when the fingers visit them.

In one implementation, and at the user's choice, the movement of the fingers 610a, 610b and 610c moves a specific cursor 615a, 615b, 615c, one for each finger. This cursor 615a, 615b, 615c can have the shape of a fingerprint, as shown in the figure, and it can have a different color for each finger. In order to increase the visibility of the controls underneath the cursor 615a, 615b and 615c, its size can vary depending on the greater or lesser pressure of the finger 610a, 610b and 610c on the sensor 60. Alternatively the cursor 615a, 615b, 615c can be invisible.

At the end of the operations the user brings the system pointer 617 outside the palette 605, Roman numeral II. Further movements of the fingers will not have any effect.

If the size of the palette 605 should be bigger than the maximum size allowed or should it include a number of controls that exceeds the number that can be handled with the current setting of the system 630, the situation will be as in FIG. 49. The dotted line area within the palette 605 represents an area under finger control 601 with the maximum allowed size. When the system pointer 673 enters the palette 605, time T1, the area under finger control 601 assumes a position like the one indicated in the figure by the Roman numeral I. As the user moves the system pointer 673 toward a part of the palette 605 which is not covered by the area under finger control 601, this is recalculated so as to move in the direction of the system pointer 673, until it eventually reaches the border edges of the palette 605. At time T2 the user has moved the system pointer 673 to the new position 675 and the area under finger control 601 associated with the scroll board 600 has been brought to the position indicated by the Roman numeral II. When moving the area under finger control 601, the controls 674 contained in it change in their turn to make way for others. A control 674 that was previously selected with a finger can, for example, move to the control of another finger, or leave the field of action of the three fingers entirely. Movement of the area under finger control 601 with respect to the system pointer 673 can occur in a quantized manner (known as snapping) around the controls 674.

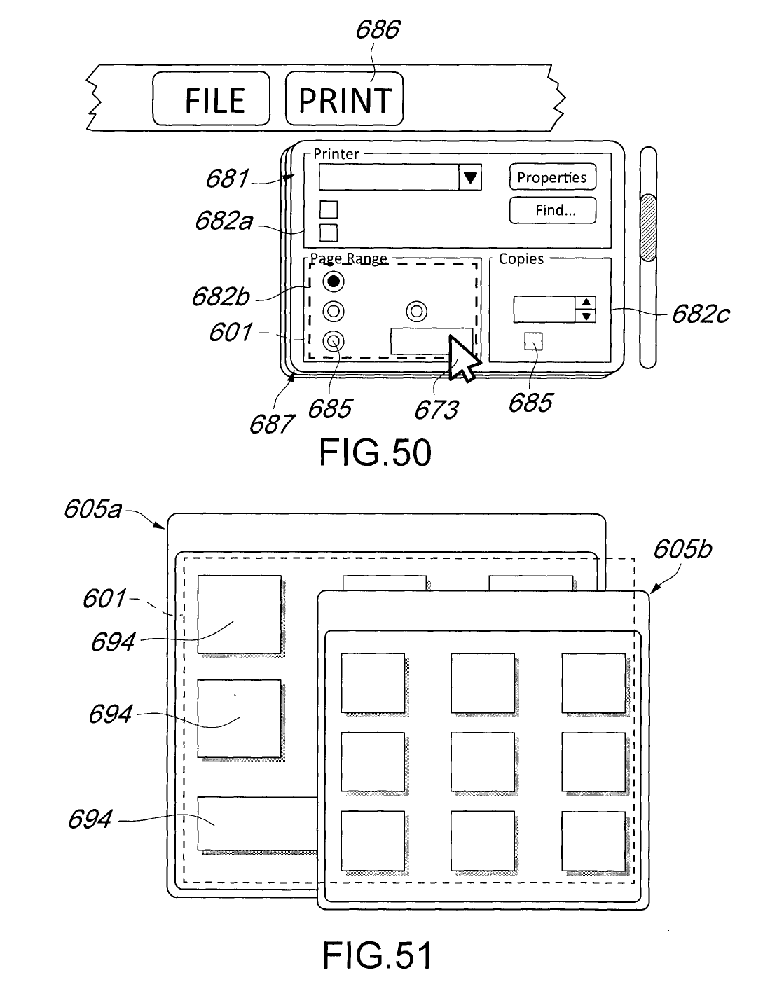

In some cases, and for better comprehension by the user, an area under finger control 601 can be adapted to contain a smaller number of elements than the number allowed by the system 630. This is so for those controls which are subdivided into functional groups, or in all cases in which belonging to a subunit of elements must be evidenced. Consider the case shown in FIG. 50, which shows a dialog window 681 subdivided into control groups 682a, 682b and 682c. Moving the system pointer 673 within the window 681 the management system, instead of centering the area under finger control 601 on the system pointer 673 and encompassing the biggest possible number of controls, dynamically adapts the area under finger control 601 to contain one entire group 682a, 682b and 682c of controls at a time.

Two or more overlapping palettes can be controlled as if they were a single palette. In FIG. 51 we see two overlapping palettes 605a and 605b. The area under finger control 601 is drawn so as to contain the upper palette 605b and also part of the lower palette 605a. The user comes to the visible elements 694 of the lower palette 605a as he or she would if they were a single palette. In order to access the non-visible elements of a palette 605a, because they are hidden by the overlapping palettes, the palette 605a must be made to revolve in the order of overlapping on the screen, technically known as Z-order, until some or all of the elements that the user wants to manipulate are made visible. In the preferred implementation this operation can be performed by an auxiliary scrolling device, such as the thumb-roller 429 present in this description (FIG. 31). By rotating the scrolling device 429 one tick forward the palette 605a immediately below the upper one 605b will move to the top of the Z-order, and the latter palette 605b will move to the bottom. At each subsequent tick the operation can be repeated until all the palettes, in turn, have been made entirely visible. This function can be activated by the management system when it detects that the user has come to two or more overlapping palettes.

When a command arranged inside a palette causes the opening of a second palette (nested palettes), this, usually, is overlapped on the first. In the preferred implementation the opening of a child palette by a control belonging to a parent palette causes the redrawing of the area under finger control so as to contain all the elements of the child palette and only those elements. In other words, the “focus” of command shifts to the nested palettes. In at least one implementation a nested palette can overlap the parent palette without taking the focus of command. In this manner the user can control the elements of a nested palette together with some of those of the parent palette.

The palettes in the examples are only one specific application case of the methods described up to now. These are equally applicable to all types of control and control containers (for example menus, toolbars etc.), as well as to editable objects (for example the words of a text, graphical objects etc.), both implemented within the specific operating system and within individual applications.

In addition to redrawing the area under finger control 601, the system pointer can be used to work on the controls of a palette in the classic manner, leaving it to the user to choose when to work in one mode and when in the other. In the Normal Control Mode, the user uses the system pointer in the traditional manner. In this mode each input device 1 of the scroll board 600 behaves like the button of a mouse: a click at any point of the input device 1 in order to launch the action for the corresponding button of a mouse (left-click, center-click and right-click). In the Finger Control Mode a click on an input device 1 does not refer to the current position of the system pointer, but rather to the element that is currently selected by means of the fingers. So that benefits can be gained from both methods, the traditional method and the one described herein, we shall describe methods for switching from one mode to the other in a natural and instantaneous manner while working on the same set of commands. The user, for example, might want to use the system pointer to go to a control in a palette and launch a command, and then decide to continue working on the same palette by means of his or her fingers.

In one implementation the transition from the Normal Control Mode to the Finger Control Mode occurs alternatively by means of moving the system pointer and moving the fingers on the sensor. In this implementation, moving the system pointer beyond a given limit value causes the transition to the Normal Control Mode. Similarly moving a finger beyond a given limit value along the surface of the sensor 60 causes the transition to the Finger Control Mode.

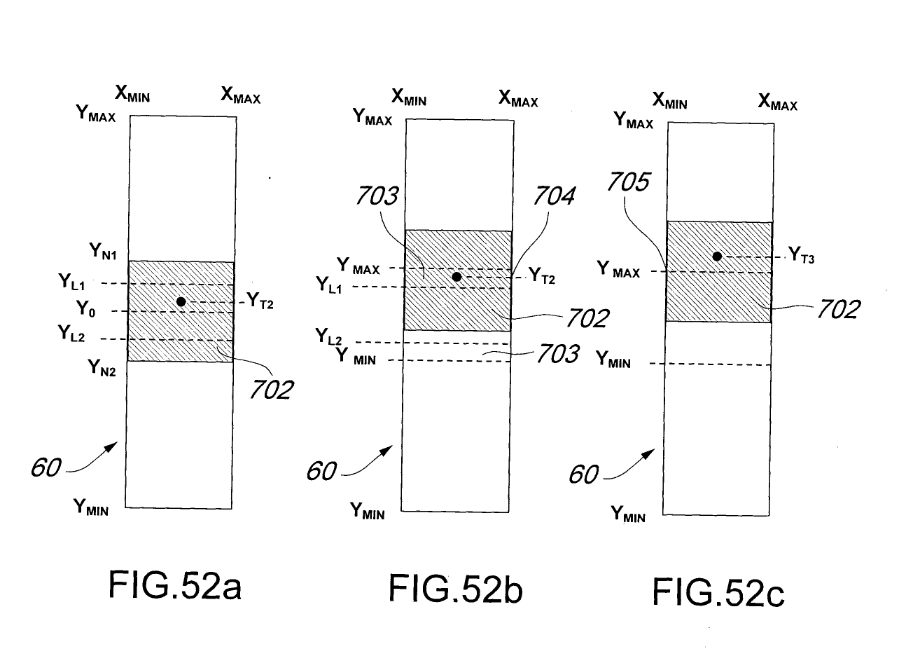

In another implementation the transition from the Normal Control Mode to the Finger Control Mode occurs by bringing a finger to any point of a reserved area of the sensor 60. FIG. 52a shows the area of a sensor 60 corresponding to a finger. The area 702 comprised between the coordinates Yn1 and Yn2 is reserved for the use of the system pointer in classic mode. We shall call this area the Normal Mode Area. As long as the finger is laying in this area 702 the input device 1 will behave like the button of a conventional mouse. This area 702 should be chosen so that it is under the fingers of the user in normal use, particularly when the user grips the device. Normally, in fact, once the device is gripped the fingers are no longer moved, apart from small body movements. The breadth of the Normal Mode Area 702 must be chosen to take account of these small movements, so that a different mode is not triggered accidentally. In order to take account also of the length of different fingers and a clumsy grip, in the preferred implementation the position of the Normal Mode Area can be variable depending on the position of the first touch of the finger on the sensor. In FIGS. 52a, 52b and 52c we see an example of the method of determining the Normal Mode Area 702 of the sensor 60 of an input device 1. At the initial time T1 the user has the finger lifted and the sensor 60 does not register its presence. This circumstance resets an internal variable which signals the presence of the finger on the sensor 60. At time T2 the user has positioned a finger on the sensor 60 and the internal variable is set. If the position of the finger YT2 is within the area marked by the limit positions YL1 and YL2, as in FIG. 52a, then the current position of the Normal Mode Area 702 remains unchanged. If the position of the finger YT2 falls respectively above or below the limits YL1 and YL2, but within the bands 703 delimited by the limits Ymax, Ymin, as in FIG. 52b, then the Normal Mode Area 702 is updated by setting the vertical coordinate 704 of its center to the coordinate of the new position of first touch YT2. At time T3 the user has moved the finger on the sensor 60 starting from this position YT2. If the position of the finger, as in FIG. 52c, should exceed the limits Ymax and Ymin, respectively above or below those limits, as in position YT3, then the vertical center 705 of the area 702 would remain fixed respectively at the Ymax and Ymin values. At time T4 the user has lifted the finger and the system returns to the initial situation (time T1).

In the present implementation, as long as the finger of the user stays in the Normal Mode Area 702 then the system 630 will remain in the Normal Control Mode, while the egress of the finger from this area 702 determines the transition to the Finger Control Mode. The return to the Normal Control Mode can occur simply by moving the system pointer, more specifically by moving it beyond a certain movement limit value.

The previous method can also be used to trigger the appearance of a pop-up palette on the screen. Pop-up palettes appear in the vicinity of the current position of the system pointer following a triggering action. Depending on whether the finger crosses the border above or below the Normal Mode Area 702, a different palette can appear. In addition to triggering the display of the palette, this action produces the transition to the Finger Control Mode, and the palette obtains the focus of command.

We have shown how, with the methods described, a management of the interface commands is achieved which is free from the slowdowns caused by continual movements of the pointer. We have moreover shown how the transition from one mode to the other occurs seamlessly.

### Structured System of Palettes

It is possible to use the methods described up to now, as well as others which shall be introduced as required, to create a structured system of palettes which is capable of containing within it the entire set of functionalities made available by a modern application and of making them available for use very rapidly and in a reduced screen space.

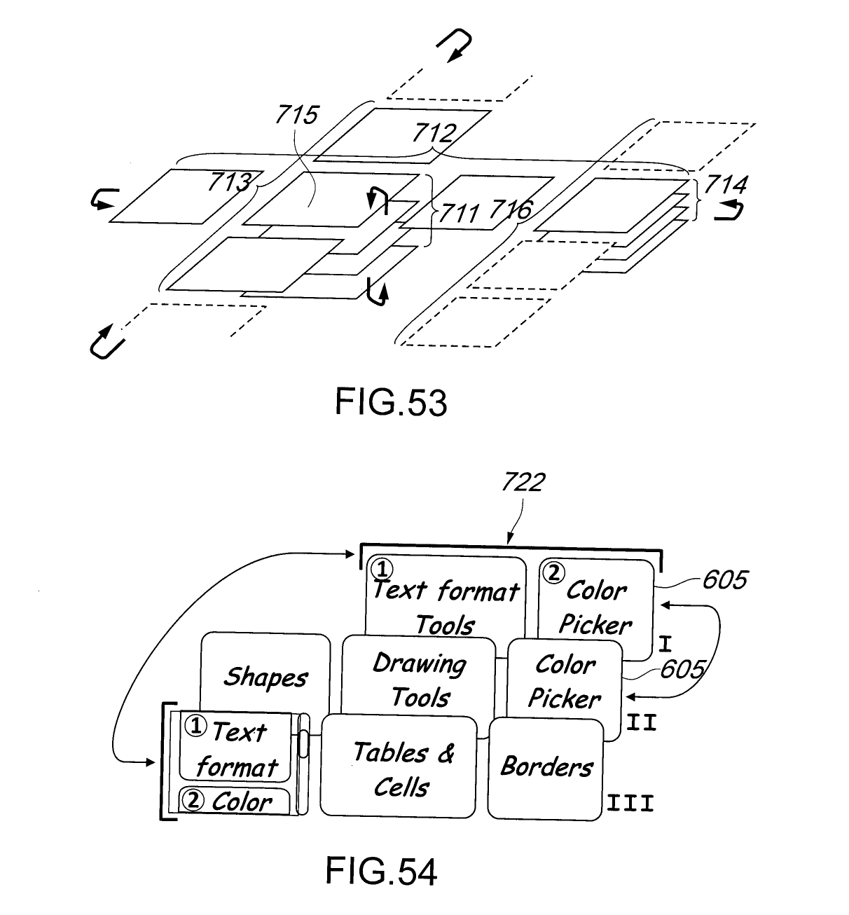

With reference to FIG. 53, we shall describe systems and methods for creating a structured system of palettes. A structured system of palettes makes it possible to search for, display and control a palette which contains the controls for an application. Using the new degrees of freedom of the input device 1, it is possible to arrange the palettes in a three-dimensional spatial scheme. A three-dimensional system of palettes makes it possible to arrive at the destination palette much more rapidly than in a conventional system since it is possible to reach it in six directions starting from the current palette. In order to achieve the objectives the system makes use of three distinct representations of a set of palettes. In the first of these, the palettes are arranged so as to form overlapping layers. Hereinafter we shall call these palettes simply “layers”. In the second representation, the palettes are arranged side by side one after the other in at least one screen direction, and are visible in a scrollable window. For convenience we shall call these palettes “fliers”. In the third representation, the palettes are arranged side by side. We shall call palettes arranged in this manner “tiles”. These representations are independent of each other and have their own methods for determining the current palette (cycling). They furthermore offer a way to group the palettes into logical groups: for example the palettes in a layer can all belong to the same program.

In FIG. 53 we see an example of a structure in which all three of the aforementioned types are shown. We see palettes grouped schematically into layers 711, 714, in tiles 712, and in fliers 713, 716. Fliers 713 are scrolling palettes and can be displayed by way of a scrollable window. If we accept the convention whereby the layers are arranged along an axis that emerges from the screen, then what is achieved is a three-dimensional system of palettes, as is clear from looking at the figure. From looking at the figure we can see that some groups of palettes are inserted inside others. The palettes 714 are grouped in layers and positioned inside the tiles 712 which in turn are dependent on element 715 of the fliers 713. In this manner we achieve a multidimensional system with the following characteristics: the possibility of further reducing the distances between two palettes with respect to a purely three-dimensional system, and the possibility of inserting the same structure of palettes at multiple points, which favors the speed of navigation between palettes even more. By replicating a structure, in fact, and locating it in a position closer to other palettes, we obtain an additional shortening of the path. This latter characteristic can be taken advantage of by the user to set up a customized control environment.

In FIG. 54 we see palettes arranged on three levels, I, II, III. It can be seen that single palettes 605 and entire structures 722 (connected in the figure by arrows) are replicated on different levels. In particular we see that the entire level I (palettes 1 and 2) relating to generic text formatting is replicated in a location of level III, relating to tables, in the form of scrollable palettes (fliers). Since the user knows the content of level I, he or she will have no difficulty with working on the same set of palettes replicated on level III.

The palette structures can be always visible on the screen, or they can be made to appear like a conventional pop-up palette. The methods of accessing the current palette of a structure are the same as those described for single palettes, for example the palette in FIG. 45. In FIG. 50 we see a structure of palettes 681 floating on the screen. The structure can be anchored to the sides of the screen in the usual ways. In the same figure, a structure of palettes 681 is made to appear following the selection of a menu entry 686. The same action can also be used for making the transition to the Finger Control Mode.

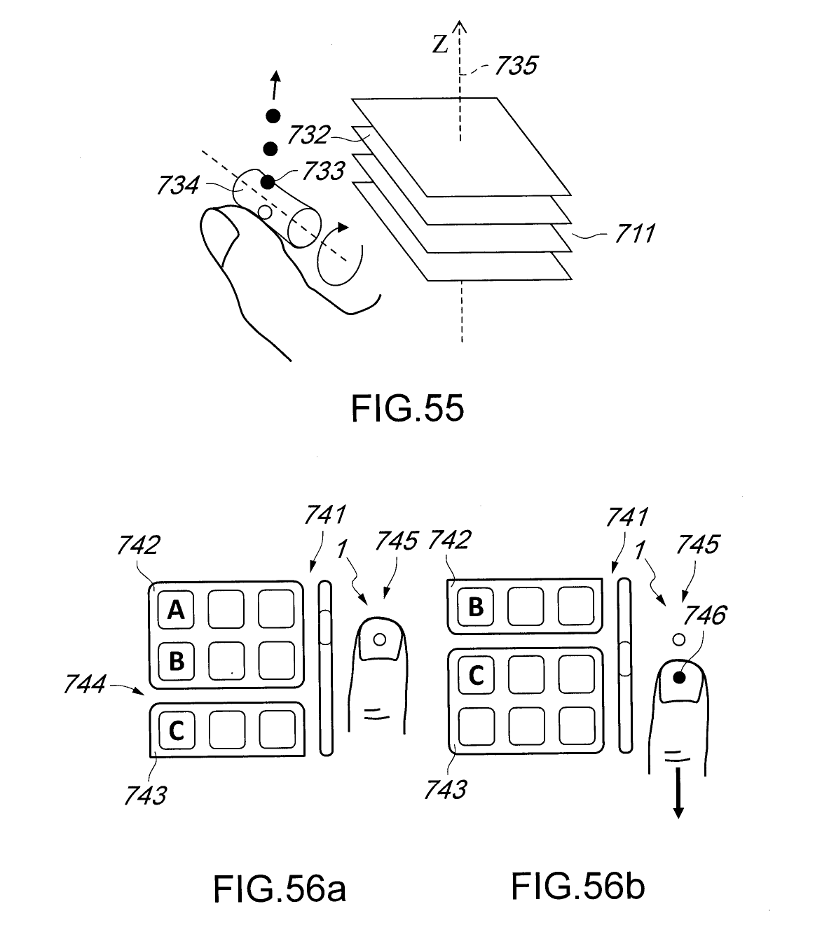

Below are the methods for cycling through palettes within each structural type. FIG. 55 schematically shows a group of layers 711. The palettes 732 which are lower down than the first are hidden or partially visible. In their place there may be a graphical representation that indicates their presence, such as the element 687 in FIG. 50. In the preferred implementation, a tick 733 on the auxiliary scrolling device 734 (thumb-roller) causes the advancement or retraction of the palettes 732 in the Z-order 735. In FIG. 56a we see a scrollable window 741 through which it is possible to scroll the palettes 742 and 743 within a group 744 of fliers. The upper palette 742 is fully visible while only the first row of the lower palette 743 is visible. Of the former, we can see the cells A and B which belong respectively to the first and second row of the palette 742 and which correspond to the first and second row of the scrollable window 741. Of the latter 743 we can see the cell C which belongs to the first row of the palette 743, as well as to the third row of the scrollable window 741.

In one implementation the content of a scrollable window is made to scroll by one row by rotating the slideable member 745 of at least one input device 1. In another implementation, the same effect is achieved by rotating the slideable member 745 with at least one finger while maintaining contact with at least one contact band 424 which is arranged laterally to the at least one input device 1.

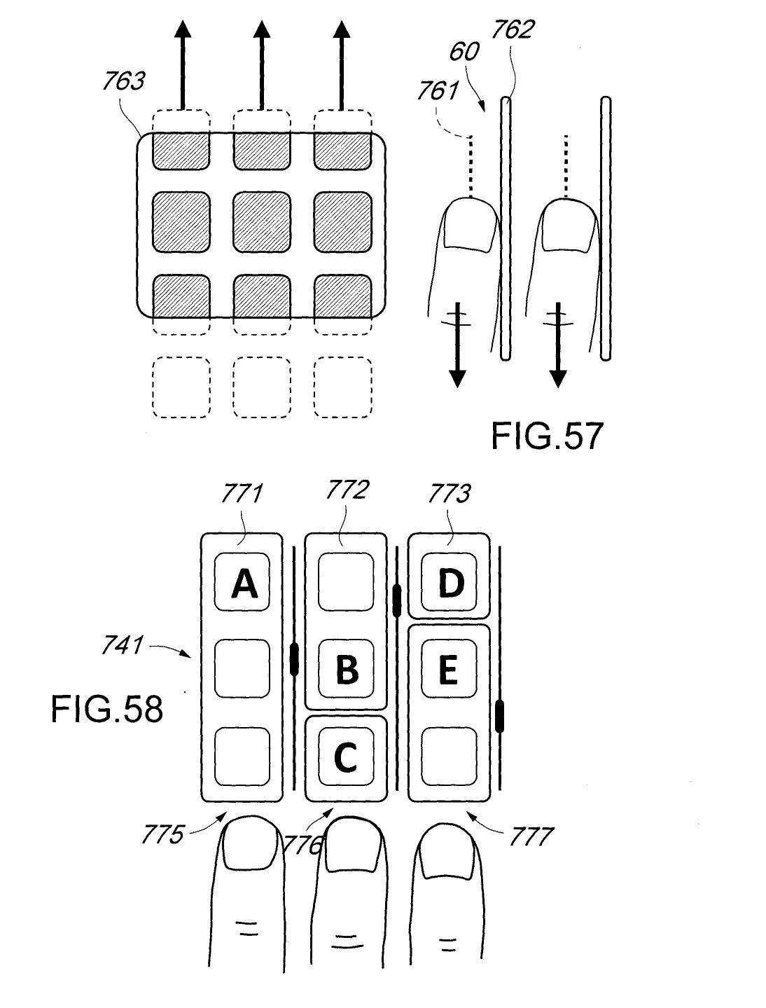

FIG. 56b shows the status of the scrollable window 741 of the previous example, after the user has rotated the slideable member 745 downward by one tick 746. As can be seen, the first row of the palette 742 has disappeared and, in the lower part, second row of the palette 743 has appeared. Other modes of scrolling are possible. By clicking with at least one finger and keeping the input device 1 pressed while rotating the slideable member 745 we obtain, with each tick 746, the page by page scrolling of the content of the scrollable window 741. In FIG. 57 we see an example of continuous scrolling. The user positions at least one finger at any point 761 of the sensor 60 so as to establish contact with a contact band 762 as well. By moving the finger up and down, the window 763 scrolls its content continuously upward and downward. This function is useful for positioning the rows at the height preferred by the user.

In one implementation, in FIG. 58, the palettes 771, 772, 773 within the scrollable window 741 are positioned horizontally side by side and each one of them can be made to scroll individually by rotating the slideable member 775, 776, 777 of the input device which is associated therewith.

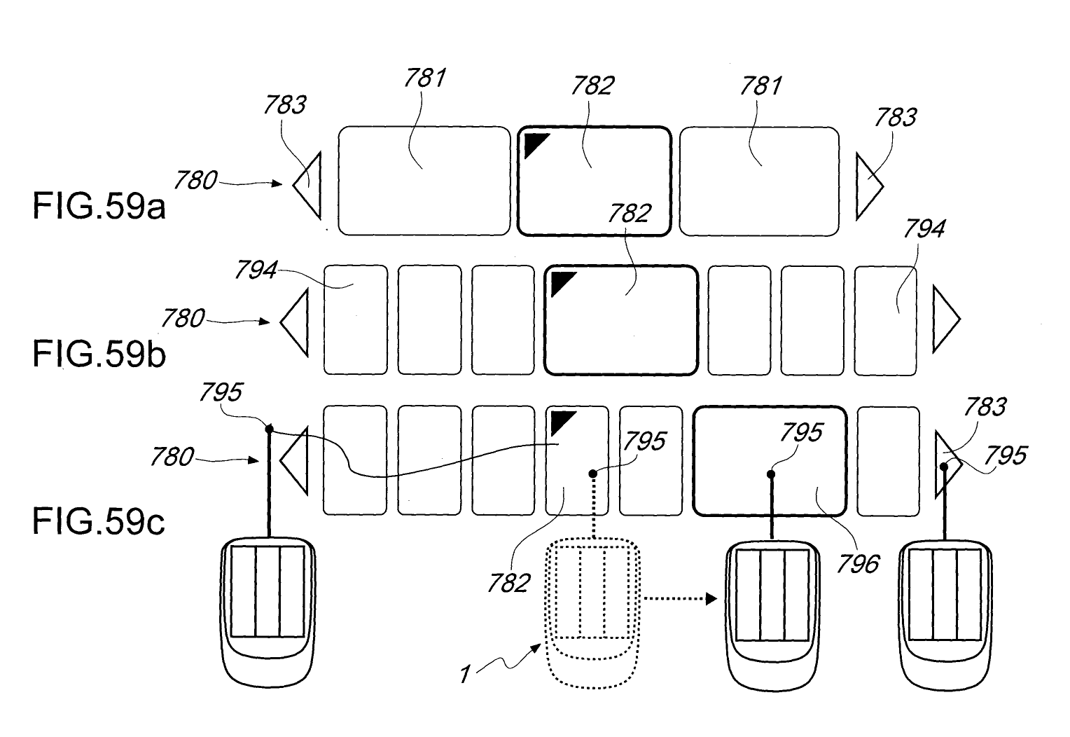

FIGS. 59a, 59b and 59c show a group of tiles 780. There are a series of secondary palettes 781, a principal palette 782 which is marked in the figure with a black triangle, and overflow icons 783. The secondary palettes 781 appear when the principal palette 782 receives the focus of command. They are arranged preferably along the horizontal axis of the screen. In order to save space they can be reduced to thumbnails when they are not selected. With reference to FIG. 59b, the rectangles of reduced size 794 represent the palettes 781 reduced to thumbnails. The principal element 782, which is currently selected, appears in its normal form. As the selection changes in response to an action from the user, the tiles that assume the focus of command are expanded to their normal form, while those that lose the focus return to the thumbnail state. In the preferred implementation a change of selection is achieved by moving the system pointer 795 beyond a preset amount of movement, in the direction of the new selection 796. In the example in FIG. 59c, the user, who initially controls the principal palette 782, moves to the right by a quantity equal to at least twice the preset movement quantity, thus moving the selection 796 forward by an equal number of positions. The overflow icons 783 indicate the presence of other palettes in addition to the ones already in view. They are furthermore used as scrolling devices. In the preferred implementation it is possible to scroll a group of side-by-side palettes by hovering with the system pointer 795 over an overflow icon 783 for a determined period of time, after which the palettes will begin to scroll automatically in the preset direction until the icon 783 is vacated. In another implementation the palettes 781, 782 are made to scroll in one of the two directions by rotating the slideable member 2, 102 of the input device 1 by the number of ticks corresponding to the number of hidden palettes to display.

When control is taken of a structure of palettes or if the current selection is changed, the area under finger control 601 is adapted by the system 630 in the following ways: if the selected palette does not belong to a group of fliers then the area under finger control 601 will coincide with the area of the palette. If it does belong to a group of fliers, then the area under finger control 601 will coincide with the internal area of the scrollable window 741.

We have shown that it is possible to manage an unlimited number of palettes of commands with little effort and without moving the pointer. We have furthermore shown that it is possible to save space on the screen by hiding some palettes within an organized structure.

It is possible to reduce the space used and the movements of the system pointer even further, by using a pop-up structure. Like pop-up palettes, a pop-up structure appears proximate to the system pointer following a triggering action. Pop-up systems generally suffer from a problem which is linked to their continual appearance and disappearance on the screen. It is known these appearances and disappearances can in the long term affect concentration. It is therefore desirable to provide a pop-up system with characteristics adapted to minimize its negative effects. This object can be achieved in two combined ways: by reducing the size of the palettes, and by using particular graphical contrivances. It is known that the larger a palette is, the more its appearance will affect concentration. In addition to the aforementioned thumbnails it is possible to reduce the space occupied on the screen in two ways: by selectively displaying graphic controls, and by reusing the background of a palette.

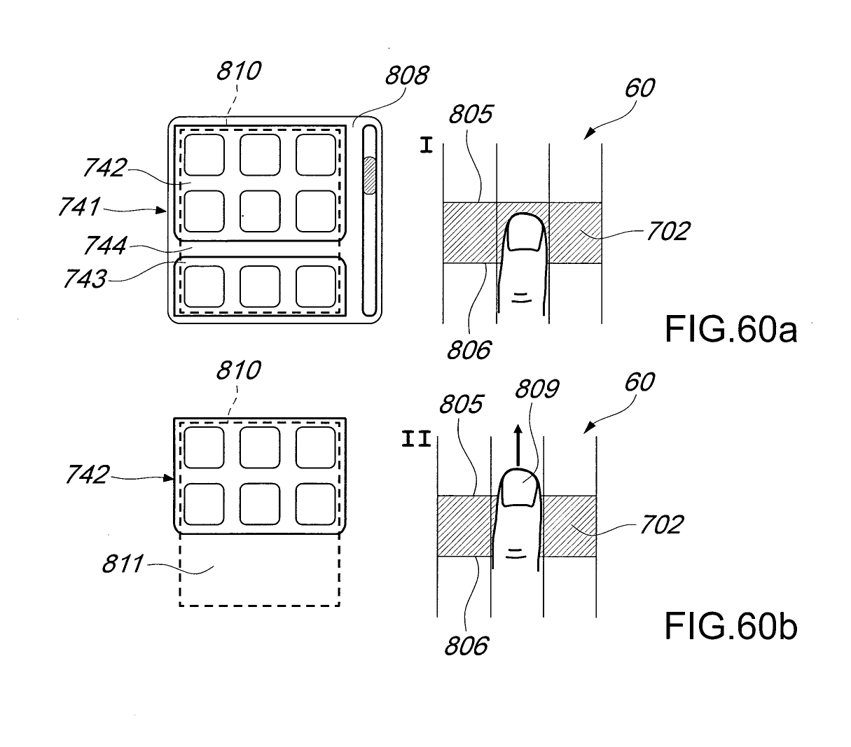

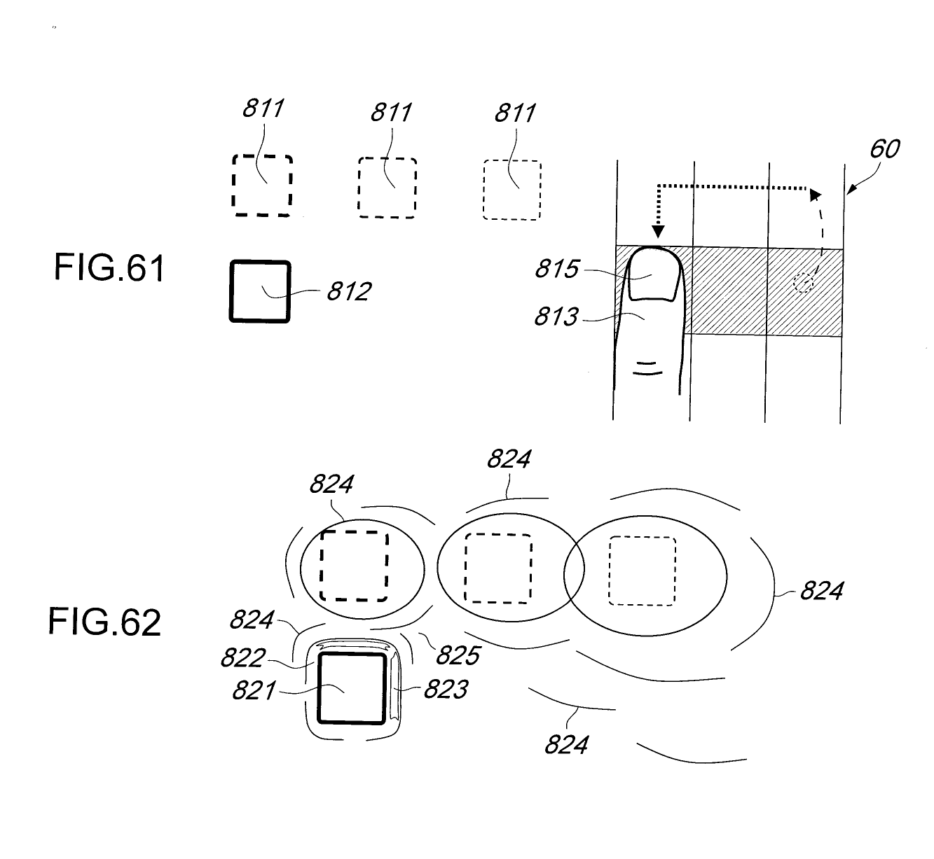

We shall describe methods whereby, within a scrollable window, selectively smaller numbers of elements will be displayed according to the type of action performed by the user. In FIG. 60a we see a scrollable window 741 within which we see two partial palettes 742, 743 which are delimited by a separation line 744. In order to access them the user must, in the preferred implementation, cross the upper 805 and lower limits 806 of the Normal Mode Area 702 with the finger. Assuming that the user knows the position of the palette 742 that he or she wants to access, the movement of the finger in the direction of the palette 742 can tell the system to display only the part of the latter that appears in the scrollable window 741, and not draw any other palettes 743 or the frame 808 of the window itself. This situation is indicated in FIG. 60b. Here the movement of a finger 809 toward the upper part of the sensor 60 has triggered the appearance of the upper palette 742 alone (the area under finger control 810 still coincides with the inner area of the scrollable window 741). This view remains until the user takes the finger 809, with an opposite movement to the previous one, outside 811 (up or down) the part of palette 742 that is currently displayed, or scrolls the scrollable window 741 in any direction. These actions cause the redrawing of the scrollable window 741 and of all the palettes 742, 743 which are visible within it. The crossing of the limit 805, 806 of the Normal Mode Area 702 can occur in two ways: by sliding the finger 809 on the sensor, or by jumping (i.e. breaking off contact with the sensor while the finger is in the Normal Mode Area 702). In one implementation, positioning one or more fingers by jumping in an area outside the Normal Mode Area 702 causes the display of only those controls in a palette 742 which correspond, in the area under finger control 810 of the scrollable window 741, to the current position of the fingers on the sensor. This situation is shown in FIG. 61. Here we see a group of controls 811 which were recently selected by jumping, and a currently-selected control 812. The controls 811 have disappeared following the lifting of the finger 813 from the sensor 60 or the transition of the finger 813 to another location on the sensor 60. The control 812, corresponding to the current position 815 of the finger 813 on the sensor 60, is still visible and can be controlled with the methods previously described.

In FIG. 62 we see an example graphical effect applied to a pop-up control of the type just described. Taking inspiration from the behavior of a light body in water, it is possible to replicate some aspects of this in order to obtain transitions during opening and closing of graphical elements which are soft and pleasing. The control 821 in the figure is surrounded by an edge 822 which is constituted of reflections 823 of water. The edge 822 is formed gradually as if the control had been pushed out of the screen from the inside, thus creating a continuity with the situation before the control appeared. The transition can moreover be accompanied by an animation in the form of small ripples 824 which also affect the part of the screen 825 underlying the control 821 that has appeared. A similar effect can be produced for the appearance of the graphical element 821 and obstinately repeated in order to indicate a user action that is no longer executable such as, for example, reaching the end of a list in response to a scroll action.

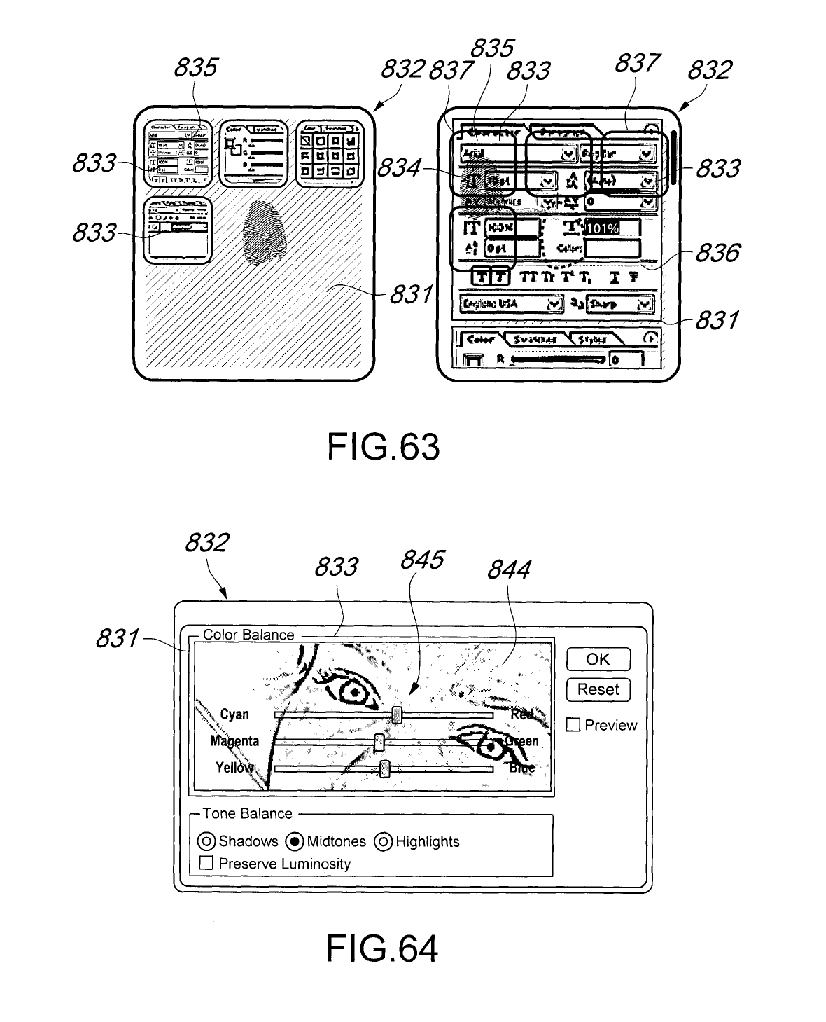

In FIG. 63 we see an example of reuse of the background of a palette. We see the background 831 of a palette 832 and, on another level, the controls 833. In this case the controls are selection buttons, in the form of thumbnails, which are used to call up the corresponding palette. By moving the finger cursor 834 over a thumbnail 835, the background 831 of the palette 832 is updated with the palette 836 to which that thumbnail 835 refers. By clicking on the thumbnail 835 the buttons 833 disappear and the palette 836 moves to the foreground. When a palette 836 is in the background, the part of it which is not covered by the buttons 833 can be manipulated directly with the methods previously described. The buttons 833 can be substituted by silhouettes 837 when one of them becomes highlighted.

In another case, in FIG. 64, the background 831 of a palette 832 or of a group of controls 833 can offer a thumbnail 844 of part of a document to be edited with the overlapping controls 845.

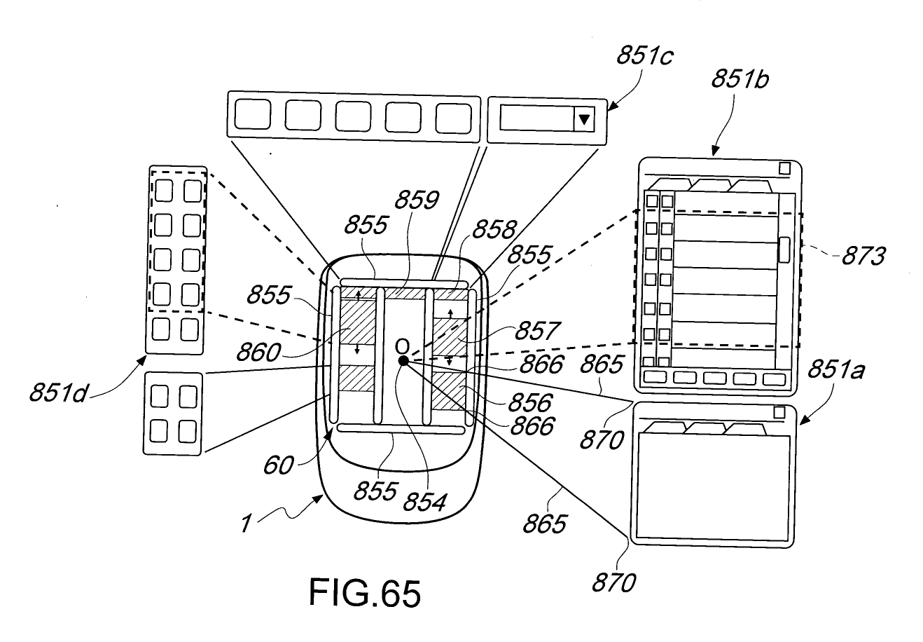

A method for the rapid selection of palettes that are variously arranged on the screen. With reference to FIGS. 65 and 29, by using at least one input device 1 in association with at least one contact band 424 it is possible to select a palette to be manipulated by positioning a finger on the sensor 60 in the direction of that palette and keeping the finger in contact with at least one contact band 424.

In FIG. 65 we see the palettes 851a, 851b, 851c and 851d, all placed around the central area of a screen. We also see an input device 1 which for simplicity is shown in the place of the cursor in the position O 854. It is possible to logically subdivide the sensor 60 so that each section 856, 857, 858, 859, 860 of the sensor 60 corresponds to a palette 851a, 851b, 851c, 851d. Following the example in the figure, a section 856 is comprised at least partially of the intersections 866 of the sensor 60 with two lines 865 originating at O and terminating at the border edges 870 of the corresponding palette 851a. Very big palettes 851b can be subdivided into smaller sections 873 which can be made to scroll along the entire area of the palette 851b. The current section 873 of a big palette 851b corresponds to the current area under finger control of the palette 851b. The current section 873 of a big palette 851b corresponds to a moveable section 857 of the sensor 60 which can act as a scrolling bar. By positioning the finger on a moveable section 857 of the sensor 60 and simultaneously on the contact band 855 which is adjacent to the moveable section 857 and moving the finger up and down, we obtain the scrolling of the current section 873 of the palette 851b on a continuous or quantized basis. The function of selecting a palette 851a or section of palette 873 is triggered by placing a finger in contact with the section 856, 857 of the sensor 60 corresponding to the palette 851a or to the section of palette 873 and with the same finger also touching the contact band 855 which is adjacent to the section 856, 857 of the sensor 60. By breaking off contact with the contact band 855, in at least one implementation, the palette 851a (or the section of palette 873) remains selected. In another implementation the confirmation of the selection occurs by way of a click with the same finger. Once selected, the palette assumes the focus of command and can be controlled in two ways: by positioning the area under finger control on the palette itself or by replicating its content in a pop-up palette. In the first case, control occurs at a distance from the system pointer, and in the second case, in its immediate vicinity. In both cases the method works even if the palettes are not visible on the screen because the system keeps track internally of their last position. The method can be used in all other cases where it is advantageous to use it.

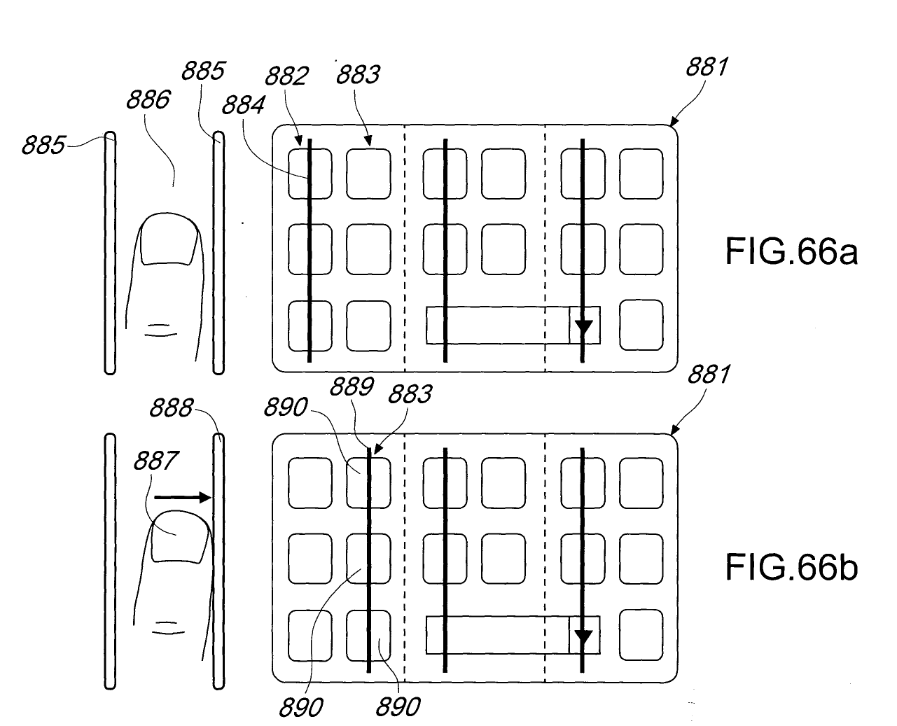

A method for controlling extra columns. It is possible to control two or more columns of commands with just one finger by making use of modifier devices such as contact bands and side switches. In FIG. 66a we see a palette 881 with two columns 882, 883 of commands per finger. In the normal position each finger controls only the left-hand column 882. This situation is indicated in the figure by the presence thereon of the scanning line 884. It is possible to move the scanning lines 884, i.e. make it control a different column, both as a block and individually or even cell by cell. The movement can furthermore be temporary or permanent. According to a first method, the contact of a finger on a contact band 885 adjacent to the input device 886 causes the shifting of the scanning line 884 in the direction in which the contact band 885 is positioned with respect to the input device 886.

In FIG. 66b we see the palette 881 of the previous example after the user has touched the right-hand contact band 888 with the index finger 887. The scanning line 889 corresponding to the index finger 887 is now drawn on the right-hand column 883 and the user can work with the controls 890 in it with the methods we have already seen. In one implementation, breaking off contact with a contact band returns control to the original column. It is possible to make the selection of an additional column permanent by performing a tap or a double tap on the corresponding contact band. The same effect can be achieved by rotating the thumb-roller 429 by a number of ticks corresponding to the position of the column in the series of additional columns.

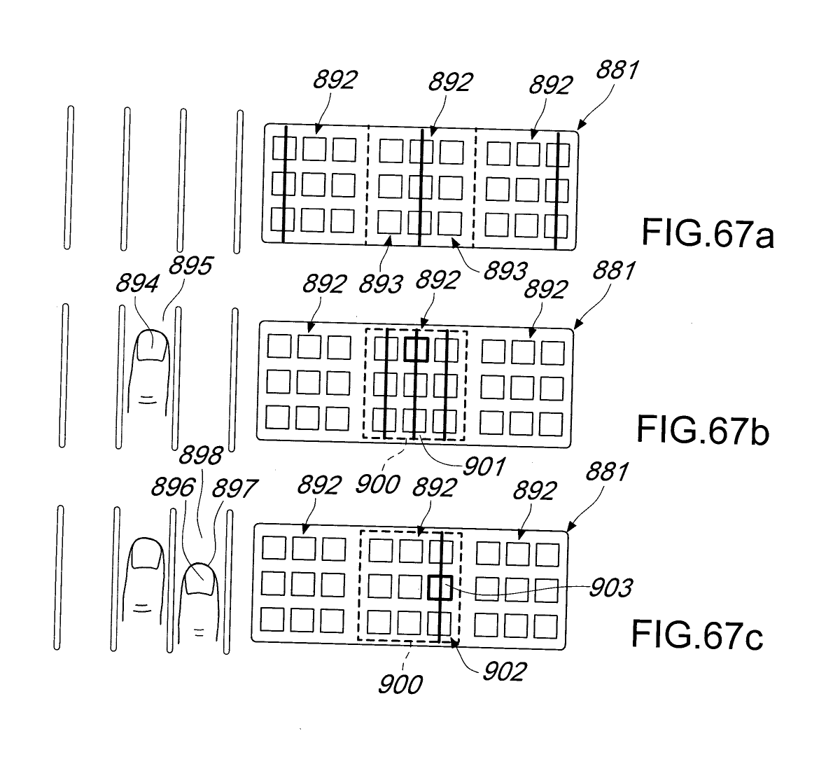

According to another method the selection of a cell in an additional column occurs by way of the combined use of two fingers. FIG. 67a shows a palette 881 with three groups 892 of three columns each. Selection of an additional column 893 occurs by placing two fingers on the respective sensors in sequence. With the first finger the user selects the group of columns, with the second the column within the group. In the example in FIG. 67a the user has placed the middle finger 894 at any point of the second input device 895 and, subsequently, the ring finger 896 at a point 897 of the third input device 898, as in FIG. 67c. The first action has selected the second group 900 of columns and, by default, the second column 901. The second action has selected, within the group 900, the third column 902. The height of the position 897 of the finger 896 on the sensor 60 selects, as normal, a command 903.

A method for selecting extra rows. It is possible to select the first and last rows of a palette by positioning the finger respectively on the first and on the last row of the sensor and with the same finger simultaneously touching the horizontal contact band adjacent to it. In this manner it is possible to increase the number of vertical controls that can be handled by the sensor while maintaining unchanged the number and breadth of the cells into which it is subdivided.

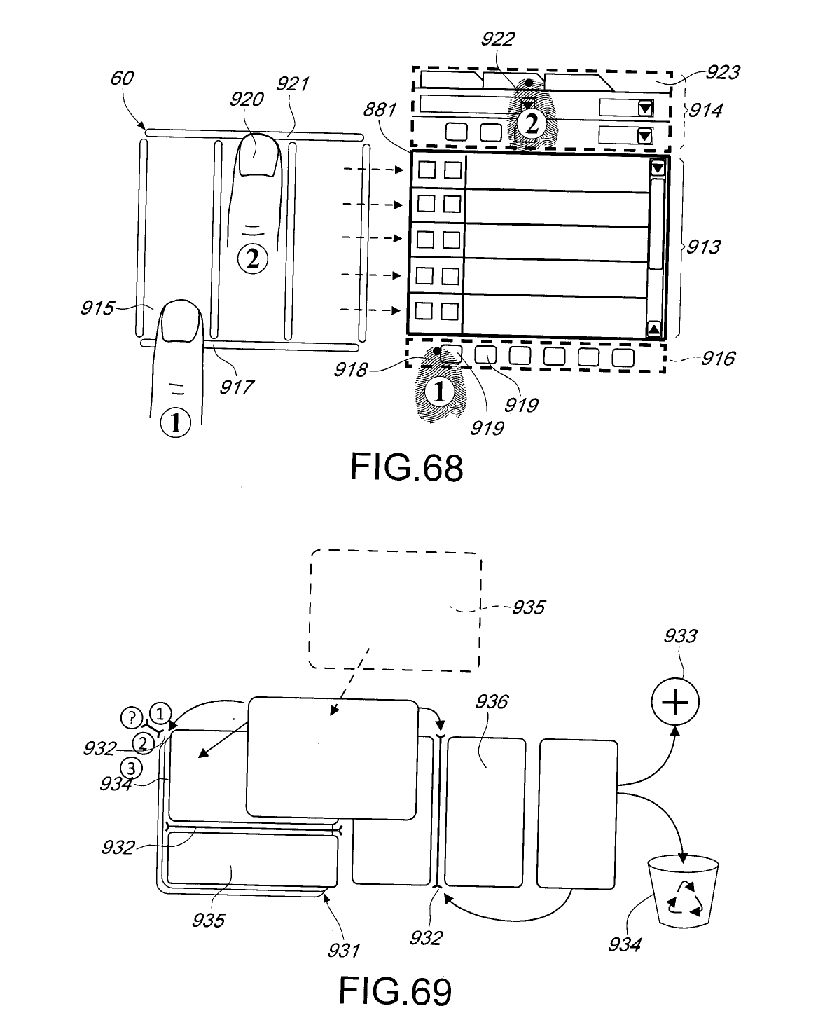

In FIG. 68 we see a palette 881 which is divided into 9 rows and controlled by a sensor 60 which is configured to handle 5 of them. In the example the sensor 60 controls the 5 central rows 913. In order to access the outermost rows 914, 916 the user proceeds in this manner he or she goes to the cell 915 of the sensor 60 which is nearest to the additional row 916 to be controlled and touches the horizontal contact band 917. As a consequence of this, the cursor 918 of the finger is positioned on the additional row 916 thus allowing the user to act on the controls 919 contained in it. By breaking off contact with the contact band 917, in at least one implementation, the additional row 916 remains selected until the cursor 918 vacates the cell 915 of the sensor 60. A double tap on the contact band 917 makes the selection permanent until the next movement of the pointer. In one implementation the additional rows 914, 916 are not initially visible (dotted line) and the technique described simultaneously causes their appearance. If the additional rows 914, 916 are n per side, then using the method makes it possible to access them in sequence starting from the outermost one 923. Once made available for use, these will occupy the first n cells of the sensor on the side corresponding to them (above or below). In the figure, a touch of the finger 920 on the contact band 921 located above has positioned the cursor 922 of the finger on the first 923 of the three rows 914 of a group of controls, thus also causing their appearance.

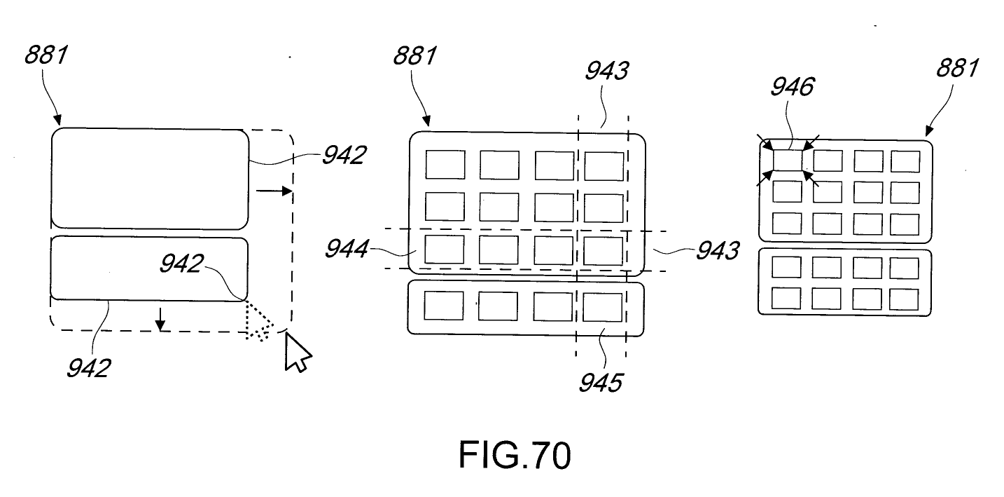

A structure of palettes can be customized in two ways: “WYSIWYG” and “manual”. In WYSIWYG mode the user drags, with known methods, the palettes to a point of the structure and, upon release, the palette is inserted at the point indicated. A palette can be withdrawn from any part of the user interface in order to be moved, copied or deleted. In a structure it is also possible to insert legacy palettes such as toolbars, and even single groups of commands such as those present, for example, in a dialog window. It is possible, furthermore, to insert an entire structure of palettes into a structure, such as, for example, the structure 681 in FIG. 50. It is likewise possible to move or copy a palette which is already part of a structure to a new location therein. In FIG. 69 we see a structure of palettes 931, insertion points 932, service icons 933 and 934, and an example external palette 935. Following a user action the system enters a mode in which the structure of palettes 931 does not disappear when the pointer is moved, and the pointer can be used to drag the external palette 935 to an insertion point 932 of the structure 931. The insertion points 932 are highlighted when the palette 935 passes through them. A palette can be inserted in a group of layers 934, of fliers 935 or of tiles 936. A palette can be duplicated or deleted by dropping it on the respective icons 933 and 934. A palette can furthermore be parked on the screen. In one implementation, the user action is a double click on the side switch 426. In another, the system enters the WYSIWYG mode upon pressing the side switch 426 and remains in that mode until it is released. In WYSIWYG mode it is also possible to resize each palette of the structure so as to accommodate a greater or smaller number of controls. With reference to FIG. 70, the resizing occurs by dragging the edges 942 of the palette 881 by an amount 943 equal at least to that of the row 944 or column 945 that the user wants to add. Alternatively, such an action can cause the effective resizing 946 of the palette 881 and of its content.

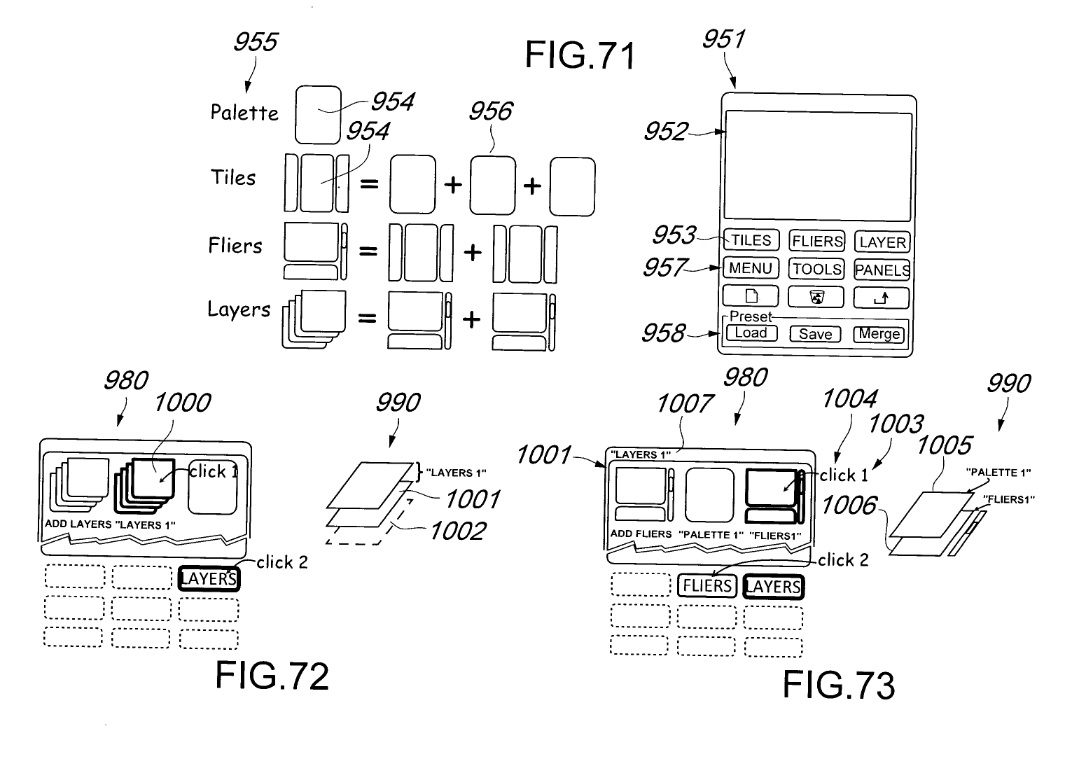

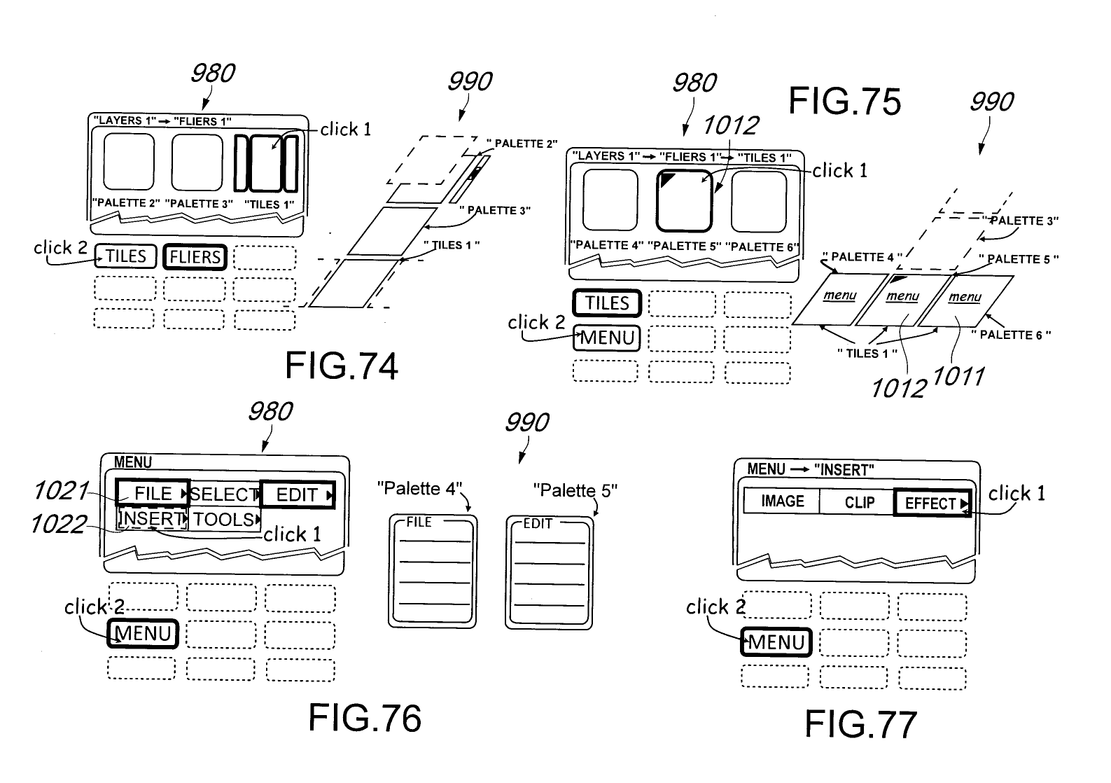

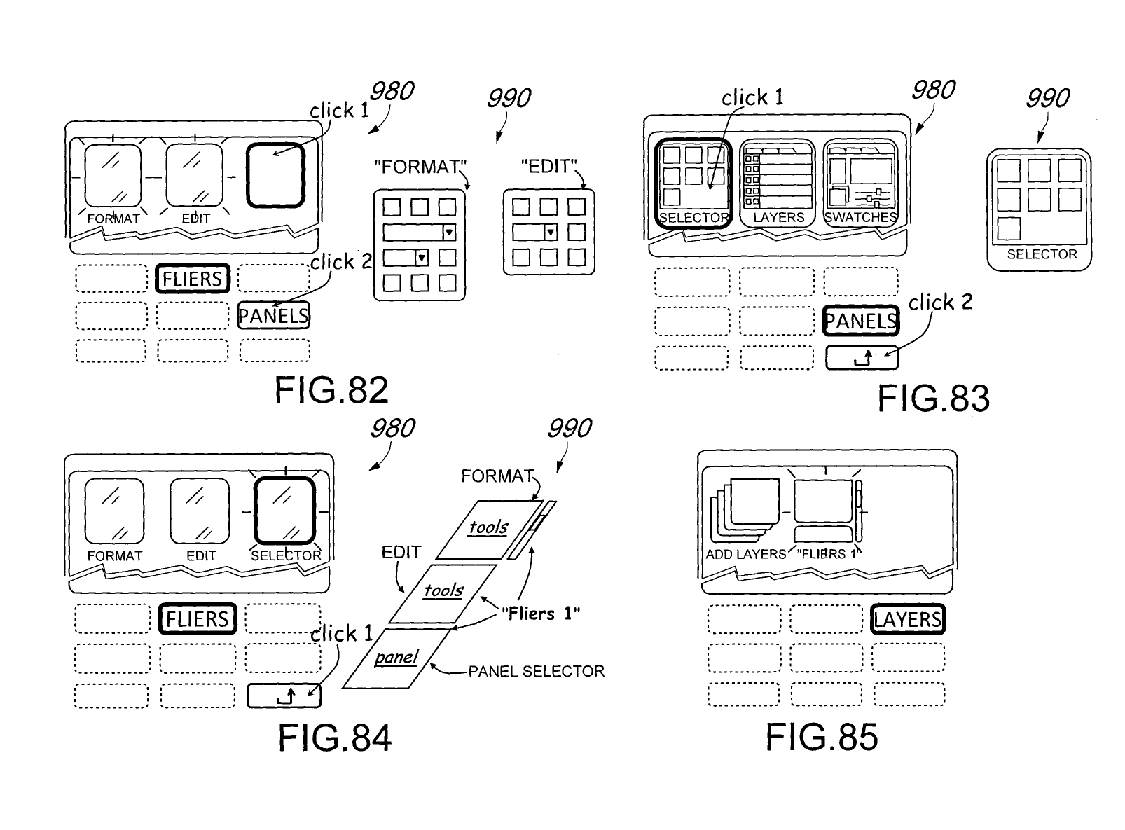

In the manual customization mode, the user can reorganize the content of a structure of palettes via a dialog window, hereinafter referred to as an “organizer”. FIG. 71 shows an organizer 951 provided with a window 952 and a series of buttons 953. The window 952 provides a representation of a part of the structure by way of icons 954. The figure shows the icons 954 together with a description 955 of what they represent and an example 956 of their inner composition. The buttons 953 are divided into two assemblies. The first 957 is used to manage the content of the structure, the second 958 to manage its presets and filter its display. The operation of the buttons 957 will become clear in light of the examples shown in the groups in FIGS. 72 to 78 and FIGS. 79 to 85. In the first of these, we see the actions to perform in succession in order to browse an example structure called “Layers 1”, in FIG. 72. In the second, we see the actions to create an example structure called “Fliers 1”, in FIG. 85, from scratch. For each step, the status 980 is shown of the organizer 951 and also a drawing 990 of the part of the structure affected. The history of the actions is indicated with an ordinal number 1003 beside the name 1004 of the type of action.

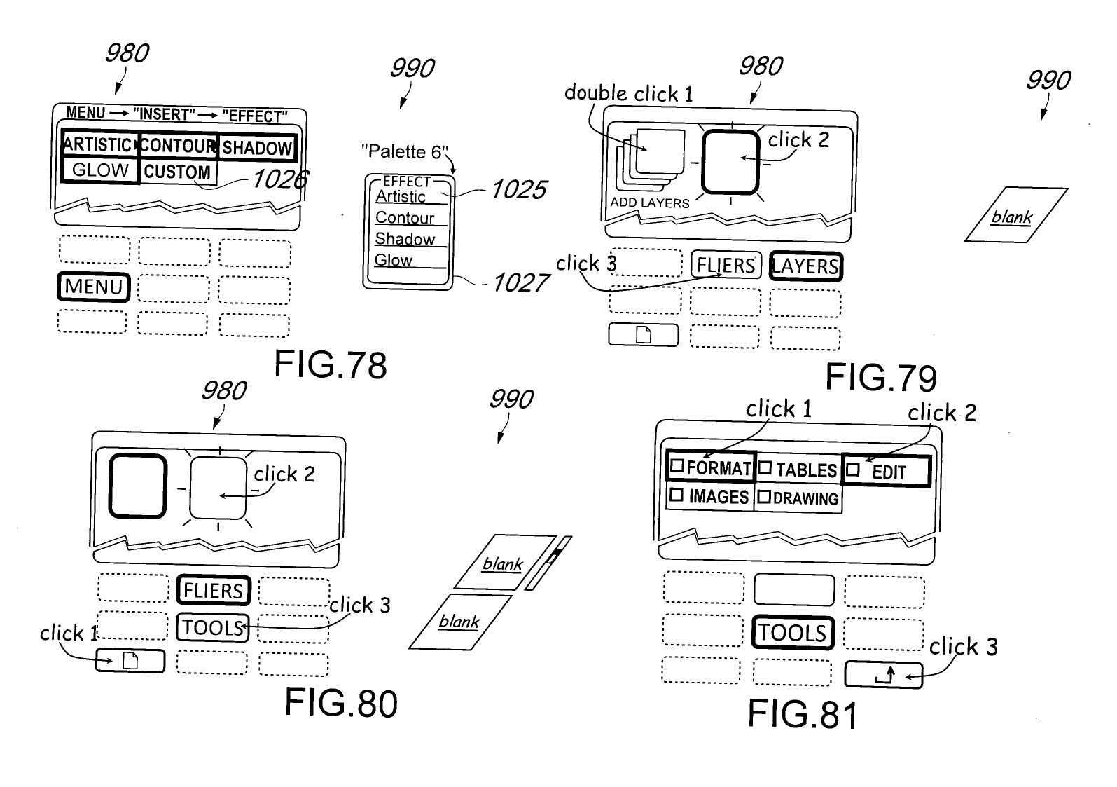

A structure can be represented by way of a tree of icons. The structure of the first example, in FIG. 72, is, at the top level, formed from two elements: a group of layers 1001 and a single palette 1002. By clicking once on one of the icons, it is selected, and with a double click the window is updated with the elements which are lower down in the icon tree. This last action can also be executed by selecting an icon 1000 and then clicking on the button associated with it. The selection is of the tri-state type and involves greying out elements to indicate that they are deactivated. FIG. 73 shows the result of a double click on the icon 1000 named “Layers 1” in the previous figure. As can be seen, with the assistance of the drawing 990, the “Layers 1” group contains a single palette 1005 and a group of fliers 1006. With actions similar to the previous ones it is possible to open the element container, and select and deactivate the elements contained. It is possible to change the order of display of the palettes on the screen by selecting the appropriate icon and rotating the slideable member 2, 102 of the input device 1. At any time it is possible to see the current path by looking at the header 1007 of the window. The structure of the example, in FIG. 75, is, at the lowest level, a series of palettes which form part of a group of tiles 1011. The principal palette 1012 of the group 1011 is marked with a triangle. By double clicking on the icon of a palette 1012, the window shows its content. This can be of three types: menus, tools and panels, corresponding to three types of classic interface command. In the example all three of the palettes 1011 are of the menu type. If we open one, in FIG. 76, we see, marked in black, the corresponding menu 1021. A dotted menu entry 1022 indicates the presence of other menus which are already selected inside it. FIG. 78 shows the content of the “Effect” menu 1025 in which the “Custom” entry 1026 has been deactivated, and thus it does not appear in the drawing 990 at the side. The second example, in FIGS. 79 to 85, shows how a user can intuitively create an empty (blank) palette, navigate the tree structure, and delete a palette. It is possible to create a palette of one of the three types by selecting a blank palette, pressing the button corresponding to the chosen type and selecting its content. In a similar manner it is possible to change the type of a palette that is already associated with a type and is not empty.

The second group of buttons 958 in the organizer 951, in FIG. 71, contains buttons by means of which it is possible to load, save and aggregate “presets”. Presets are items of information which tell the system which subsets of the structure to display. A subset can be constituted by a reduced number of layers with respect to the complete structure, within which there can be a reduced number of fliers, tiles and single palettes, within which, for example, some entries have been deactivated. In future implementations it is possible that a program can be sold, from the point of view of the end user, in the form of presets. A pair of presets, furthermore, can be assigned to different hands, making use of two input devices 1 of which at least one is advantageously provided with a position sensor. The latter can be of the removable type and be mounted in the device corresponding to the dominant hand of the user.

### Graphic Controls

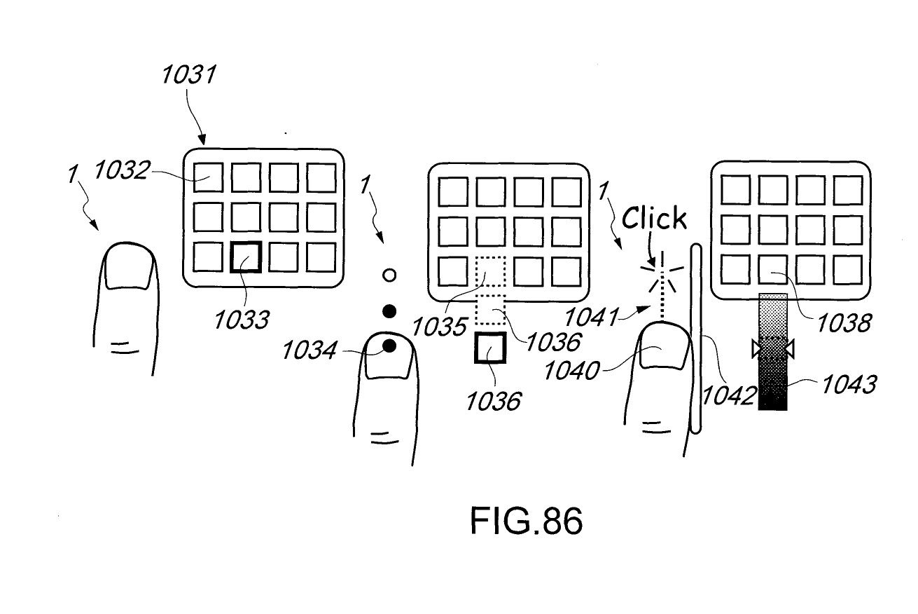

Using the methods previously described for managing controls using the fingers in combination with the adoption of one or more auxiliary devices (side switches, contact bands, thumb-rollers) as modifiers, it is possible to obtain different responses from the graphic controls to the actions of the user. As an example of application of the principle illustrated, we shall consider the case of a palette of colors, also known as a “color picker”. The palette 1031 in FIG. 86 contains buttons 1032 in the form of color cells. Clicking on a cell 1033 selects the corresponding color, and rolling 1034 on the same cell 1035 makes it possible to select supplementary colors 1036. Clicking on a cell 1038 followed by sliding the finger 1040 on the sensor 1041 accompanied by contact with a contact band 1042, plus a final (optional) confirmation click, makes it possible to choose from a continuous gradation of colors 1043. Other use cases of the method will be presented over the course of the description.

Two or more commands can be executed simultaneously by multiple fingers acting on the respective input devices 1. In one implementation two or more commands executed simultaneously by multiple fingers give a result produced by the blending of the individual effects of each command into a totally new effect. For example, in the previous example, by executing a first click with a first finger on the yellow color cell and, without releasing the switch 5 of the input device 1, executing a second click with a second finger on the blue color cell, we obtain the selection of the color green.

Controls that initially appear closed, such as a combo box, or controls that have been reduced to icons in order to save space on the screen, for example a slider, can remain permanently in view, once “open”, in order to allow the finger to scroll those controls repeatedly or to select the elements or values associated with them by jumping. To close a control which is in the open state, it is possible to execute an “escape” action which includes, for example, a touch of a finger on the sensor 60 of an input device 1 other than the one which is currently associated with that control.

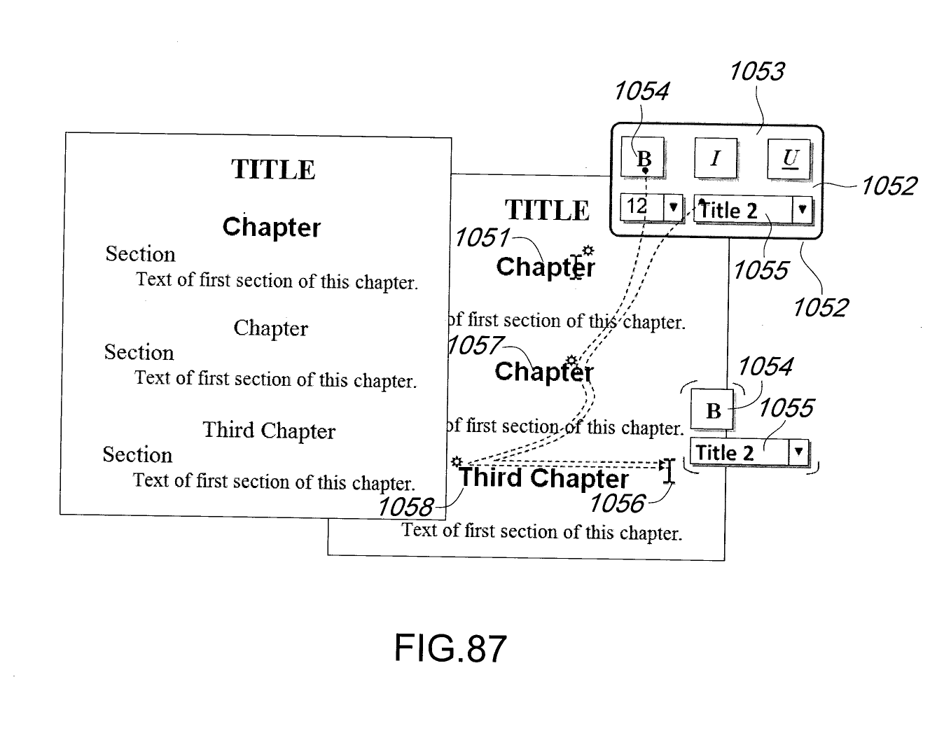

With reference to FIG. 87, a control 1054, 1055 contained in a palette 1053 can be dragged onto the object to be edited 1057, 1058 by pointing to the control 1054, 1055 with the finger and moving the system pointer 1056. In this manner the palette 1053 disappears and the system 630 enters a mode that corresponds to the type of control 1054, 1055 which was dragged. In this mode, hereinafter referred to as Command Mode, the system pointer 1056 moves accompanied by one or more icons associated with the controls 1054, 1055 that are being dragged. Once the system pointer 1056 is over the object to be edited 1057, 1058 the normal methods can be used, for example clicking or rolling, in order to apply the effects associated with the dragged controls 1054, 1055 to the object 1057, 1058. To exit from the Command Mode it is sufficient to lift the finger off the sensor 60. The example in the figure shows how it is possible to apply the same properties to a discontinuous group of objects 1057, 1058. At time T1 the user has clicked, in Normal Control Mode, on a word 1051 containing the formatting attributes to be replicated. This action has internally updated the values of the formatting controls 1052. At time T2 the user has opened a palette 1053 and used two fingers to point to the “Bold” 1054 and “Style” 1055 controls. At time T3 the user has moved the system pointer 1056, bringing it over a word 1057 of the text to be formatted. The controls 1054 and 1055, or a graphical representation of them, follow the system pointer 1056 close behind. At time T4 the user has clicked on the word 1057 thus obtaining the application of the formatting styles 1054, 1055 to the word 1057. Without taking the finger off the sensor and moving the system pointer 1056, the user has then clicked & dragged (movement of the pointer while keeping the switch 5 pressed) on a row of text 1058 thus achieving, when the switch 5 is released, a similar result. It should be noted that in this example a combo box was used as if it were a button.

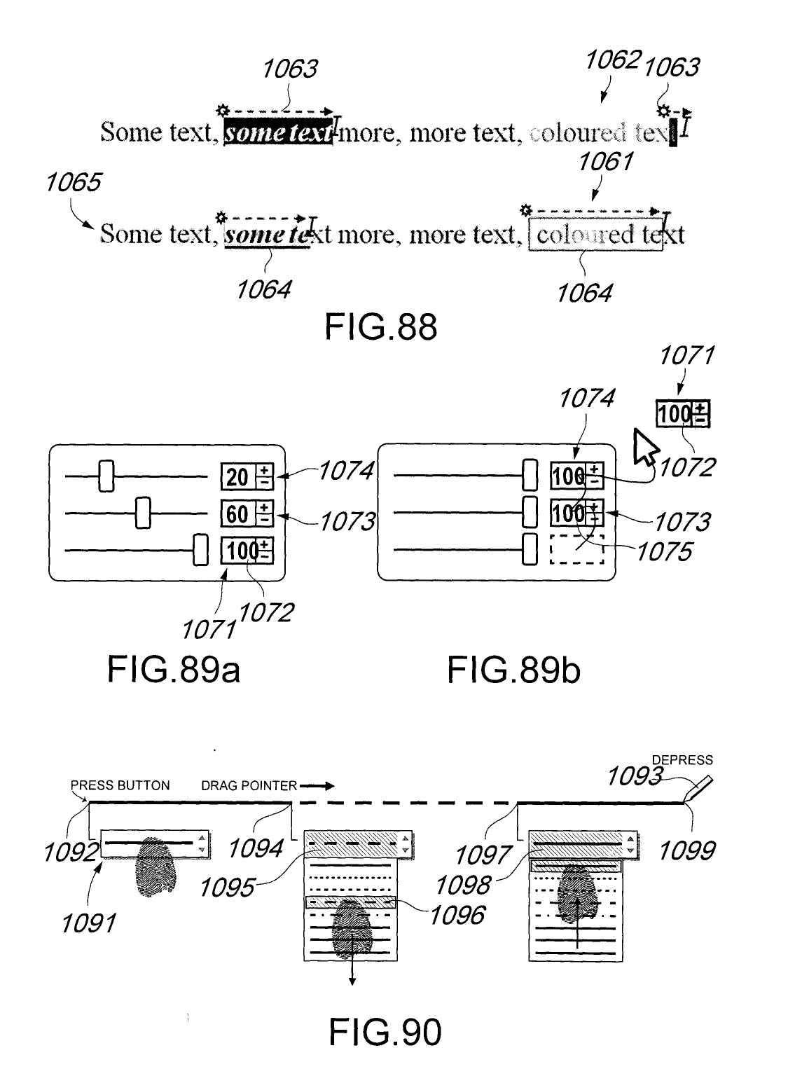

With this method it is no longer necessary to display a selection box around the objects during selection. This box can be substituted in real time, i.e. during the dragging, with a preview of the objects to be edited as they will appear at the end of the editing operation. In FIG. 88 the new 1061 and old 1062 methods of selection are compared. We see a classic selection box 1063 substituted, below, by a partial preview 1064 of a row 1065 while dragging.

A control can be dragged over another control of the same type to copy the content of the first control to the second. FIG. 89a shows an example of the method. At time T1 the user has used the finger to point to the spin box 1071 which contains the numeric value 1072 to be copied to the other two spin boxes 1073, 1074. At time T2, in FIG. 89b, the user has clicked with the same finger and, without releasing the switch 5, has dragged the control 1071 over the second spin box 1073. At time T3 the user has released the switch 5 without breaking off contact with the sensor 60. This action has updated the numeric value 1075 of the second spin box 1073 to that 1072 of the first 1071. Further controls 1074 of this type can be updated, from now on, by keeping the finger on the sensor 60 and simply clicking on the controls 1074.

A control belonging to a first instance of an object can be dragged and dropped at any point of the graphical area of a second instance of the same object in order to ensure that the value of the dragged control is copied to that of the corresponding control belonging to the second instance of the object. With this method, for example, it is possible to drag the “Volume” control of an audio track to the graphical area of another audio track in order to conform the value of the volume of the two tracks.

We shall describe methods of Live Editing which take advantage of the ability to modify the state of a control while it is being dragged. In FIG. 90 we see how it is possible to change the brushstroke of a drawing tool during the drawing of a line. At time T1 the user has pointed at a control 1091 corresponding to the brushstroke and has “dragged” it, in the manner indicated above, over the start point 1092 of the line. At time T2 the user has clicked on that point and has dragged the system pointer 1093 to the intermediate point 1094 while keeping the switch 5 of the input device 1 pressed. At time T3 the user has rotated the combo box 1091 in order to change the current brushstroke 1095 to a dotted line 1096 and, still without releasing the switch 5, has continued to drag the system pointer 1093 to the second intermediate point 1097. Here the user has performed the opposite operation by selecting a continuous brushstroke 1098 again, and has proceeded to draw the line up to the final point 1099, where the user has released the switch 5. With the same method, two or more controls can be controlled simultaneously in real time. Controls which do not modify an object but instead manipulate it can be modified during the movement of the pointer. In this manner it is possible, for example, to simultaneously move and rotate an image on the screen.

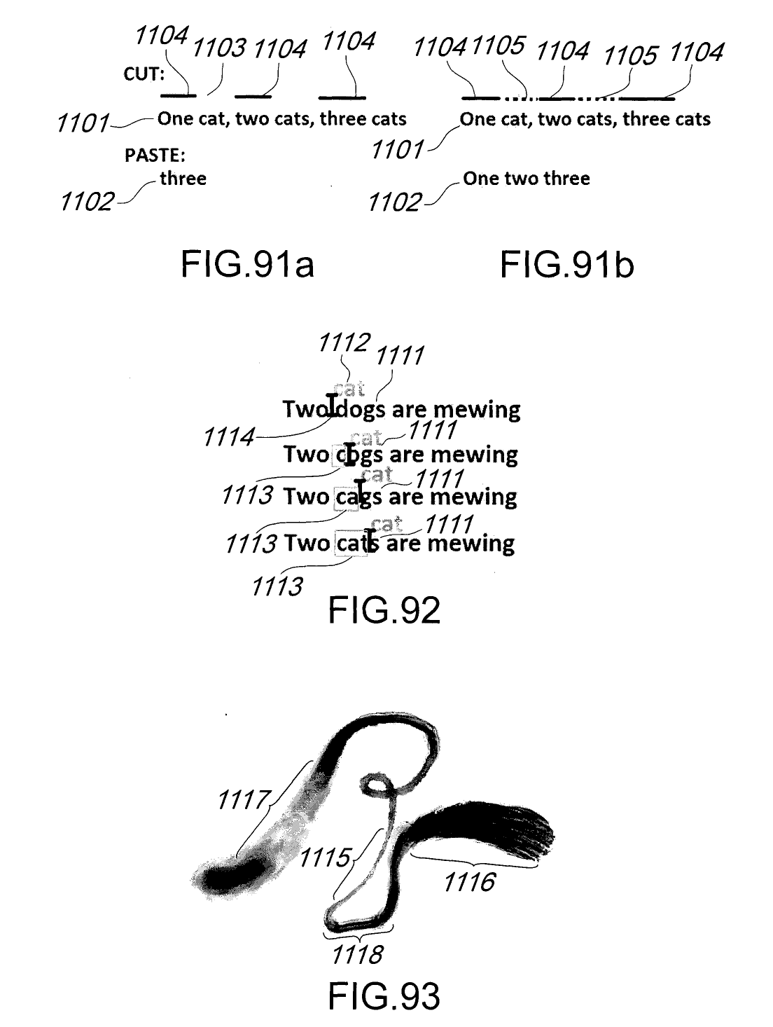

A Live Editing method applied to the Cut, Copy and Paste commands. Using the principles just described it is possible to enrich these conventional controls with new functionalities. The Cut and Copy buttons, for example, can function differently depending on whether the finger is kept on the sensor 60 or not between one action and the next. In the first case, the objects that have been copied or cut are kept queued in memory, while in the second only the last one is kept in memory. In FIGS. 91a and 91b we see a similar example applied to the words of a text 1101 together with a representation of the contents of memory 1102 in the two cases as it appears after a paste action. In the first case, in FIG. 91a, the user has lifted (dashed line 1103) the finger from the sensor between one click & drag action 1104 and the next. In the second, in FIG. 91b, the user has kept (dotted line 1105) the finger on the sensor 60 between one click & drag action 1104 and the next. With reference to the example in FIG. 92, in at least one implementation the Paste button, if dragged onto a selection 1111 of objects, can replace them immediately with the objects contained in memory 1112, offering a preview 1113 in real time of the final result. The contents 1112 of memory of a paste action can be displayed next to the insertion cursor 1114 when the Paste command is dragged.

A Live Preview method. A preview of the application of one or more commands to a selection of objects is obtained simply by passing the fingers over the regions of the sensor corresponding to the controls in question, for example over the cells of a style gallery. If two or more commands are selected simultaneously then the preview shows a result produced by the blending of the commands.

A Live Painting method. As well as operating on a series of controls, it is also possible to select the properties of the brushstroke of a drawing tool by impressing and modulating the imprint of the finger on the sensor 60. If the sensor 60 of an input device 1 is a touch pad then the lighter or heavier pressure of the finger on it can give rise to a different touch area which can be associated with quantity values of the various different brushstrokes. With reference to FIG. 93, the imprint left with a fingernail, for example, will correspond to a very small brushstroke size 1115. The very shape of the imprint can suggest the selection of a different brush type. By resting a whole phalange on the sensor 60, for example, and moving the system pointer, we can have a brushstroke similar to the one in FIG. 93, element 1116. Other brushstrokes can be had by rotating and inclining the fingers. According to a first method the user selects the color, size and shape of the brushstroke by clicking on a color within a palette and simultaneously impressing the appropriate shape on the button. According to a second method the user clicks on a color and starts drawing simply by placing the finger on the sensor 60 while the system pointer is being moved. As long as the finger lies on the sensor 60 the movement of the system pointer will trace a line of the color chosen previously, the size and shape of which will vary as a function of the imprint that the user produces on the sensor 60 while he or she draws. Lifting the finger from the sensor 60 terminates drawing the line. The operation of preselecting the color can be executed with each button of the input device with different colors and brushstroke shapes. In such case, by working on different input devices in turn we can draw, with both methods, lines with different characteristics. In FIG. 93 we see the result of the real time modulation of color 1117, size 1116 and shape 1118 of the brushstroke applied to the paintbrush tool. By working on two or more input devices 1 simultaneously we draw a line resulting from the combination or blending of the properties of each brushstroke.

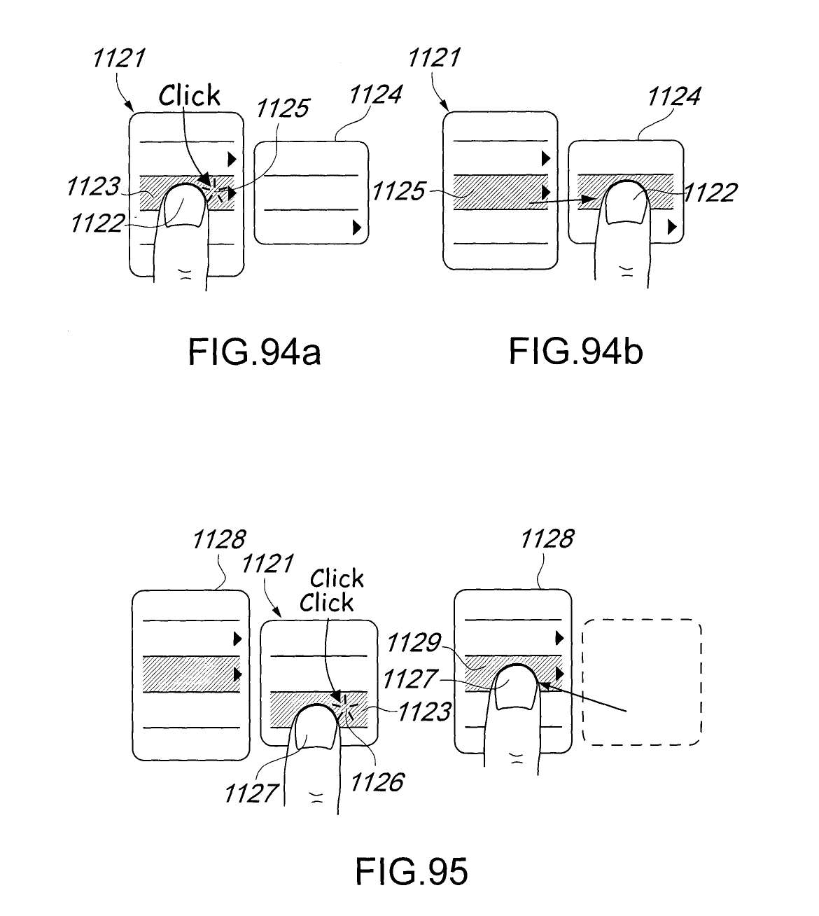

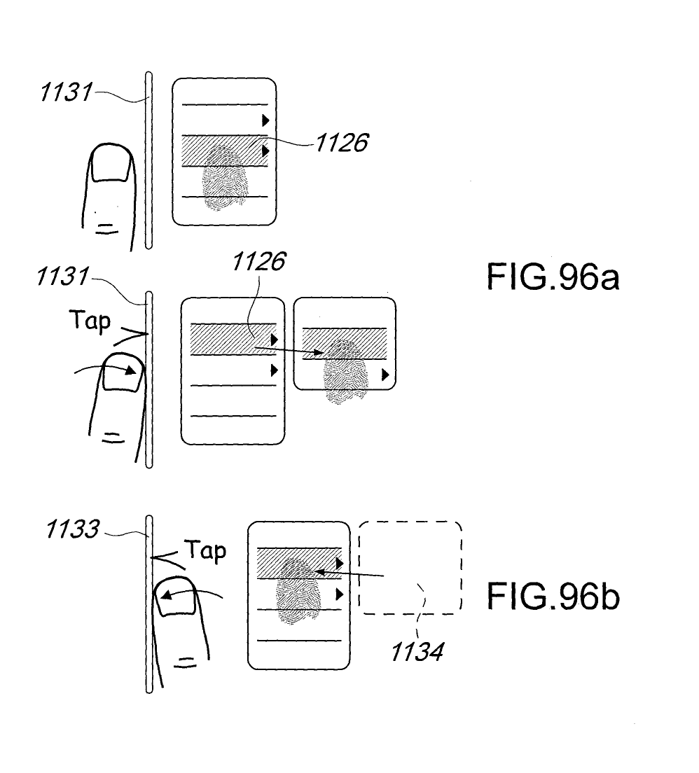

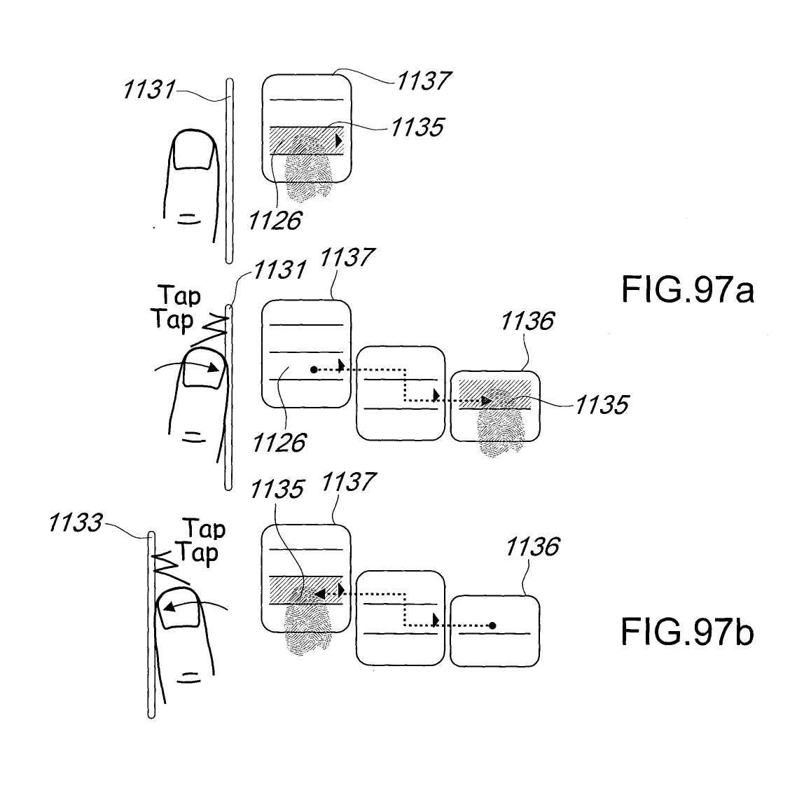

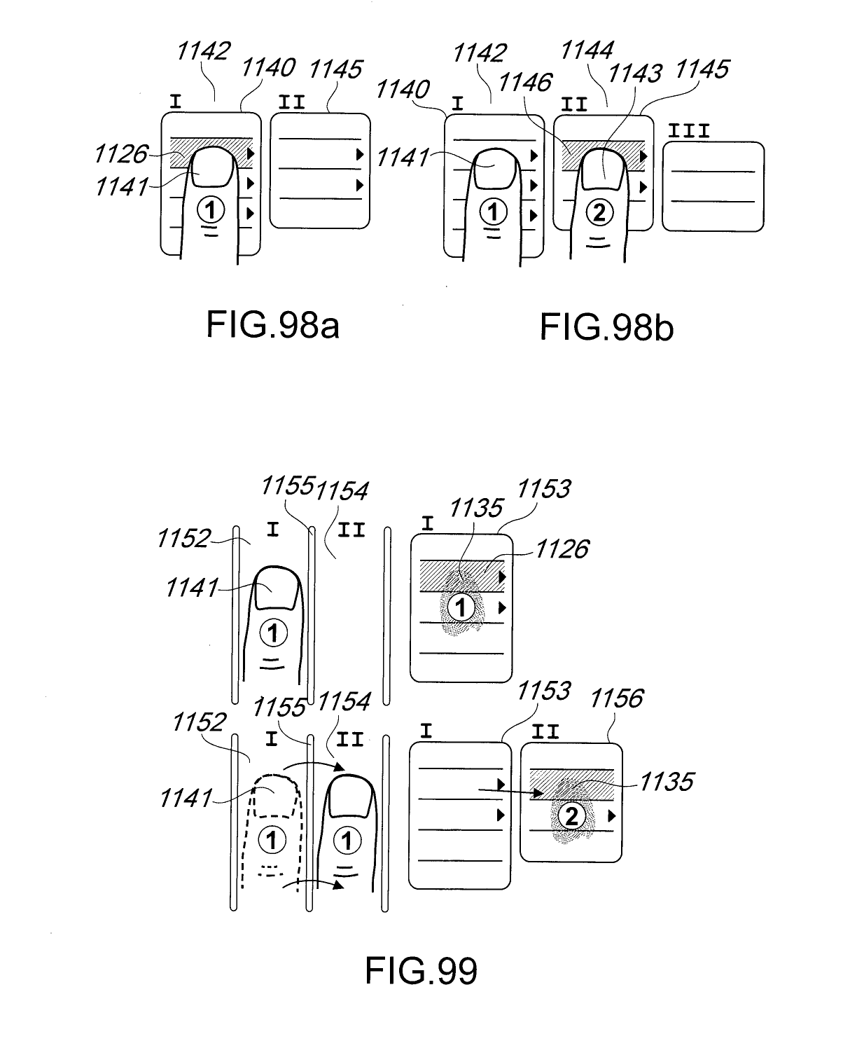

We shall describe methods with which it is possible to navigate a tree structure such as that of a menu or a folder of a file system. According to a first method, clicking with a finger at a point of the sensor 60 of an input device 1 corresponding, on the screen, to an entry of a submenu opens the submenu and positions the cursor of that same finger at an entry of that submenu. In FIG. 94a we see a menu 1121 controlled by a finger 1122 which points to an entry of a submenu 1123 and the corresponding submenu 1124. For simplicity, a finger 1122 is drawn on the output on the screen in place of the finger cursor associated with the finger 1122. FIG. 94b shows the result of clicking the finger 1122 on the sensor 60 in the current location 1125. According to a second method, in FIG. 95, a double click in any location 1126 of a submenu 1121 causes the closing of the submenu 1121 and the movement of the finger cursor 1127 to the menu of the next level up 1128 at the submenu entry 1129. According to a third method, in FIGS. 96a and 96b, we obtain a similar effect to that of the first method by tapping on the right-hand contact band 1131 at the submenu entry 1126. According to a fourth method, we obtain a similar effect to the second method by tapping on the left-hand contact band 1133 in any location of a submenu 1134. In one implementation the third and fourth methods are used to navigate the last folders visited in the manner of navigation buttons. According to a fifth method, in FIGS. 97a and 97b, a double tap on the right-hand contact band 1131 in a location corresponding to a submenu entry 1126 brings the finger cursor 1135 to the last submenu 1136 visited in the tree structure starting from that entry 1126. According to a sixth method, a double tap on the left-hand contact band 1133 in any location of a submenu 1136 brings the finger cursor 1135 to the palette 1137 of the highest (root) level of the structure. According to a seventh method, in FIGS. 98a and 98b, by positioning a first finger 1141 on a first input device 1142 at a submenu entry 1126 and, subsequently, a second finger 1143 on the input device 1144 adjacent to the first input device 1142 on the right hand side, we obtain the opening of the submenu 1145 and the positioning of the cursor of the second finger 1143 in a location 1146 of the submenu 1145. According to an eighth method, by positioning a first finger 1143 on a first input device 1144 in any location of a submenu 1145 and, subsequently, a second finger 1141 on the input device 1142 adjacent to the first input device 1144 on the left hand side, we obtain the closure of the submenu 1145 and the positioning of the cursor of the first finger 1141 in the menu of the next level up 1140. According to a ninth method, in FIG. 99, by positioning a finger 1141 on a first input device 1152 at a submenu entry 1126 and moving the finger to a second input device 1154 adjacent on the right hand side to the first input device 1152, in this manner touching the contact band 1155 interposed between the two input devices 1152, 1154, we obtain the opening of the submenu 1156 and the positioning of the finger cursor 1135 associated with the second input device 1154 in a location of that submenu 1156. According to a tenth method, by positioning a finger 1141 on a first input device 1154 at any location of a submenu 1156 and moving the finger to a second input device 1152 adjacent on the left hand side to the first input device 1154, in this manner touching the contact band 1155 interposed between the two input devices 1154, 1152, we obtain the closing of the submenu 1156 and the positioning of the finger cursor 1135 associated with the second input device 1152 in the menu of the next level up 1153.

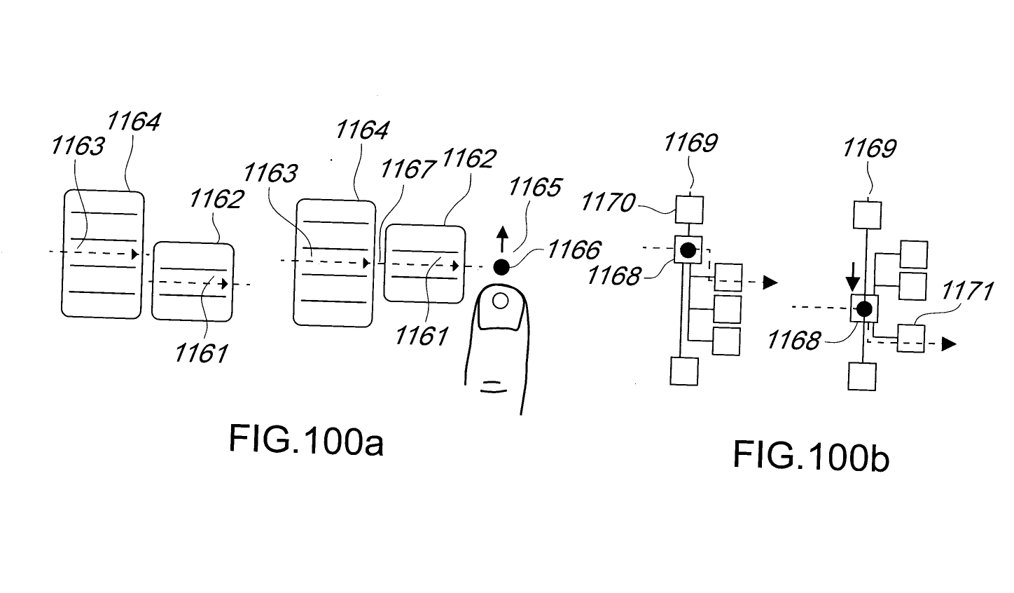

The methods described can be combined and ordered into sequences of pseudo-gestures which can be memorized by the user and repeated at will. In order to simplify the pseudo-gestures it is possible to arrange the palettes of the submenus so as to align some submenu entries, as in FIG. 100a. An element 1161 of submenu 1162 aligned 1167 with the corresponding submenu entry 1163 on the parent palette 1164 is selected by default upon opening the submenu 1162. It is possible to move the submenu palettes or the subfolders of a file system so as to bring the part of them which is used most frequently closer to the corresponding entry point on the parent palette. The submenu element 1161 thus aligned will be selected by default upon opening the submenu 1162. To move a palette 1162 vertically it is sufficient to rotate the slideable member of the input device 1165 associated therewith by a number of ticks 1166 such as to create alignment 1167 between an element 1161 of the submenu 1162 and the corresponding entry point 1163. The same operation can be performed with the subfolders of a file system, as in FIG. 100b. In the example in the figure the user has used the finger to point to a subfolder 1168 on the sensor 60 of the input device 1165 associated with the column 1169 of subfolders 1170 that contains that subfolder 1168 and has “rotated” the slideable member of the input device 1165 downward by two ticks. This action has aligned the “parent” folder 1168 with the third “child” folder 1171 of the parent folder 1168.

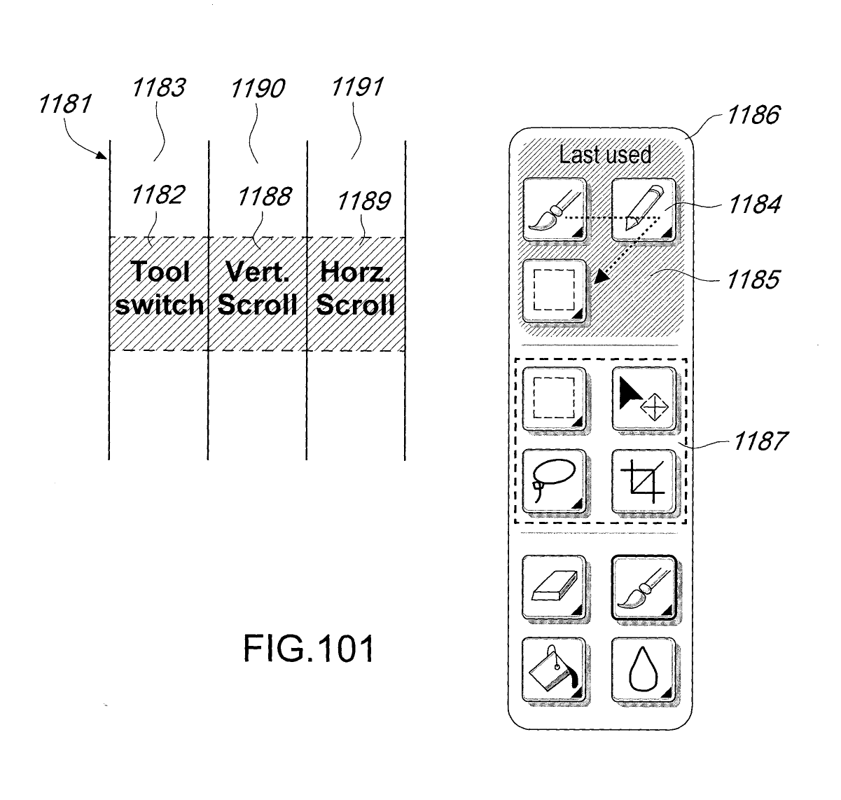

In the preferred implementation a rolling action performed starting from a point within the Normal Mode Area produces a different result than a rolling action performed starting from another position on the sensor. This peculiarity is used by the following method to simulate the behavior of a mouse wheel. In FIG. 101 we see the central part of the sensor 1181 of a scroll board divided into Normal Mode Areas 1182, 1188, 1189. The Normal Mode Area 1182, 1188, 1189 of each input device 1183, 1190, 1191 is assigned a different behavior for the rolling action. A rolling action starting from a point within the Normal Mode Area 1182 of the first input device 1183 produces the selection of a different tool 1184 in a group 1185 of tools in a palette 1186. Clicking & rolling on the same point produces the selection of a different group 1187 of tools. A rolling action starting from a point within the Normal Mode Areas 1188, 1189 of the second 1190 and third 1191 input devices produces, respectively, the vertical and horizontal scrolling of the windows.

A method of rapid character input. In FIG. 102a we see an example of the method of rapid character input which uses a palette 1201 which contains three columns of buttons, each column being controlled by an input device 1. Each button 1202 is associated with a default character 1203 and a set of supplementary characters 1204. The default character 1203 of each button 1202 can be entered by clicking on the button 1202 with the input device 1 associated with the button 1202 using the methods described previously. The supplementary characters 1204 can be entered in the following manner point the finger cursor 1205, in FIG. 102b, at the button 1202 containing the characters 1204 to be entered and rotate the slideable member 2, 102 of the input device 1, in FIG. 102c, by a number of ticks 1206 corresponding to the position of the chosen additional character 1207 within the set of supplementary characters 1204. The input of the selected character occurs when the finger is lifted from the sensor. In the example in the figure the user has pointed to the button 1202 “ABC” and has rotated the slideable member 2, 102 downward by two ticks 1206 thus selecting a “C”, which is the second element in the supplementary characters 1204 “B,C”. The method can be performed more rapidly on an input device 1 that implements the method for locking the slideable member described above. In an alternative implementation the input of the default character occurs by rotating the slideable member 2, 102 of an input device 1.

The following table gives the organization of a possible use of the method of rapid character input, with particular reference to cellular phones. Each column of the table corresponds to a button, and each row shows the values that it is possible to attribute to a button by rotating the slideable member 2, 102 upward or downward starting from the default value (central row). We see, for example, that, by rotating the slideable member 2, 102 upward, we obtain the selection of a corresponding character in uppercase. Similar effects can be obtained by way of simple gestures. For example, by tapping in sequence with the index and ring fingers on the sensor 60 we can toggle Caps On and, by inverting the order of the sequence, we can toggle Caps Off. The space character and the carriage return character can be entered by tapping on the sensor 60 respectively with two and with three fingers simultaneously.

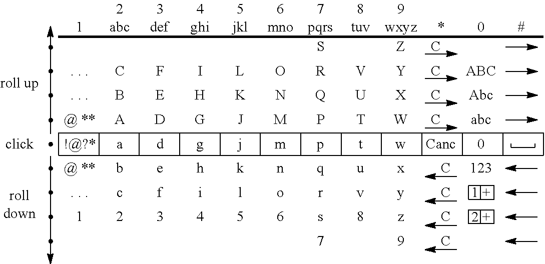

+ = auto completion methods
** = last used symbol
* = opens symbols keyboard

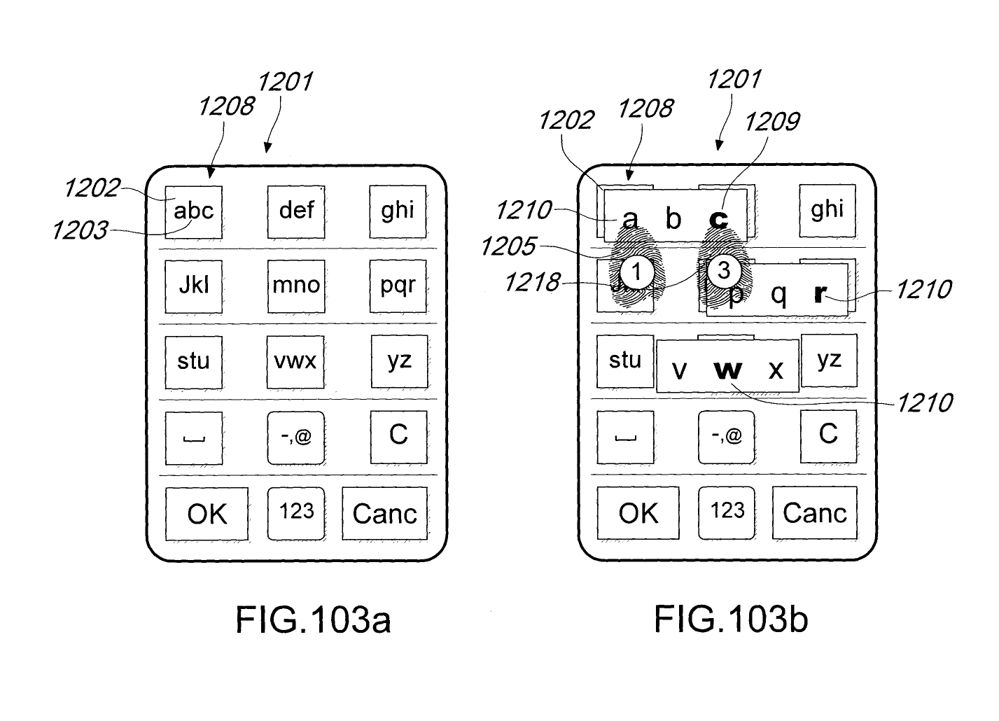

A second method of rapid character input makes use of the method, previously described, which uses two fingers to select a cell within a group of columns, in FIG. 67c. In FIG. 103a we see a palette 1201 similar to the previous one. Each button 1202 is associated with three characters 1203. By placing a first finger 1205 on the sensor 60 of a first input device 1, in FIG. 103b, we have the selection of the column 1208 to which the button 1202 belongs and within which the character 1209 to be entered is found. The height of the finger 1205 on the sensor selects a button 1202 of the column 1208 and, by default, the character 1210 whose relative position within the set of characters 1203 of the button 1202 corresponds to the position of the finger 1205 in the order of the fingers of the hand. Clicking on the button 1202 thus selected causes the entry of the default character 1210. In the example in the figure, clicking with the index finger 1205 on the button 1202 “ABC” causes the entry of the letter “A”.

By tapping or clicking with a second finger 1218, without lifting the first finger 1205 from the sensor 60, at any point of the sensor 60, we obtain the selection and entry of the character 1209 whose relative position within the set of characters 1203 of the button 1202 selected corresponds to the position of the finger 1205 in the order of the fingers of the hand. Following the previous example, by tapping or clicking with the ring finger 1218, without lifting the index finger 1205 from the sensor 60, we obtain the selection and entry of the letter “C”.

A method for automatic insertion of the space character. By using two input devices 1, a space character is automatically entered whenever a character is entered with a different input device 1 to the one used for the last input. It follows from this that by writing each word on a different input device 1 the words entered will be appropriately separated by spaces.

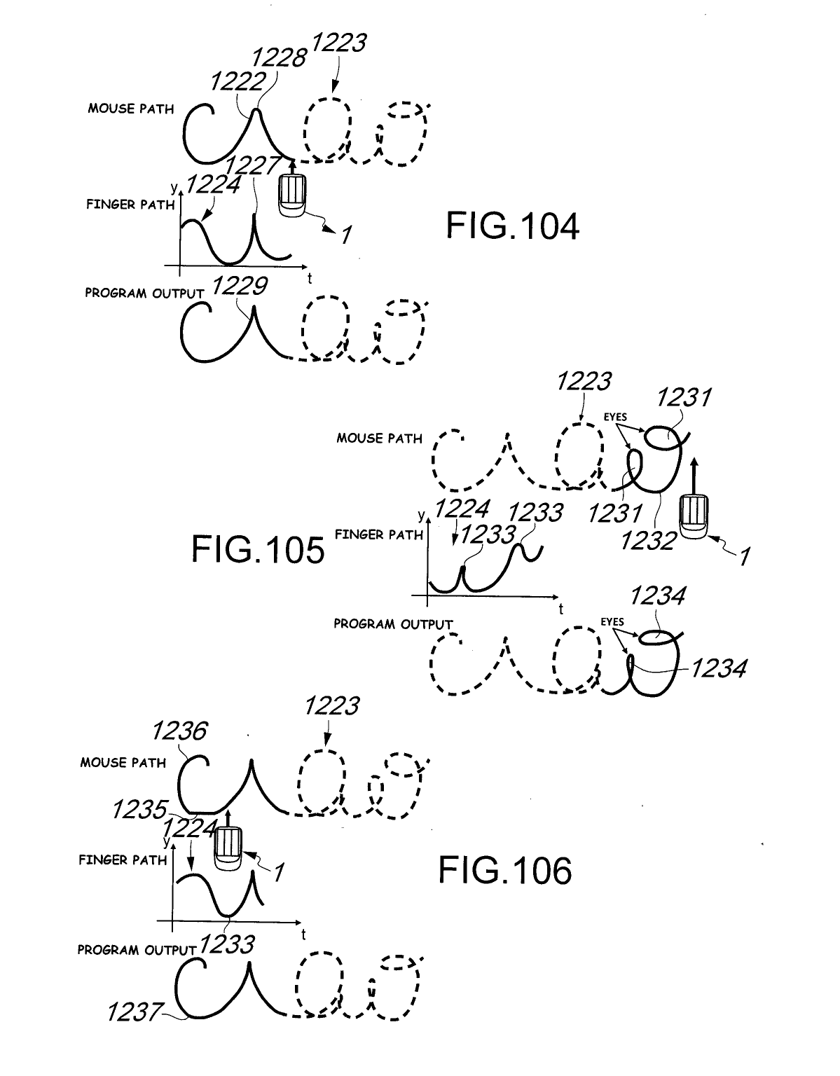

A method for correction of free handwriting by using an input device which is associated with a mouse. By moving the finger on the sensor 60 or rotating the slideable member 2, 102 starting from a point within the Normal Mode Area while the input device 1 is moved, we can modify the speed of movement of the pointer. The movements of the input device 1 and of the finger can be combined in various ways. According to a first method, moving the finger when the input device 1 is already in motion triggers a mode wherein by moving the finger we obtain a change of speed of the pointer moved by the mouse. By modulating the movement of the finger on the sensor or the movement of the slideable member 2, 102 we can have positive or negative acceleration factors of the pointer depending on whether the finger is moved forward or backward. These factors can be used by a program to make corrections in real time on an operation of free handwriting and the like. In FIG. 104 we see an input device 1 which has finished tracing the letter “i” 1222 of the Italian word “Ciao” 1223. Below this is the graph 1224 of the movement of the finger on the sensor 60 (y axis) over time (t axis) when tracing the letters shown above (“ci”). As can be seen, at the cusp 1227 of the “i” 1222 the finger has inverted its direction, faster and more sharply than the corresponding output 1228 of the mouse. Using this information the system has reconstructed the “i” 1229 according to the original intentions of the user, and this is shown at the bottom. Other defects can be corrected in a similar manner. In FIG. 105 the disproportion of the eyes 1231 of the letter “o” 1232 has been corrected in a similar manner. We can see the movement 1233 of the finger on the sensor 60 at the eyes 1231 and the end result 1234 on the screen. In FIG. 106 an artifact 1235 at the base of the letter “c” 1236 has been corrected. We can see the movement 1233 of the finger on the sensor 60 at the artifact 1235 and the end result 1237 on the screen.

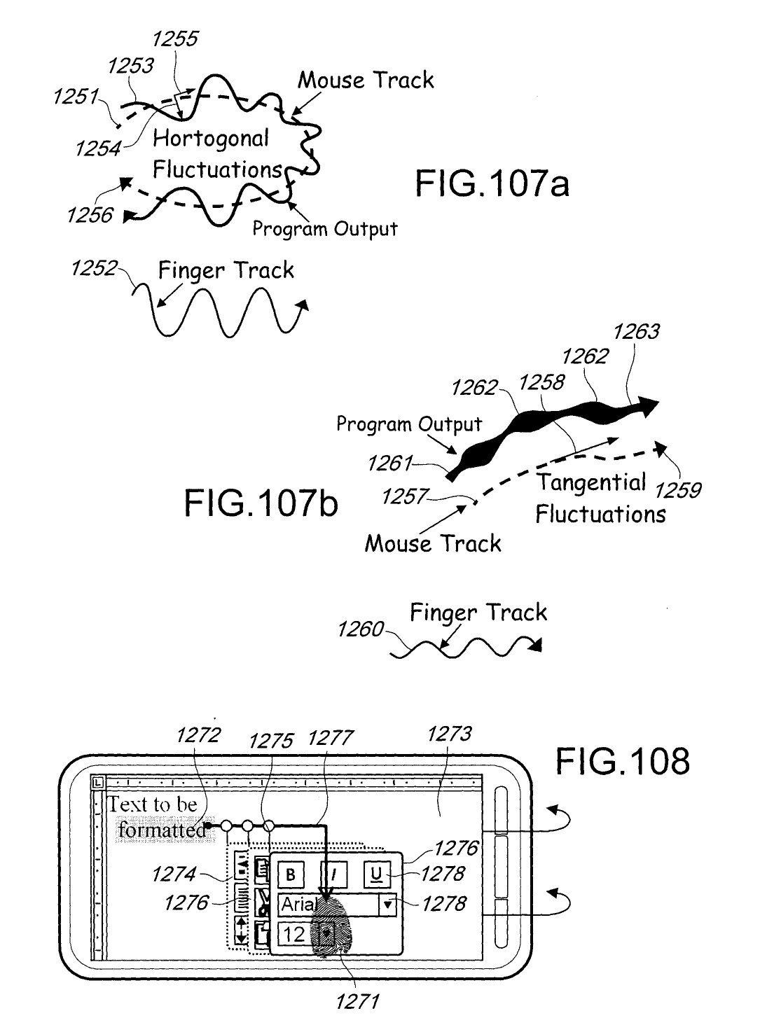

A method of drawing which makes it possible to parameterize the output of an input device 1 based on the movement of the finger on the sensor 60. In FIGS. 107a and 107b we see two examples of parameterization. For each example the figures offer a comparison of the output of the mouse 1251, 1257, of the finger 1252, 1260 and of the program 1253, 1261. In the first case the tracing of a line 1251 is modified according to a vector 1254 that is perpendicular to the motion vector 1255 of the pointer 1256. A sinusoidal movement 1252 of the finger on the sensor 60 will give rise, in this case, to an undulating line 1253. In the second case the tracing of a line 1257 is modified according to a vector 1258 that is tangential to the motion vector of the pointer 1259. A sinusoidal movement 1260 of the finger on the sensor 60, in this case, can give rise, in the program output 1261, to fluctuations 1262 in the thickness of the brushstroke 1263.

A method for moving objects on screen without clicking. We can move objects, resize windows and so on by laying at least one phalange of a finger, preferably the ring finger, on the sensor of an input device 1 and moving the mouse which is associated with the input device 1. This action simulates a clicking and dragging of the pointer. Lifting the finger produces an action similar to releasing the button of a mouse.

A method for controlling the graphical interface, particularly for displaying palettes, for use in computer devices which are associated with at least one input device 1 that is provided with a touch-sensitive screen. With reference to the example in FIG. 108, by pointing with a finger 1271 to an object 1272 or to a selection of objects and rotating the slideable member 1273 a first time, we obtain the displaying of a palette 1274. By rotating the slideable member 1273 again, and at each tick 1275, we obtain the displaying of a different palette 1276. Subsequently, by positioning a finger 1271 on a command 1278 of the palette 1276 and performing the appropriate action (clicking, rolling etc.) we obtain the execution of the command 1278 as well as, in at least one implementation, the closing of the palette 1276. The palettes displayed can be contextual to the type of object 1272 which is pointed at.

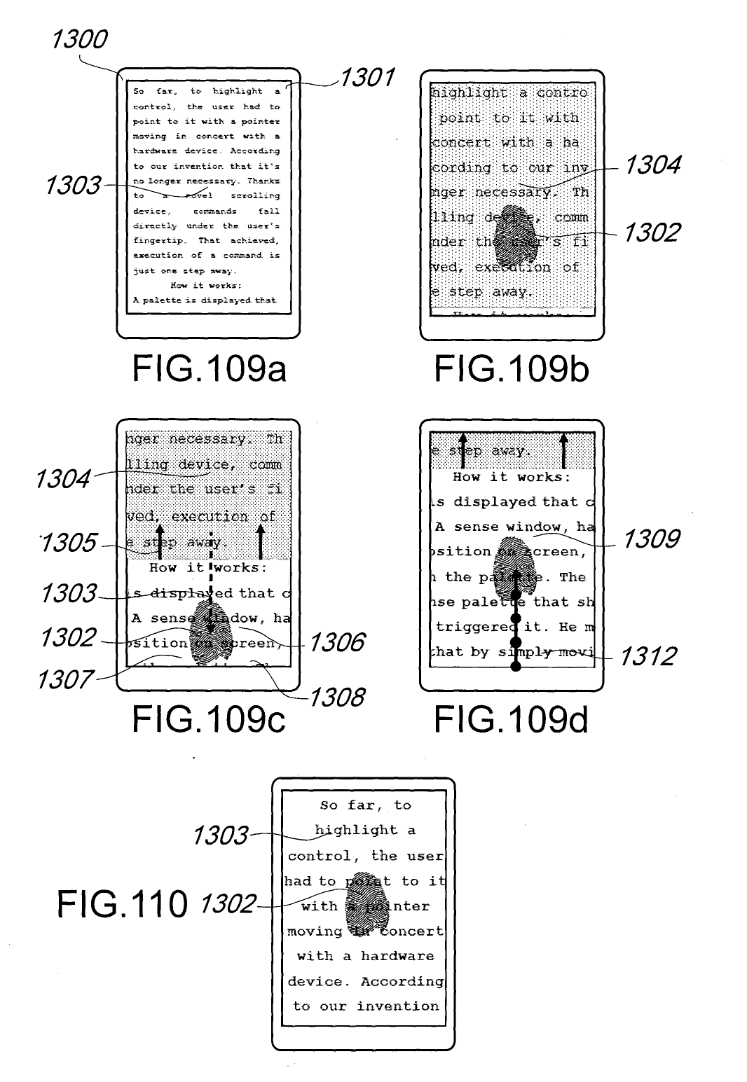

A method of magnification and panning “with just one finger” for use in computer devices associated with at least one input device 1. With this method it is possible to browse an infinite number of pages, enlarge them and continue to browse them using just one finger and without ever breaking off contact with the sensor 60. In FIGS. 109a, 109b, 109c and 109d we see an example of the method applied to a portable device 1300 which comprises an input device 1 and a touch-sensitive screen 1301. The example in the figures refers to the application of the method to a page of a document of text which is currently displayed on the touch-sensitive screen 1301. The user points with a finger 1302, preferably the thumb, to the part 1303 of a page to enlarge. Subsequently the user performs a triggering action, preferably a prolonged click, on the point of the screen which is currently pointed to by the finger 1302, and, without breaking off contact of the finger 1302 with the touch-sensitive screen 1301, begins to move the finger 1302 upward or downward. The system recognizes this action as a gesture and produces an enlarged representation 1304 of the part 1303 of the page currently pointed to by the finger, as in FIG. 109b. This enlarged representation 1304 remains on the screen even when the finger is stationary. With reference to FIG. 109c, as the user moves the finger 1302 upward or downward the previously-enlarged part 1304 of the page moves, respectively, downward 1305 or upward thus enabling the user to read the parts 1306 that the enlarged part 1304 has hidden vertically. A similar behavior ensues if the user performs the gesture horizontally. As the user moves the finger 1302 to the right or to the left the enlarged part 1304 of the page moves, respectively, to the left or to the right thus enabling the user to read the parts that the enlarged part 1304 has hidden horizontally. The user can continue to scroll a page even when the finger 1302 has reached the bottom 1307 of the screen 1301: from the current location, and without breaking off contact of the finger 1302 with the screen 1301, the user moves the slideable member 1308 of the input device 1 upward, thus bringing the finger 1302 back toward the center 1309 of the screen. In response to this movement of the slideable member 1308 the enlarged part 1304 of the page is made to scroll upward by an amount similar to the movement of the slideable member 1308. In this manner the lower part 1307 of the portion of page that is currently displayed moves upward, leaving space below 1312 for the repetition of the method. With a similar procedure it is possible to scroll a page downward even when the finger 1302 has reached the top of the screen.

In one implementation the enlargement of a part of the page is substituted by the reformatting thereof. In FIG. 110 we see the same part 1303 of the document pointed to by the finger 1302 in the previous example, in FIG. 109b, as it appears reformatted so that it can be read in its entirety horizontally. In this manner it is sufficient to scroll the document vertically only, using the method described. In one implementation the method described produces the scrolling of a page without enlarging it. The method described can be used both in a desktop environment and in a mobile environment. The method described can be used to navigate a desktop of any resolution or to scroll a window.

In the preferred implementation of the method, the triggering action is produced by clicking on the sensor 60 of an input device 1 while keeping the switch 5 pressed for a preset period of time, after which the user can, by releasing the switch 5 and without breaking off contact with the sensor 60, execute the remaining part of the method. This triggering action can be used, more generally, to tell the system 630 that execution of a gesture has begun. In one implementation, lifting the finger from the sensor 60 following the triggering action described triggers a countdown timer. If this countdown timer expires and the sensor 60 has not been touched at least once by at least one finger then the system 630 interrupts execution of the method. Otherwise the countdown timer restarts and the method is repeated.

A Self-Orienting method for “frictionless” touch pads. In FIG. 10 we see two input devices 122 according to the third preferred embodiment, used for entering text with the methods previously described. When the user is tired of one posture 123 he or she can simply rotate 124 the arm and resume writing. The system 630 recognizes the degree of rotation 124 on the basis of information such as the orientation of the shape of the fingertip, the direction of movement of the finger and of sliding of the bubble 102 in a straight line, and recalculates the output of the input device 122 so as to enable the user to type in the new position 124 and obtain the same results. The method can also be used to dynamically orientate the movement of the system pointer according to axial systems corresponding to different hand postures.

In practice it has been found that the input device, particularly for computers or the like, according to the present disclosure, achieves the intended aim and objects in that it makes it possible to interface with computers or the like in a manner that is natural, fast, instinctive and with reduced force.

The input device, particularly for computers or the like, thus conceived is susceptible of numerous modifications and variations. Moreover, all the details may be substituted by other, technically equivalent, elements.

In practice the materials employed, provided they are compatible with the specific use, and the contingent dimensions and shapes, may be any according to requirements.

1-148. (canceled)

149. An input device for use with a computer system, comprising:
a slideable member, comprising a moveable surface which is looped back on itself;
at least one sliding support;
said slideable member being adapted to slide around said at least one sliding support; said sliding support and said slideable member providing at least one substantially squashed portion of said input device;
a slide sensor which is adapted to read the movement of the slideable member around said at least one sliding support and convert it to an electronic signal.

150. The input device according to claim 149, further including a touch sensor which is configured to detect the interactions of the user with said at least one substantially squashed portion of said input device.

151. The input device according to claim 149, further including:
at least one switch; and
a moveable member, which is adapted to engage with said slideable member and with said at least one switch so that the pressure exerted with the finger on said at least one substantially squashed portion of said input device causes the triggering of said at least one switch.

152. The input device according to claim 150, further including:
a housing;
a moveable element, which is associated with said housing;
at least one first magnetic element which is associated with said housing or with a supporting bracket and at least one second magnetic element which is associated with said moveable element; said at least one first magnetic element and said at least one second magnetic element being adapted to attract or repel each other; said at least one first magnetic element and said at least one second magnetic element being selected from the group consisting of:
a) a metallic body;
b) a magnet; and
c) an electromagnet;
or a combination of elements of said group;
actuators which are adapted to generate a tactile signal;
a control section for electromagnets;
means for the generation or short-circuiting of an electrical signal; said tactile signal and said electrical signal being indicative of an action of pressure and/or traction exerted by a finger of the user on said moveable element; and
one or more link members which are adapted to couple said moveable element to said housing or to said supporting bracket.

153. The input device according to claim 149, wherein said slideable member further includes a belt and said at least one sliding support includes at least one element which is chosen from a first group composed of:
a) a roller;
b) a wheel;
c) a bearing;
d) a fixed support; and
e) a magnetic element;
or a combination of elements of said first group.

154. The input device according to claim 150, wherein said slideable member further includes a belt and said at least one sliding support includes at least one element which is chosen from a first group composed of:
a) a roller;
b) a wheel;
c) a bearing;
d) a fixed support; and
e) a magnetic element;
or a combination of elements of said first group.

155. The input device according to claim 151, wherein said slideable member further includes a belt and said at least one sliding support includes at least one element which is chosen from a first group composed of:
a) a roller;
b) a wheel;
c) a bearing;
d) a fixed support; and
e) a magnetic element;
or a combination of elements of said first group.

156. The input device according to claim 153, wherein said slide sensor includes a code wheel, and further includes:
at least one element for coupling which is chosen from a second group composed of:
a) lever means;
b) hydraulic means;
c) magnetic means; and
d) electromechanical means;
or a combination of elements of said second group; said at least one element for coupling being adapted to couple said code wheel with said belt in response to the pressure of the finger of the user on said at least one substantially squashed portion of said input device; the coupling of said code wheel with said belt being such as to induce the code wheel to rotate in response to the traction of the belt by the finger of the user.

157. The input device according to claim 155, wherein said slide sensor includes a code wheel, and further includes:
at least one element for coupling which is chosen from a second group composed of:
a) lever means;
b) hydraulic means;
c) magnetic means; and
d) electromechanical means;
or a combination of elements of said second group; said at least one element for coupling being adapted to couple said code wheel with said belt in response to the pressure of the finger of the user on said at least one substantially squashed portion of said input device; the coupling of said code wheel with said belt being such as to induce the code wheel to rotate in response to the traction of the belt by the finger of the user.

158. The input device according to claim 156, wherein said coupling of said code wheel with said belt is interrupted in response to a variation of the pressure of the finger of the user.

159. The input device according to claim 156, wherein said lever means includes at least one first lever arm which is adapted to rotate about a first axis and at least one second lever arm which is adapted to rotate about a second axis which is coupled to said first lever arm; said second lever arm being coupled to said belt and to said code wheel.

160. The input device according to claim 153, wherein said belt has a cross-section which is, at least partially, curved.

161. The input device according to claim 154, wherein said belt has a cross-section which is, at least partially, curved.

162. The input device according to claim 160, wherein said belt is composed, at least partially, of a material which is chosen from a third group composed of:
a) a material of the type of steel;
b) a material of the type of plastic;
c) a material of the type of rubber; and
d) a material of the type of silicone;
or of a combination of elements of said third group.

163. The input device according to claim 153, wherein at least one part of said belt, in the absence of external forces, has a shape substantially similar to the shape of a belt kept in tension between two rollers.

164. The input device according to claim 155, wherein at least one part of said belt, in the absence of external forces, has a shape substantially similar to the shape of a belt kept in tension between two rollers.

165. The input device according to claim 159, wherein at least one part of said belt, in the absence of external forces, has a shape substantially similar to the shape of a belt kept in tension between two rollers.

166. The input device according to claim 153, wherein at least one part of said belt has a shape and structure similar to the shape and structure of a portion of a measuring tape having a curved cross-section and made of steel, when said measuring tape is folded at an angle of width disposed between 170 degrees and 190 degrees.

167. The input device according to claim 149, wherein said slideable member includes a closed shell and said at least one sliding support includes an internal body; said closed shell being provided with an elasticity coefficient which is such as to enable said closed shell to slide around said internal body in response to the fraction exerted by at least one finger of the user on said closed shell.

168. The input device according to claim 150, wherein said slideable member includes a closed shell and said at least one sliding support includes an internal body; said closed shell being provided with an elasticity coefficient which is such as to enable said closed shell to slide around said internal body in response to the fraction exerted by at least one finger of the user on said closed shell.

169. The input device according to claim 167, further including:
a support shell; said closed shell being included in said support shell; said support shell being provided with at least one opening; said opening leaving uncovered at least one part of said at least one substantially squashed portion of said input device;
one or more magnets and/or metallic elements which are associated with said support shell and/or with said internal body; said one or more magnets and/or metallic elements being configured so as to enable said closed shell substantially to float in the space defined and/or comprised, at least partially, by said support shell.

170. The input device according to claim 169, further including a position sensor which is configured to detect the movements of said input device with respect to a resting surface.

171. A mouse comprising one or more input devices according to claim 149.

172. A mouse comprising one or more input devices according to claim 150.

173. A mouse comprising one or more input devices according to claim 160.

174. A mouse comprising one or more input devices according to claim 167.

175. A portable electronic device comprising one or more input devices according to claim 149.

176. A portable electronic device comprising one or more input devices according to claim 167.
